(19) United States
(12) Patent Application Publication
(10) Pub. No.: US 2023/0405592 A1
(43) Pub. Date: Dec. 21, 2023

(54) METHODS AND APPARATUS FOR REMOVABLE NOZZLE WITH CAM LATCH ENGAGEMENT IN FLOW CYTOMETERS

(71) Applicant: Cytek Biosciences, Inc., Fremont, CA (US)

(72) Inventors: Kuncheng Wang, Fremont, CA (US); Huimin Gu, Fremont, CA (US); Andrew Klyce-Mariscal, Fremont, CA (US); Wing Lee, Fremont, CA (US); Ming Yan, Fremont, CA (US); Glen Krueger, Fremont, CA (US); David Vrane, Fremont, CA (US)

(73) Assignee: Cytek Biosciences, Inc., Fremont, CA (US)

(21) Appl. No.: 18/297,615

(22) Filed: Apr. 8, 2023

Related U.S. Application Data
(63) Continuation-in-part of application No. 17/665,480, filed on Feb. 4, 2022.
(60) Provisional application No. 63/329,360, filed on Apr. 8, 2022.
(60) Provisional application No. 63/172,072, filed on Apr. 7, 2021.
(60) Provisional application No. 63/172,330, filed on Apr. 8, 2021.
(60) Provisional application No. 63/258,065, filed on Apr. 8, 2021.

(51) Int. Cl. B01L 3/00; G01N 15/14

(52) U.S. Cl. CPC B01L 3/502746; G01N 15/1434; G01N 2015/149; G01N 2015/1006

(57) ABSTRACT

A flow cell subassembly includes a carriage assembly coupled to a flow cell body to selectively engage a nozzle with a base of a cuvette. The carriage assembly includes a linear bearing slidingly engaged with the flow cell body, a tiltable carriage plate coupled to the linear bearing, and a nozzle mount coupled to the tiltable carriage plate. The nozzle mount receives a nozzle assembly with the nozzle. Set screws can adjust pitch angle of the tiltable carriage plate with the linear bearing to adjust engagement between the nozzle and cuvette in a first dimension. To adjust engagement between the nozzle and cuvette in a second dimension, axial play in bolts/screws through the tiltable carriage plate into threaded holes of the linear bearing allow for yaw angle adjustments.

### CROSS-REFERENCE TO RELATED APPLICATIONS

This patent application claims the benefit of United States (US) Provisional Patent Application No. 63/329,360 titled METHODS AND APPARATUS FOR REMOVABLE NOZZLE WITH CAM LATCH ENGAGEMENT IN FLOW CYTOMETERS filed on Apr. 8, 2022, by inventors Kuncheng Wang et al., incorporated herein by reference for all intents and purposes. This patent application further is a continuation in part and claims the benefit of United States (U.S.) patent application Ser. No. 17/665,480 titled INTEGRATED COMPACT CELL SORTER filed on Feb. 4, 2022, by inventors Glen Krueger et al., incorporated herein by reference for all intents and purposes. U.S. patent application Ser. No. 17/665,480 claims the benefit of United States (US) Provisional Patent Application No. 63/172,072 titled INTEGRATED COMPACT CELL SORTER filed on Apr. 7, 2021, by inventors Glen Krueger et al., incorporated herein by reference for all intents and purposes. U.S. patent application Ser. No. 17/665,480 further claims the benefit of United States (US) Provisional Patent Application No. 63/172,330 titled INTEGRATED AIR FILTERING AND CONDITIONING OF DROPLET CHAMBER IN A COMPACT CELL SORTER filed on Apr. 8, 2021, by inventors Glen Krueger et al., incorporated herein by reference for all intents and purposes. U.S. patent application Ser. No. 17/665,480 further claims the benefit of United States (US) Provisional Patent Application No. 63/258,065 titled INTEGRATED AIR FILTERING AND CONDITIONING OF DROPLET CHAMBER IN A COMPACT CELL SORTER filed on Apr. 7, 2021, or Apr. 8, 2021 (pending petition to correct filing date) by inventors Glen Krueger et al., incorporated herein by reference for all intents and purposes.

### FIELD

The disclosed embodiments relate generally to flow cytometer and cell sorter systems.

### BACKGROUND

Flow cytometry and cell sorting involves the optical measurement of cells or particles of a test sample carried in a fluid flow. Cell sorting further sorts out selected cells of interest into different containers (e.g., test tubes) for further usage (e.g., testing) or counting. The lab instruments that achieve these tasks are respectively known as a flow cytometer and a cell sorter. The cell sorter can also be referred to as a sorting flow cytometer.

Cell sorters and flow cytometers are often configurable with removable nozzles. This is so that the nozzle can be periodically cleaned to avoid a clogged orifice and cross-contamination between different samples that are being tested. Additionally, different nozzles may be selected with different diameters of orifices to accommodate different drop sizes and different drop delays between sample drops of differing biological samples. After a periodic (e.g., daily) calibration of the flow cytometer with a selected nozzle, the nozzle may be removed multiple times during the same day. It is desirable that the removeable nozzle is inserted substantially back into the same position that it was when previously calibrated. This is so the drop size and the drop delay (drop quality) between sample drops is substantially the same from sample run to sample run each time the removeable nozzle is replaced after cleaning.

Furthermore, for efficient flow of drops of sample fluids in a flow cytometer, it is desirable that axes of the flow (fluid) channels in the nozzle and orifice are substantially in line (concentric) with the axis of the flow channel in a cuvette. It is desirable to periodically (e.g., during initial assembly and reassembly) set and check the channel alignment of these flow channels. If the flow channels are out of alignment, it is desirable to adjust the alignment of the nozzle with the cuvette in the flow cytometer to bring the channels into substantial alignment to increase drop efficiency and drop quality.

### SUMMARY

The embodiments are best summarized by the claims. However, a summary of some of the embodiments is provided here.

In one embodiment, a nozzle subsystem for a cell sorter system is disclosed, the nozzle subsystem comprises a latchable nozzle assembly including a nozzle handle and a nozzle, the nozzle handle having a body with a gripping end and a nozzle end, the nozzle positioned in a portion of the through hole of the body of the nozzle handle, the nozzle having a circular body with a center nozzle orifice concentric with the through hole to flow drops of a sample fluid, and a beveled ring in a top surface extending out from the circular body; and a latchable mount formed to have a first through hole and a second through hole, wherein the latchable mount is further formed to slidably receive the nozzle handle, the latchable mount including a ball assembly having a ball configured to extend partially out of the second through hole and engage with the nozzle handle, wherein the ball guides the nozzle handle to register on the latchable mount such that the center nozzle orifice and the first through hole are concentric within a tolerance.

In another embodiment, a flow cytometer or cell sorter system is disclosed. The system comprises a flow cell coupled in communication with a fluidics system to receive a sheath fluid, wherein a sample fluid flows with cells or particles through the flow cell to be surrounded by the sheath fluid, the flow cell including a flow cell body coupled around the drop drive assembly to receive the sample fluid from the sample injection tube; a cuvette coupled to a base of the flow cell body, the cuvette having a channel to receive the fluid stream of the sample fluid; a latchable nozzle assembly selectively engaged with the cuvette, the latchable nozzle assembly having a nozzle and an O-ring around the nozzle selectively pressed against a face of the cuvette around the channel, the nozzle being configured to receive the sample stream from the cuvette and form sample drops out of the nozzle assembly; a latchable mount formed to have a first through hole and a second through hole, wherein the latchable mount is further formed to slidably receive the nozzle handle, the latchable mount including a ball assembly having a ball configured to extend partially out of the second through hole and engage with the nozzle handle, wherein the ball guides the nozzle handle to register on the latchable mount such that the center nozzle orifice and the first through hole are concentric within a tolerance.

In another embodiment, a method for a nozzle assembly of a flow cytometer or cell sorter system is disclosed. The method comprises engaging rails of a base portion of a latchable nozzle handle with slotted rails of a latchable mount, wherein the latchable nozzle handle has a body with a gripping end and a nozzle end, and wherein the latchable mount is formed to have a first through hole and a second through hole; sliding the rails of the base portion of the latchable nozzle handle along the slotted rails of the latchable mount; engaging the base portion of the latchable nozzle handle with a ball assembly as the latchable nozzle handle is sliding along the latchable mount, wherein the latchable mount includes a ball assembly having a ball configured to extend partially out of the second through hole and engage with the latchable nozzle handle; and guiding the latchable nozzle handle via the ball to register on the latchable mount such that the center nozzle orifice and the first through hole are concentric within a tolerance.

In another embodiment, a method for a subassembly of a flow cytometer or a cell sorter is disclosed. The method comprises loosely installing a carriage assembly 442B to a flow cell 404, including loosely installing a carriage plate 465B to a linear bearing 464 by inserting a plurality of bolts/screws through a plurality of holes 471A in the carriage plate and threading some threads of the plurality of bolts/screws into a plurality of threaded openings of the linear bearing 464; inserting an empty latchable nozzle assembly 450E into a mount 452B of the carriage assembly 442B under a cuvette 406, the empty latchable nozzle assembly 450B having a nozzle body without a nozzle and an o-ring; pushing on the mount 452B to engage a top surface portion of the nozzle body of the empty latchable nozzle assembly 450B with a bottom surface portion of the cuvette 406; and with the top surface portion of the empty latchable nozzle assembly 450B and the bottom surface portion of the cuvette 406 forming an even gap, tightening the threads of the plurality of bolts/screws into the plurality of threaded openings of the linear bearing 464.

In another embodiment, a method for a flow cell subassembly is disclosed. The method comprises: installing a carriage assembly to a flow cell, the carriage assembly including a carriage plate and a linear bearing, wherein a nozzle mount for receiving a nozzle assembly is coupled to the carriage plate and a cuvette is coupled to the flow cell; performing a first engagement test between a first nozzle of a first latchable test nozzle assembly and a cuvette to make a first observation of engagement along a first angle; and based on the first observation of engagement, adjusting angular orientation (yaw) of a carriage plate with respect to a linear bearing by clockwise or counterclockwise rotation to adjust the engagement between nozzles and the cuvette in a first dimension.

In still another embodiment, a method for a flow cell subassembly is disclosed. The method comprises: installing a carriage assembly to a flow cell, the carriage assembly including a carriage plate and a linear bearing, wherein a nozzle mount for receiving a nozzle assembly is coupled to the carriage plate and a cuvette is coupled to the flow cell; performing a first engagement test between a first nozzle of a first latchable test nozzle assembly and a cuvette to make a first observation of engagement along a first angle; performing a second engagement test between a second nozzle of a second latchable test nozzle assembly and the cuvette to make a second observation of engagement along a second angle differing from the first angle; performing a third engagement test between a third nozzle of a third latchable test nozzle assembly and the cuvette to make a third observation of engagement along a third angle differing from the first and second angles; and performing a fourth engagement test between a fourth nozzle of a fourth latchable test nozzle assembly and the cuvette to make a fourth observation of engagement along a fourth angle differing from the first, second, and third angles.

In another embodiment, a flow cell assembly for a flow cytometer or cell sorter system is disclosed. The flow cell assembly comprises a flow cell body, a cuvette coupled to a base of the flow cell body, and a carriage assembly coupled to the flow cell body. The flow cell body is adapted to receive a sample fluid. The cuvette has a flow channel to receive a fluid stream of the sample fluid. The cuvette is transparent to light and allows the sample fluid in the flow channel to undergo interrogation by one or more lasers and a plurality of detectors. The carriage assembly selectively engages a nozzle with the base of the cuvette. The carriage assembly includes a linear bearing slidingly engaged with a front of the flow cell body; a tiltable carriage plate coupled to the linear bearing, the tiltable carriage plate including a first plurality of threaded holes; a plurality of set screws threaded into the first plurality of threaded holes; and a nozzle mount coupled to a base of the tiltable carriage plate. The nozzle mount receives a nozzle assembly with the nozzle. The plurality of set screws adjust a pitch angle between the tiltable carriage plate and the linear bearing to selectively adjust the engagement of the nozzle with the base of the cuvette to a selected or selective engagement in a first dimension.

### BRIEF DESCRIPTIONS OF THE DRAWINGS

Various embodiments are illustrated by way of example, and not by way of limitation, in the Figures of the accompanying drawings.

FIG. 1A is a basic conceptual diagram of a cell sorter system (a sorting flow cytometer system) and a flow cytometer system is shown.

FIG. 1B is front view of a compact cell sorter system with its various doors in a closed state.

FIG. 1C is front view of a compact cell sorter system with its various doors in an open state.

FIGS. 2A-2B are views of the droplet deposition unit (DDU) of the compact cell sorter system with the DDU door and the sample input door open.

FIGS. 3A-3B are views of the fluidics bucket in the fluidics system of the compact cell sorter system.

FIGS. 4A-4G are views of the flow cell in the fluidics system of the compact cell sorter system.

FIG. 4H is an exploded view of the flow cell of the compact cell sorter system.

FIG. 4I is an exploded view of the nozzle carriage assembly of the flow cell shown in FIG. 4H.

FIGS. 4J-4M illustrate various views of an instance of a left and right spring-loaded lever arm for the carriage linkage.

FIGS. 5A-5B are side views illustrating carriage movement of the flow cell as the lever is raised and lowered, respectively.

FIGS. 6A-6B are cross-sectional views illustrating carriage movement of the flow cell as the lever is raised and lowered, respectively.

FIG. 7A is a perspective view of the nozzle assembly in the flow cell of the compact cell sorter system.

FIGS. 7B-7D are exploded views of the nozzle assembly in the flow cell of the compact cell sorter system.

FIG. 7E is a cross-sectional view of the nozzle assembly.

FIG. 7F is a magnified view of a portion of cross-sectional view of the nozzle assembly.

FIG. 7G-1 through FIG. 7G-5 illustrate perspective views of a latchable nozzle assembly.

FIG. 7H-1 through FIG. 7H-5 illustrate additional perspective views of the latchable nozzle assembly.

FIG. 7I is a top view of the latchable nozzle assembly.

FIG. 7J is a back side view of the latchable nozzle assembly.

FIG. 7K is a bottom side view of the latchable nozzle assembly.

FIG. 7L is a front side view of the latchable nozzle assembly.

FIG. 8A is a view of engagement/disengagement of the nozzle assembly with the flow cell of the compact cell sorter system.

FIGS. 8B-8C are perspective views of the flow cell illustrating carriage and nozzle assembly movement down and up as the lever arm is pivoted.

FIG. 9A is a perspective view of engagement/disengagement of the nozzle assembly with the nozzle mount of the flow cell.

FIGS. 9B-9C are perspective views of the registered nozzle assembly moving up to engage the cuvette as the lever arm is pivoted.

FIG. 10A is a cross-sectional view of engagement/disengagement of the nozzle assembly with the nozzle mount of the flow cell.

FIGS. 10B-10C are cross-sectional views of the registered nozzle assembly moving up to engage the cuvette as the lever arm is pivoted.

FIGS. 11A-11B are cross-sectional views of engagement/disengagement of the nozzle assembly with the nozzle mount of the flow cell.

FIG. 11C is a perspective view of the nozzle assembly registered with the nozzle mount of the flow cell.

FIG. 11D is a magnified cross-sectional view of the end of the nozzle assembly registered with the nozzle mount of the flow cell.

FIG. 11E is a circle with two dots illustrating points of contact of the end of the nozzle assembly registered with the nozzle mount of the flow cell.

FIG. 12A is top perspective view of the latchable nozzle assembly engaged with (slid into, latched, and mounted) a latchable nozzle mount.

FIG. 12B is an exploded view of the latchable nozzle mount with the latchable nozzle assembly disengaged therefrom.

FIG. 12C is a front view of the latchable nozzle assembly engaged with (slid into, latched, and mounted) the latchable nozzle mount.

FIG. 12D is a cross sectional view of the latchable nozzle engaged with (slid into, latched, and mounted) the latchable nozzle mount.

FIG. 13A is an exploded view of a flow cell subassembly with tiltable carriage plate, latchable nozzle assembly, and latchable mount.

FIG. 13B is an exploded view of the tiltable carriage plate, latchable mount, and linear bearing of FIG. 13A.

FIG. 13C is a front view of the assembled flow cell subassembly of FIG. 13A.

FIG. 13D is cross-sectional view of the assembled flow cell subassembly of FIG. 13C.

FIG. 13E is a magnified cross-sectional view of the assembled flow cell subassembly of FIG. 13D with a tilt in the tiltable carriage plate in one direction.

FIG. 13F is a magnified cross-sectional view of the assembled flow cell subassembly of FIG. 13D with a tilt in the tiltable carriage plate in another direction.

FIG. 13G is a magnified back side view of the assembled flow cell subassembly with an empty latchable nozzle assembly latched into the latchable mount to adjust the pitch (tilt) and yaw (rotation) of the tiltable carriage (and nozzle assembly) with the linear bearing (and the cuvette).

FIG. 14A is a magnified top view of a latchable test nozzle assembly including a pair of co-linear ridges in the nozzle around the orifice.

FIG. 14B is a schematic view of different co-linear ridges in the nozzle around the orifice for a variety of test nozzle assemblies.

FIG. 14C is a schematic diagram of what reflection is visible with a poor uneven engagement between the cuvette and a test nozzle.

FIG. 14D is a schematic diagram of what reflection is visible with a good even engagement between the cuvette and a test nozzle.

FIG. 14E is a cross sectional view of a test nozzle for a latchable test nozzle assembly including the pair of co-linear ridges shown in FIG. 14A.

FIGS. 15A-15D are views through the cuvette showing good engagement by different test nozzles with the cuvette.

FIGS. 16A-16C are views through the cuvette showing poor and uneven engagement by test nozzles with the cuvette.

FIGS. 17A-17B are views of poor quality drops released from a nozzle.

FIG. 18A-18B are views of good quality drops released from a nozzle.

It will be recognized that some or all of the Figures are for purposes of illustration and do not necessarily depict the actual relative sizes or locations of the elements shown. The Figures are provided for the purpose of illustrating one or more embodiments with the explicit understanding that they will not be used to limit the scope or the meaning of the claims.

### DETAILED DESCRIPTION

In the following detailed description of the embodiments, numerous specific details are set forth. However, it will be obvious to one skilled in the art that the embodiments may be practiced without these specific details. In other instances, well known methods, procedures, components, and circuits have not been described in detail so as not to unnecessarily obscure aspects of the embodiments. The various sections of this description are provided for organizational purposes. However, many details and advantages apply across multiple sections.

### System Overview

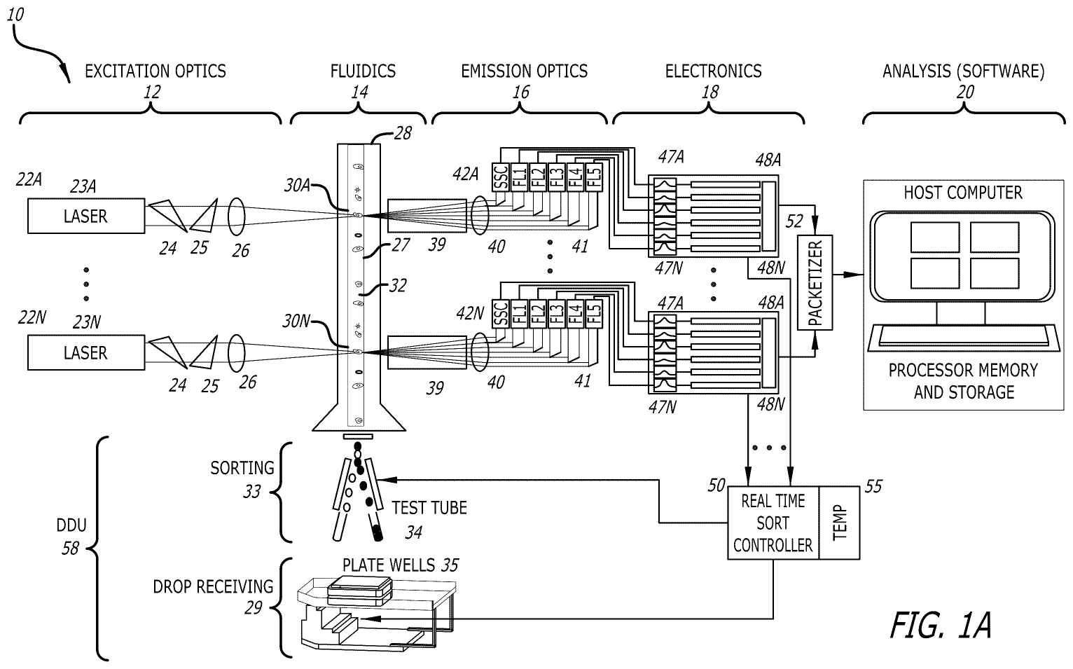

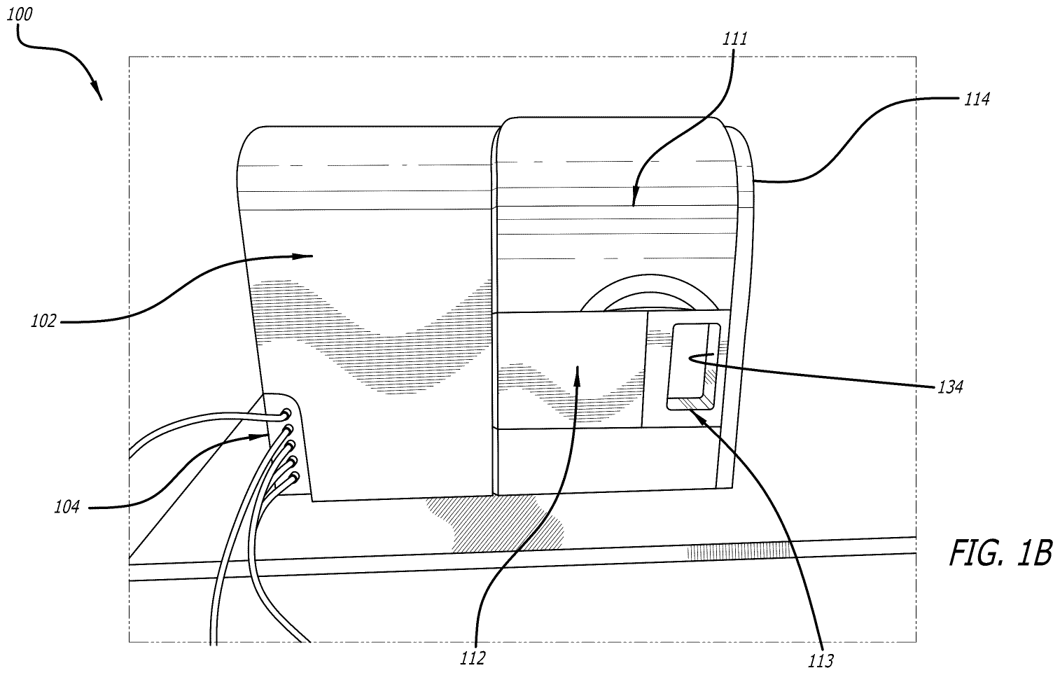

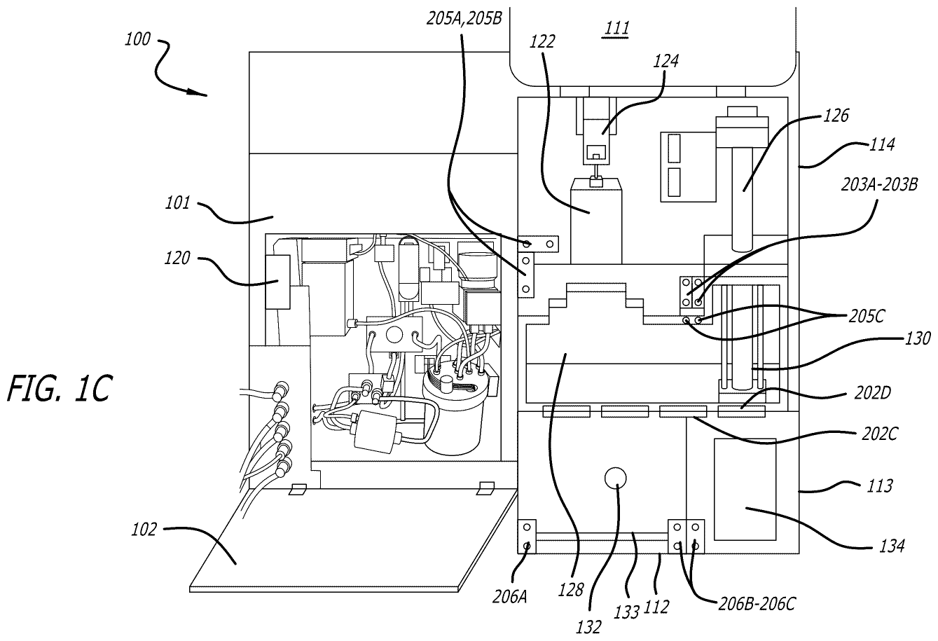

FIG. 1A is a basic conceptual diagram of a cell sorter system (sorting flow cytometer) 10. Five major subsystems of the system 10 include an excitation optics system 12, a fluidics system 14, an emission optics system 16, an acquisition system 18, and an analysis system 20. The fluidics system 14 can include a sample loading system (not shown), an interrogating system 28, a cell sorting system 33, and a drop receiving system 29. Generally, a “system” and “subsystem” includes (electrical, mechanical, and electro-mechanical) hardware devices, software devices, or a combination thereof.

The excitation optics system 12 includes, for example, a plurality (e.g., two to five) of excitation channels 22A-22N each having a different laser device 23A-23N and one or more optical elements 24-26 to direct the different laser light to optical interrogation regions 30A-30N spaced apart along a line in a flow channel 27 of a flow cell 28. Example optical elements of the one or more one or more optical elements 24-26 include an optical prism and an optical lens. The excitation optics system 12 illuminates an optical interrogation region 30 in a flow cell 28. The fluidics system 14 carries a fluid sample 32 surrounded by a sheath fluid through each of a plurality of optical interrogation regions 30A-30N in the flow cell/flow channel.

The emission optics system 16 includes a plurality of detector arrays 42A-42N each of which, for example, includes one or more optical elements 40, such as an optical fiber and one or more lenses to direct fluorescent light and/or (forward, side, back) scattered light to various electro-optical detectors (transducers), including a side scatter (SSC) channel detector and a plurality (e.g., 16, 32, 48, 64) of fluorescent wavelength range optical detectors in each array, such as a first fluorescent optical detector (FL1) receiving a first wavelength range of fluorescent light, a second fluorescent optical detector (FL2) receiving a second wavelength range of fluorescent light, a third fluorescent optical detector (FL3) receiving a third wavelength range of fluorescent light, a fourth fluorescent optical detector (FL4) receiving a fourth wavelength range of fluorescent light, a fifth fluorescent optical detector (FL5) receiving a fifth wavelength range of fluorescent light, and so on to an Nth fluorescent optical detector (FLN) receiving an Nth wavelength range of fluorescent light. Each of the detector arrays 42A-42N receives light corresponding to the cells/particles that are struck and/or one or more fluorescent dyes that attached thereto and excited by the differing laser light in interrogation regions/points 30A-30N along the flow channel 27 of the flow cell 28 by each of the corresponding plurality of lasers 23A-23N. The emission optics system 16 gathers photons emitted or scattered from passing cells/particles and/or a fluorescent dyes attached to the cells/particles. The emission optics system 16 directs and focuses these collected photons onto the electro-optical detectors SSC, FL1, FL2, FL3, FL4, and FL5 in each detector array, such as by fiber optic (optical fibre) cables 39, one or more one or more lenses 40, and one or more mirrors/filters 41. Electro-optical detector SSC is a side scatter channel detector detecting light that scatters off the cell/particle. The electro-optical detectors FL1, FL2, FL3, FL4, and FL5 are fluorescent detectors may include band-pass, or long-pass, filters to detect a particular and differing fluorescence wavelength ranges from the different fluorescent dyes excited by the different lasers. Each electro-optical detector converts photons into electrical pulses and sends the electrical pulses to the acquisition (electronics) system 18.

For each detector array 42A-42N, the acquisition (electronics) system 18 includes one or more analog to digital converters 47A-47N and one or more digital storage devices 48A-48N that can provide a plurality of detector channels (e.g., 16, 32, 48 or 64 channels) of spectral data signals. The spectral data signals can be signal processed (e.g., digitized by the A/Ds) and time stamped, and packeted together by a packetizer 52 into a data packet corresponding to each cell/particle in the sample). These data packets for each cell/particle can be sent by the acquisition (electronics) system 18 to the analysis system 20 for further signal processing (e.g., converted/transformed from time domain to wavelength domain) and overall analysis. Alternatively, or conjunctively, time stamped digital spectral data signals from each channel that is detected can be directly sent to the analysis system 20 for signal processing.

The analysis system 20 includes a processor, memory, and data storage to store the data packets of time stamped digital spectral data associated with the detected cells/particles in the sample. The analysis system 20 further includes software with instructions executed by the processor to convert/transform data from the time domain to data in a wavelength/frequency domain and stich/merge data together to provide an overall spectrum for the cell/particle/dyes excited by the different lasers and sensed by the detector arrays. With detection of the type of cell/particle through the one or more fluorescent dyes attached thereto, a count of the cells/particles can be made in a sample processed by a flow cytometer and/or cell sorter.

In some cases, it is desirable to sort out the cells in a sample for further analysis with a cell sorter (sorting flow cytometer). Accordingly, the spectral data signals can also be processed by a real time sort controller 50 in the acquisition (electronics) system 18 and used to control a sorting system 33 to sort cells or particles into one or more test tubes 34. In which case, the sorting system 33 is in communication with the real time sort controller 50 of the acquisition (electronics) system 18 to receive control signals. Instead of test tubes 34, the spectral data signals can also be processed by the real time sort controller 50 of the acquisition (electronics) system 18 and used to control both the sorting system 33 and a droplet deposition system 29 to sort cells or particles into wells 35 of a moving capture tray/plate. In which case, both the droplet deposition system 29 and the sorting system 33 are in communication with the acquisition (electronics) system 18 to receive control signals. In an alternate embodiment, the analysis system 20 can generate these control signals from analyzing the spectral data signals in order to sort out different cells/molecules and control the sorting system 33 and the droplet deposition system 29 to capture the drops of samples with cells/particles into one or more wells 35 of the plurality of wells in the capture tray/plate.

U.S. patent application Ser. No. 15/817,277 titled FLOW CYTOMETERY SYSTEM WITH STEPPER FLOW CONTROL VALVE filed by David Vrane on Nov. 19, 2017, now issued as U.S. patent Ser. No. 10/871,438; U.S. patent application Ser. No. 15/659,610 titled COMPACT DETECTION MODULE FOR FLOW CYTOMETERS filed by Ming Yan et al. on Jul. 25, 2017; and U.S. patent application Ser. No. 15/942,430 COMPACT MULTI-COLOR FLOW CYTOMETER HAVING COMPACT DETECTION MODULE filed by Ming Yan et al. on Mar. 30, 2018, each of which disclose exemplary flow cytometer systems and subsystems all which are incorporated herein by reference for all intents and purposes. U.S. Pat. No. 9,934,511 titled Rapid Single Cell Based Parallel Biological Cell Sorter issued to Wenbin Jiang on Jun. 19, 2016, discloses a cell sorter system that is incorporated herein by reference for all intents and purposes.

### Compact Cell Sorter

FIG. 1B illustrates a front view of an integrated compact cell sorter system 100. The integrated compact cell sorter system 100 includes a chassis/frame 101 (see FIG. 1C) to support the various systems and subsystems of the cell sorter. A fluidics panel/door 102, a flow cell door 111, a droplet deposition unit (DDU) door 112, and a sample input door 113 are pivotally coupled to the chassis/frame 101 to cover over and seal various chambers of the cell sorter system. One or more side panels 114 are used to cover over other portions of the chassis/frame and the subsystems therein in a more fixed manner. A fluidics input/output panel 104 connects the cell sorter system 100 to external fluid tanks and an external gas supply, such as a pressurized air supply.

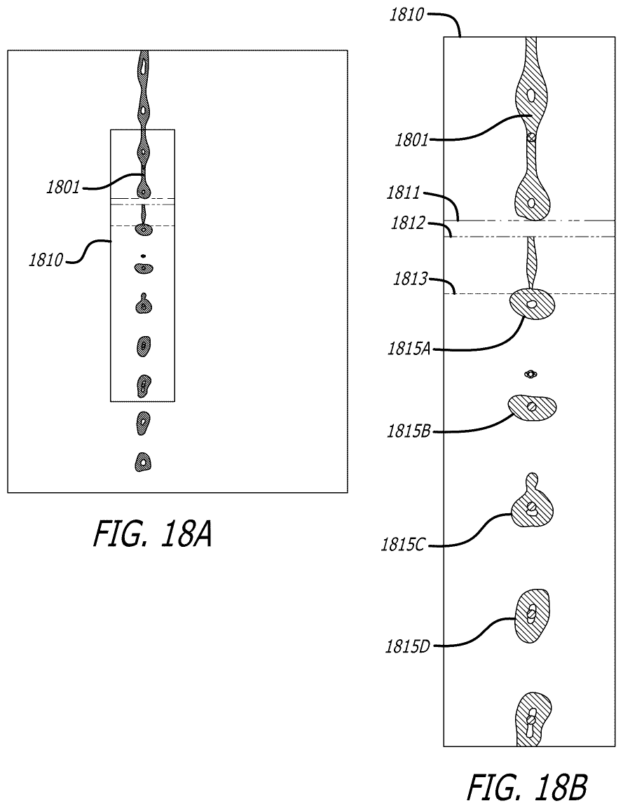

Referring now to FIG. 1C, a front view of the integrated compact cell sorter system 100 is shown with opened doors and panels removed. The fluidics panel/door 102, the flow cell door 111, the DDU door 112, and the sample input door 113 of the integrated compact cell sorter system 100 are pivoted to an open position around hinges to reveal the various systems and subsystems of the cell sorter system. The integrated compact cell sorter system 100 includes a fluidics bucket 120 (part of the fluidics system 1800 of FIG. 18), a deflection chamber 122, a flow cell 124, a sample pressure chamber 126 a droplet deposition unit (DDU) chamber or collection chamber 128, a sample input station (SIS) 130, and a sort collection camera 132. The sample input door 113 has a window 134 through which a sample tube can be viewed if mounted in the SIS 130. The DDU door 112 has a sort collection camera 132 that can view left and right deflected drops fall out of a slot in the deflection chamber 122 and into the DDU chamber 128 to be collected by test tubes or wells in a well plate.

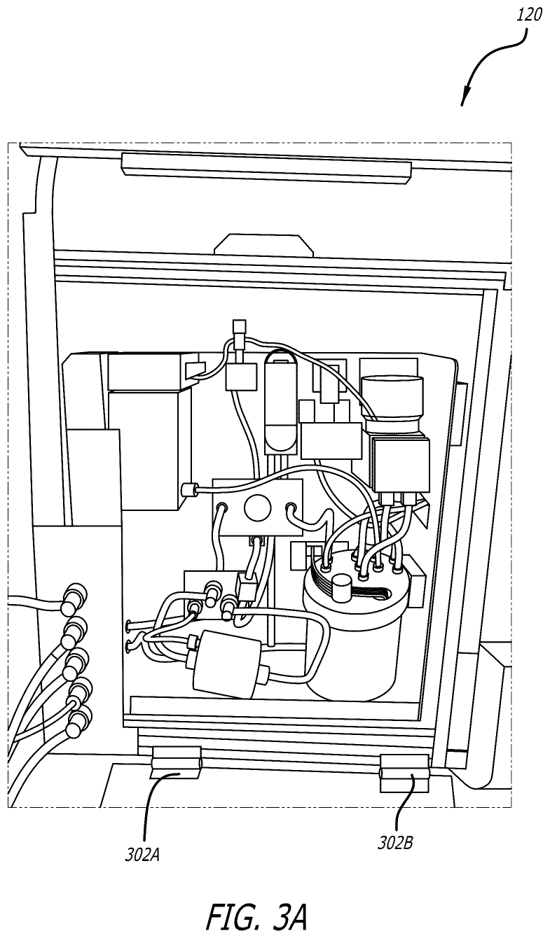

The fluidics bucket 120 (part of the fluidics system 1800 of FIG. 18) includes a gas bubble remover eliminating gas bubbles in the sheath fluid. The fluidics bucket 120 is further discussed with reference to FIGS. 3A-3B. The fluidics system 1800 (discussed in FIG. 18) is under pressure to cause a sheath fluid and a sample biological fluid to flow.

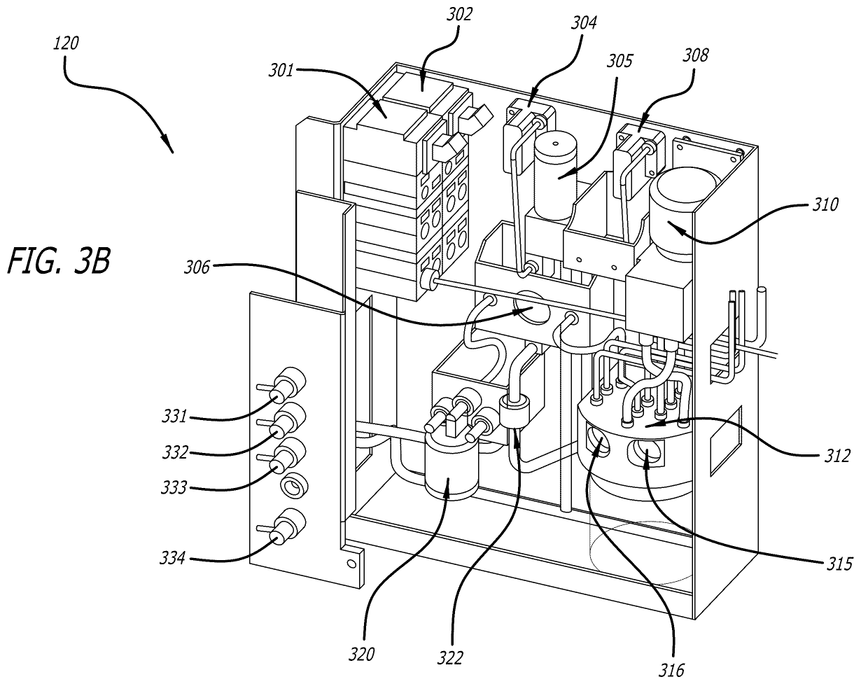

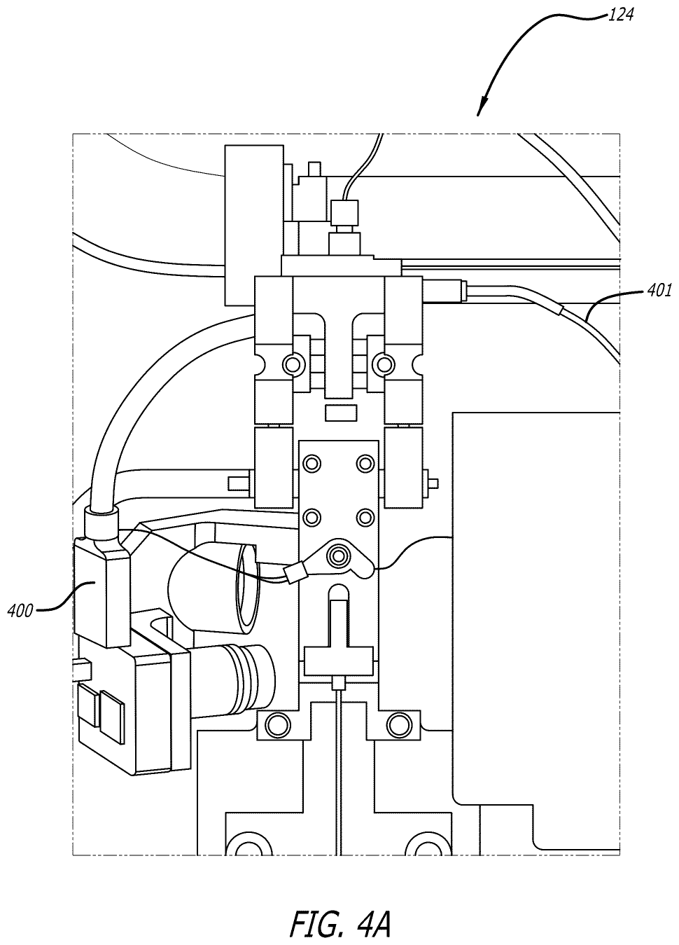

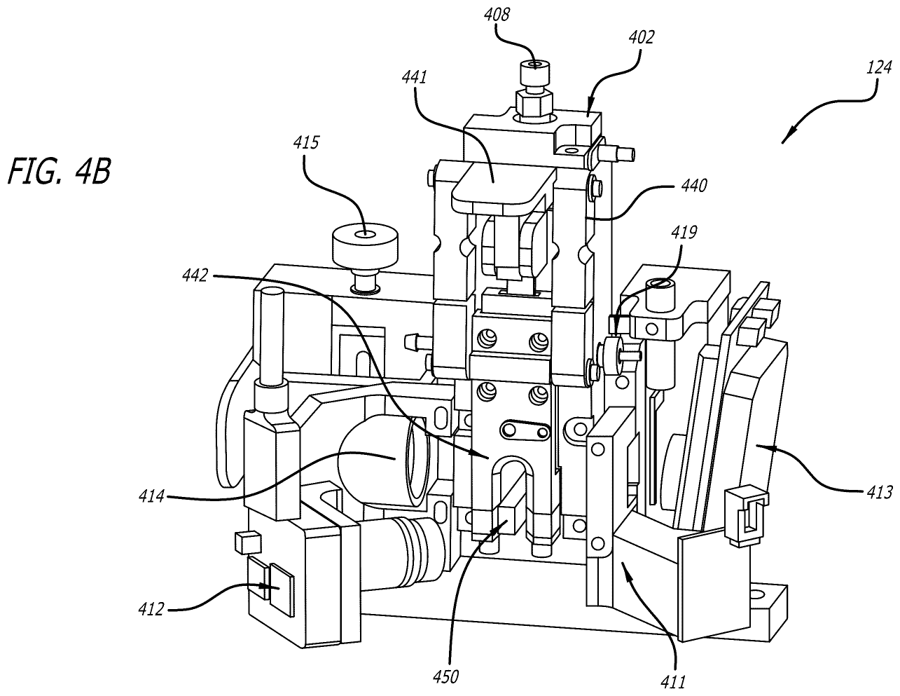

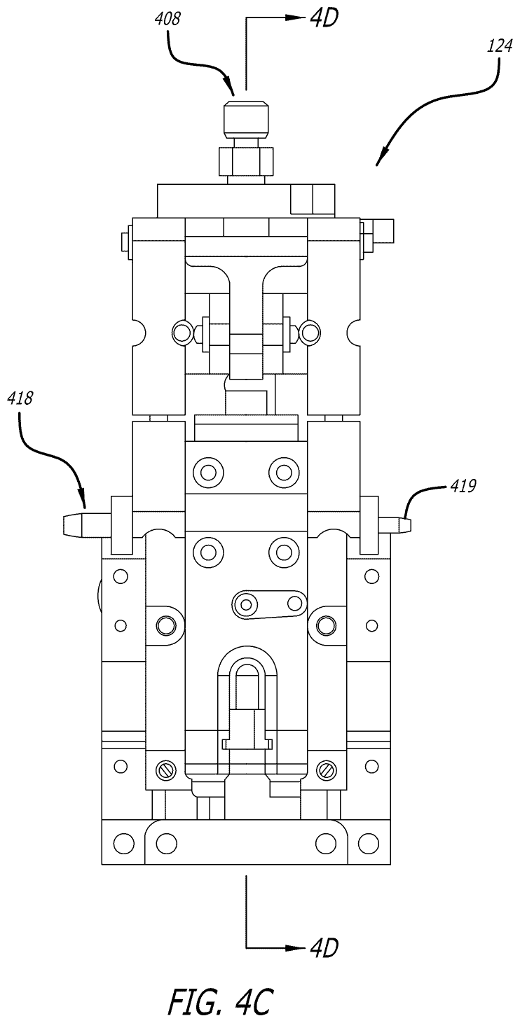

The flow cell 124 is coupled in communication with the fluidics bucket 120 to receive the sheath fluid. A sample biological fluid flows with cells or particles through the flow cell 124 to be surrounded by the sheath fluid. The flow cell 124 is further discussed with reference to FIGS. 4A-4G.

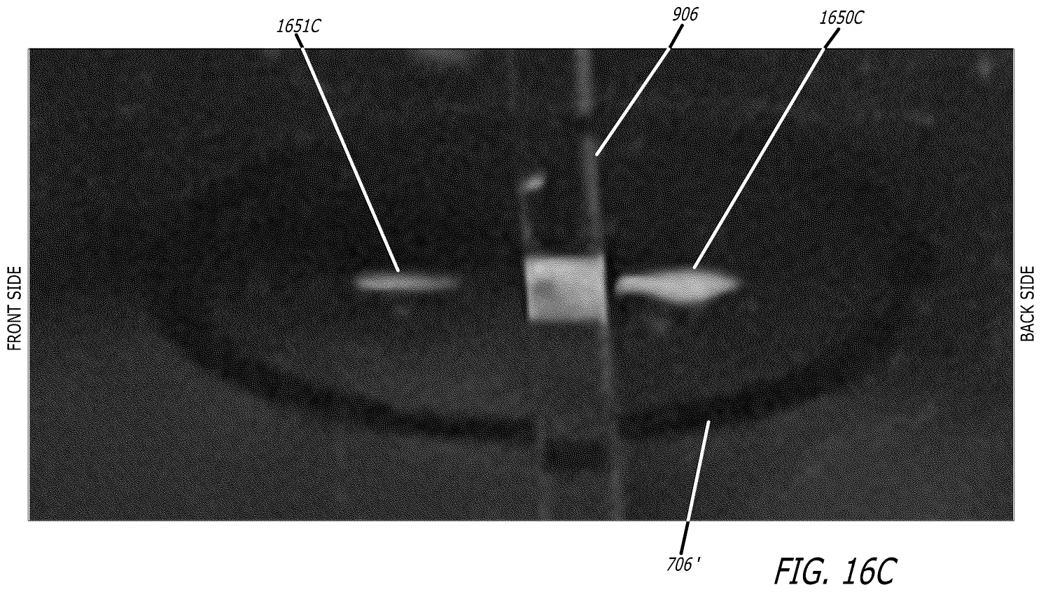

The deflection chamber 122 is under the flow cell 124 to receive the drops of sample biological fluid and sheath fluid out of the flow cell 124. The deflection chamber 122 selectively deflects one or more of charged drops away from the center stream path along one or more deflection paths. The deflection chamber 122 is further discussed with reference to FIGS. 16A-16B.

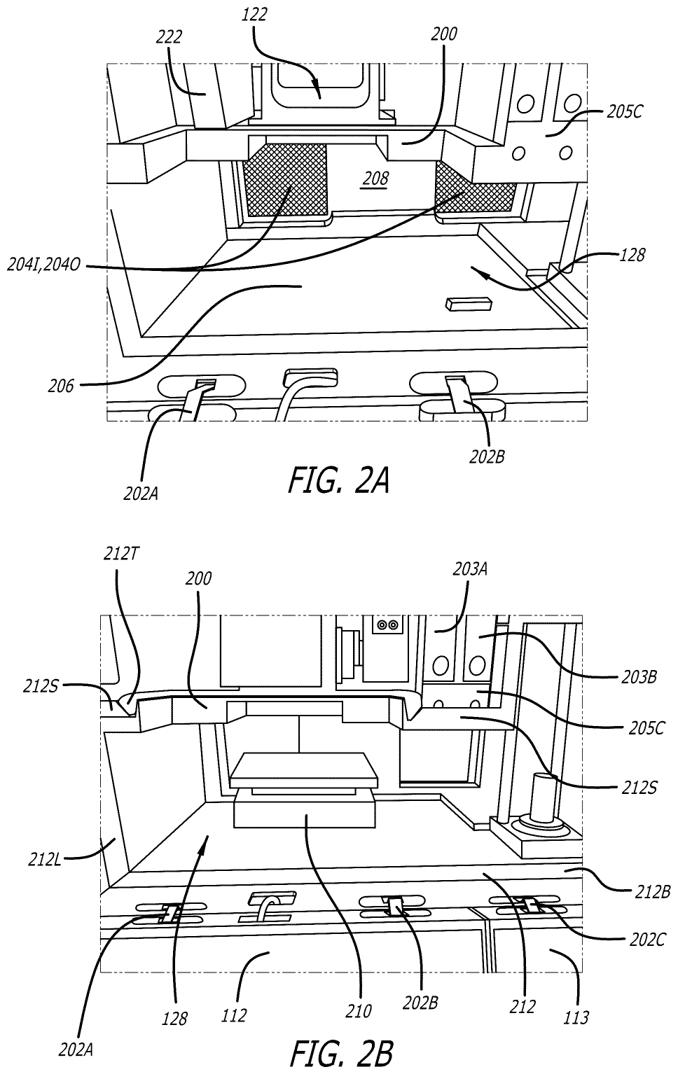

The droplet deposition unit (DDU) chamber/system 128 is in communication with the deflection chamber 122 to receive selectively deflected drops in the stream of the sample biological fluid with the one or more biological cells or particles into one or more containers. The DDU chamber 128 is further discussed with reference to FIGS. 2A-2B.

In one embodiment, the flow cell 124 includes a flow cell body coupled in communication with the fluidics system to receive the sheath fluid, the flow cell body having charging port to charge the droplets, the flow cell body having a chamber with a circular cylindrical portion and a funnel portion, the funnel portion to form a fluid stream of the sample fluid surrounded by the sheath fluid out of a bottom side opening; a drop drive assembly coupled to the flow cell body, the drop drive assembly including a glass sample injection tube (SIT) inserted into the chamber of the flow cell body and having a first end located in the funnel portion of the chamber, the glass sample injection tube having a second end coupled in communication with the fluidics system to receive the sample fluid and inject the sample fluid into the funnel portion of the chamber; and a cuvette coupled to a base of the flow cell body, the cuvette having a flow channel adjacent the bottom side opening of the flow cell body, the cuvette to receive the fluid stream of the sample fluid surrounded by the sheath fluid out of the bottom side opening, the cuvette being transparent to light and allowing the sample fluid to undergo interrogation in the flow channel by a plurality of different lasers to determine a plurality of different types of cells or particles in the sample fluid.

In one embodiment, the flow cell 124 includes the following: a flow cell body coupled around the drop drive assembly to receive the sample fluid from the sample injection tube, the flow cell body coupled in communication with the fluidics system to receive the sheath fluid, the flow cell body having a charging port to charge the droplets, the flow cell body having a funnel portion to form a fluid stream of the sample fluid surrounded by the sheath fluid out of an opening; and a cuvette coupled to a base of the flow cell body, the cuvette having a channel to receive the fluid stream of the sample fluid surrounded by the sheath fluid out of the opening, the cuvette being transparent to light and allowing the sample fluid to undergo interrogation in the channel by a plurality of different lasers to determine a plurality of different types of cells or particles therein.

In one embodiment, the flow cell 124 further includes the following: a nozzle assembly selectively engaged with the cuvette, the nozzle assembly having a nozzle and an O-ring around the nozzle selectively pressed against a face of the cuvette around the channel, the nozzle receiving the sample stream from the cuvette and forming sample drops out of the nozzle assembly; a carriage assembly slidingly coupled to the flow cell body, the carriage assembly to slidingly receive the nozzle assembly; and a linkage (one or more links or a plurality of links) pivotally coupled to the carriage assembly (e.g., tiltable carriage plate) and the flow cell body, the linkage including a lever arm to selectively engage the nozzle with the cuvette to receive a fluid stream and selectively disengage the nozzle from the cuvette to repair or replace the nozzle.

In one embodiment, the flow cell 124 further includes the following: a lever hinge formed to be statically coupled to the flow cell body; a carriage release lever rotatably coupled to the lever hinge; and two lever arms rotatably coupled to the carriage release lever and to a carriage plate of the carriage assembly, wherein the two lever arms, the carriage plate, the carriage release lever, and the lever hinge have a kinematic linkage that enables the carriage assembly to maintain a vertical movement along the center axis.

In one embodiment, the flow cell 124 further includes the following: a nozzle assembly having the following: a nozzle handle having a body with a gripping end and a nozzle end, the body having a through hole between top and bottom surfaces near the nozzle end with a partial gland in the top surface extending around the through hole, the partial gland having a slot extending out from the through hole to the nozzle end of the nozzle handle; a nozzle insert positioned in a portion of the through hole of the body of the nozzle handle, the nozzle insert having a circular body with a center nozzle orifice concentric with the through hole to flow drops of a sample fluid, and a beveled ring in a top surface extending out from the circular body; a gasket positioned in the partial gland against the beveled ring of the nozzle insert with a portion extending above the top surface of the nozzle insert and the top surface of the nozzle handle, the gasket to provide a seal around the center nozzle orifice; and wherein the slot extending out from the partial gland to the nozzle end facilitates removal of the gasket.

In one embodiment, the DDU system 128 includes the following: a case or a housing with an open face surround by edges of the case, the case forming a portion of a containment chamber, the case having a top side opening aligned with the deflection chamber to receive the selectively deflected drops in the stream of the sample biological fluid into one or more containers in the containment chamber, a seal mounted around edges of the case, one or more hinges coupled to a bottom portion of the case, and a door coupled to the one or more hinges to pivot the door about the one or more hinges, the door when closed to press against the seal and close off the containment chamber from an external environment.

In one embodiment, the DDU system 128 includes the following: an electromagnetic lock comprising at least one electromagnet mounted to the case and a metal latch coupled to an inside surface of the door, wherein the metal latch is attracted to the at least one electromagnet when the door is closed and the at least one electromagnet is energized.

In one embodiment, the DDU system 128 includes a magnetic lock comprising at least one magnet mounted to the case and a metal latch coupled to an inside surface of the door, wherein the metal latch is attracted to the at least one magnet when the door is closed.

### DDU Chamber

FIG. 2A illustrates a portion of the deflection chamber 122 with its door 222 being open. The DDU chamber 128 of the cell sorter 100 is viewable with both the doors 112-113 pivoted to open positions. Openings in a back wall 208 of the DDU chamber 128 show an input air filter 2041 and an output air filter 2040 mounted within tunnels leading to an air conditioning chamber. Behind the back wall 208 are one or more fans and at least one heating/air conditioning element to force the air through the air filters and maintain a desirable range of temperatures of the sample in the SIS 130 and the sorted cells/molecules in the DDU chamber 128.

At a base of the DDU chamber 128 is a separation plate 206 that separates a driver mechanism under the separation plate from the DDU chamber 128. Under the separation plate 206 are magnetic control mechanisms to control movement of a magnetically coupled puck 210 shown in FIG. 2B. A magnetic loading system for the DDU chamber and the magnetically coupled puck 210 is disclosed by U.S. provisional patent application No. 63/146,562, titled LOADING SYSTEM WITH MAGNETICALLY COUPLED SAMPLE MOVER FOR FLOW CYTOMETRY AND CELL SORTER SYSTEMS filed on Feb. 5, 2021 by Babak Honaryar et al., and incorporated herein by reference for all intents and purposes. Movement of the magnetically coupled puck 210 is controlled underneath the separation plate 206 by the magnetic loading system.

FIG. 2B illustrates a seal 212 that is mounted along edges of the DDU chamber 128 and the sample input station 130 to provide air resistive seal when the DDU door 112 and sample input door 113 are closed. The DDU door 112 has a shelf 133 (shown in FIG. 1C) that presses down on a top seal portion 212T when closed. Other portions of the seal 212, such as the bottom portion 212B and side portions 212S,212L, are pushed on by the doors 112-113 and squeezed up against the edges of the DDU chamber 128. With the doors closed, the DDU chamber 128 is sealed off from the ambient air of the environment (e.g., laboratory) where the cell sorter 100 is stationed. Furthermore, the DDU chamber 128 and SIS 130 are under negative pressure from a vacuum to additionally help prevent cells/molecules/gases from escaping out of the cell sorter into the ambient air of the environment, such as a laboratory.

The DDU door 112 and sample input door 113 provide a good seal to isolate the DDU chamber 128 from other parts of the flow cytometer/cell sorter 100 as well as the ambient environment. The sample drops sorted out and captured in the DDU chamber 128 may desire a temperature-controlled environment to maintain them. Furthermore, the cells that are captured may be a pathogen that are not desired to be an aerosol and escape into the environment. Accordingly, with the magnetic loading system and the sealed doors, the cell sorter can provide an integrated filtration system and temperature-controlled environment to the DDU chamber 128.

### Fluidics Bucket

FIGS. 3A-3B illustrate various views of the fluidics bucket 120 which is a part of the fluidics system of the cell sorter system 100. FIG. 18 illustrates a schematic diagram of elements in the fluidics bucket 120.

In FIG. 3B, the fluidics bucket 120 includes a sample regulator 301 and a sheath regulator 302 that control the fluidic pressure of the sample fluid and the sheath fluid, respectively. The fluidics bucket 120 further includes a degasser switch 304 and a degasser pump 305 to provide air pressure so that the degasser 306 can remove bubbles from the sheath fluid. Fluidics bucket further includes an aspirator pump 310 to externally aspirate waste out of the cell sorter system through the waste output port 334. The valve manifold 312 includes a plurality of valves to control the fluid system and a sample transducer 315 and a sheath transducer 316. The fluidics input output panel 104 includes a supply air input 331, sheath air output 332, a sheath fluid input 333, and a waste output 334. The sheath fluid 333 flows through a sheath filter 320 before entering the flow cytometer system 100. The fluidics bucket includes a pressure switch that controls opening pressure of the Sample Pressure Chamber. The aspirator pump maintains the vacuum in the tank below the valve manifold 312.

### Flow Cell Assembly

FIGS. 4A-4G illustrate various views and components of the flow cell assembly 124. In FIG. 4A the flow cell 124 has a ground connection 400 to a metal surface. This is to shield the sample fluid from charges being generated by the deflection unit and to remove charges that may have been already present.

Referring now to FIG. 4B, the flow cell 124 includes a drop drive assembly 402, the nozzle assembly 450 and nozzle carriage assembly 442 a carriage release lever 441 of a flow cell linkage 440. The flow cell 124 has a number of optical components including a drop camera for 412, drop strobe assembly 411, forward scatter assembly 413, and a final focus lens 414. The final focus lens for 414 can be focused by a final focus adjustment 415. The drop drive assembly 402 has a sample input port 408 to receive a hose or pipe that carries the sample fluid.

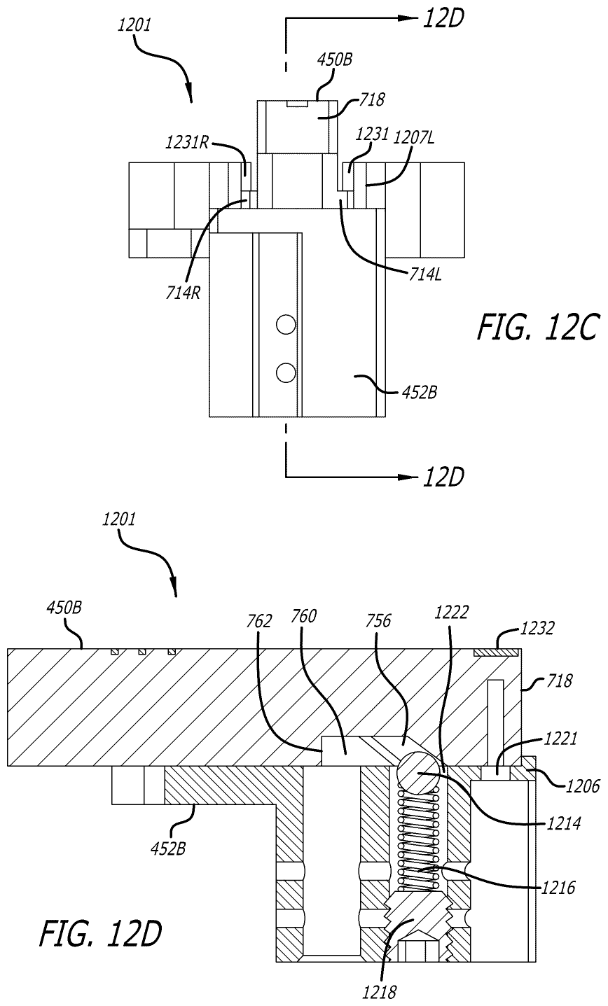

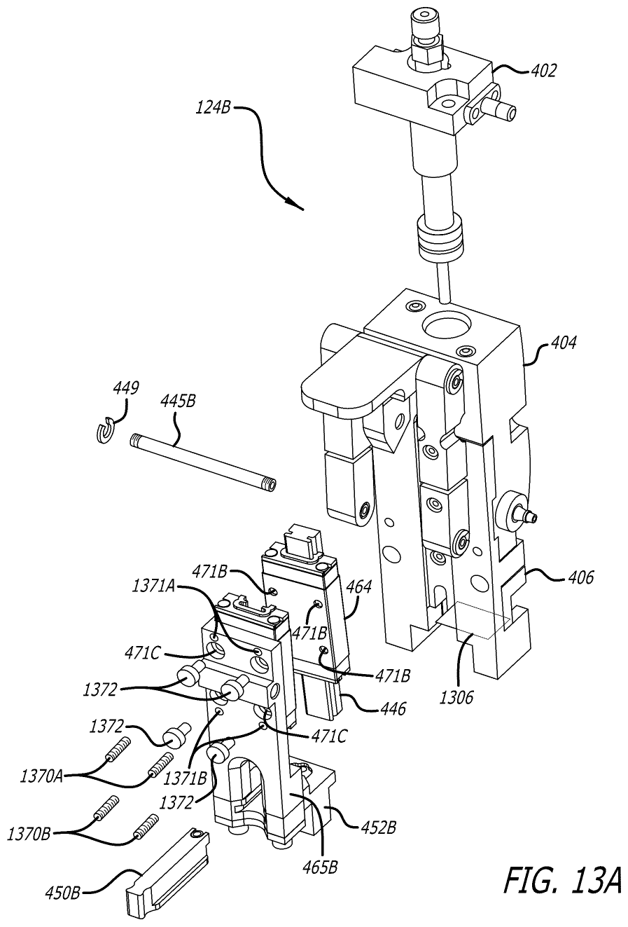

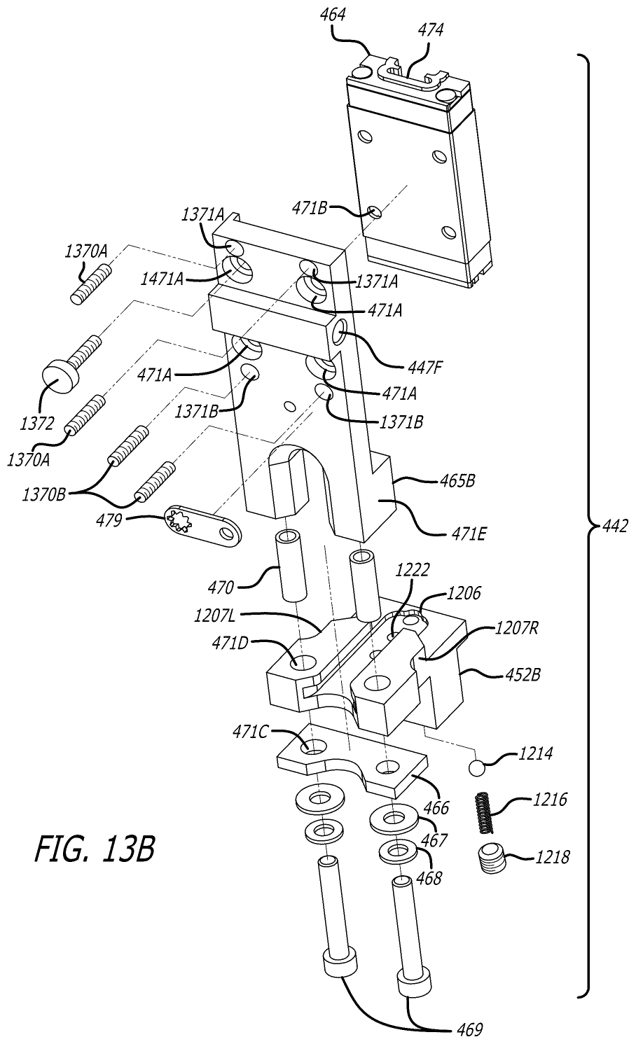

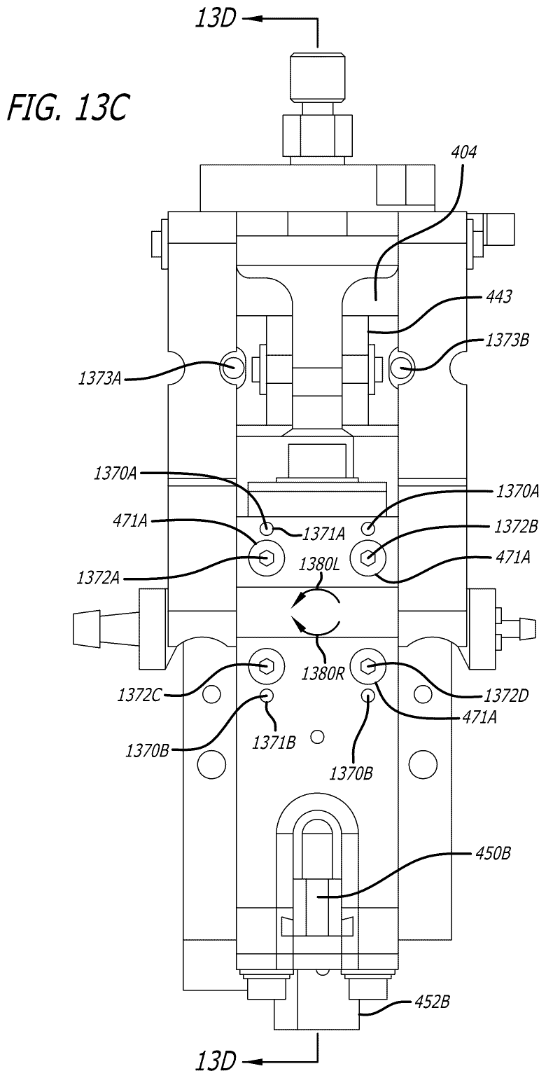

Referring now to FIG. 4C, the fluid ports for the flow cell 124 are shown. The flow cell 124 receives the sample fluid through a sample inlet port 408. The flow cell 124 receives the sheath fluid through a sheath input port 418. The flow cell 124 surrounds a stream of the sample fluid with sheath fluid. The flow cell 124 includes a conductive drain port fitting 419 threaded into the drain port (see right side port 1256 in FIG. 12C) of the flow cell body 404 to evacuate fluids from chambers inside the flow cell, and to impart charge onto the drops of sample fluid with a cell/particle. An electrical wire and a hose both couple to the conductive drain port fitting 419. The electrical wire is in communication with the sort controller to receive a signal that is synchronized with the drops. Over time the signal may be ground, one or more levels of positive charge voltages (e.g., +150, +300), or one or more levels of negative charge voltages (e.g., −150, −300) to respectively keep a drop uncharged, to positively charge a drop, or to negatively charge.

Referring now to FIG. 4D, a side cross-section of the flow cell 124 shown. the flow cell 124 includes a flow cell body 404, a drop drive assembly 402, a cuvette 406, a linkage assembly 440, a carriage assembly 442, and a nozzle assembly 450 with a nozzle 704. The linkage assembly 440 includes a carriage release lever 441 that pivots to move the nozzle assembly up and down with respect to the cuvette 406. The drop drive assembly 402 includes a sample injection tube 422.

The flow cell body 404 has top, bottom, left, right, front and back sides. In the top side, the flow cell body includes a top chamber opening leading into a chamber of the flow cell body 404. The drop drive assembly (including the sample injection tube) is mounted through the top chamber opening into the chamber. The flow cell body receives the sample fluid from the sample injection tube of the drop drive assembly. In one side (e.g., left side), the flow cell body includes an input port coupled in communication with the fluidics system of the cytometer to receive sheath fluid. In an opposite side (e.g., right side), the flow cell body includes an output port in line with the input port. The pressure of the sheath fluid and the sample fluid are independently controlled to achieve a desired flow rate of sample fluid surrounded by sheath fluid out of the chamber and into the flow channel 906 of the cuvette 406.

The flow cell body 404 has an opening or pocket in the back side. The pocket receives the cuvette 406 so that the flow channel 906 lines up with the stream of drops from the bottom opening in the chamber of the flow cell body. For the most part, the cuvette 406 (which is clear and transparent) is hidden from view in the front side by the opaque body of the flow cell 404 and the carriage assembly and nozzle assembly mounted in the mount. The pocket has an open left side and an open right side that allow laser light from one or more lasers to pass into the side of the cuvette and strike the cells/particles flowing in the flow channel. The laser light may be injected into the cuvette on one side and collected on an opposite side by an optical fiber or forward scatter detector.

A base or bottom side of the flow cell body 404 also has a a small cutout (upper arched cutaway) from front side to back side. Because the cuvette is fairly well hidden, the small cutout allows a microscope test instrument to be inserted through the front side of the flow cell body to view the flow channel in the cuvette 406 from the front side of the flow cell assembly 124.

The large cutout in the base of the flow cell body allows the nozzle assembly 450,450B to be mounted into the mount 452,452B below the cuvette 406. The large cutout further allows the nozzle assembly 450 to be moved up and down by the linkage and the carriage assembly into below the cuvette.

Laser light from one or more lasers is sent into one or more interrogation regions in the flow channel of the clear cuvette 406 to excite flowing cells/particles and/or one or more fluorescent dye markers attached thereto that pass by. The flow cell 124 further includes one or more objective lenses 460A-460B in order to capture light (e.g., reflected light, scattered light, fluorescent light) from the cells/particles and/or the one or more fluorescent dyes attached to the cells/particles on one side. On an opposite side, the one or more objective lenses 460A-460B can launch the captured light into a fiber optic cable.

To support the movement of the linkage 440 and the carriage assembly 442, the flow cell body 404 can include a plurality of threaded openings in the front side. The threaded openings can receive threaded fasteners through holes in the linear slide rail 446 to mount it to the front side of the flow cell body. The linear slide rail 446 is used to allow the nozzle carriage assembly 442 to slide up and down with respect to the release lever 441 and the linkage 440. The flow cell body can further include a shallow oval opening in the front side to receive the spring 427 and the detent 461 (spring loaded detent) for holding the position of the release lever 441, the linkage, the carriage assembly, and the nozzle assembly. The hole or opening is oval in order to allow the spring and the detent to move up and down with adjustments in position of the hinge bracket 443.

Referring now to FIG. 4E, a front cross-sectional view of the flow cell 124 is shown. The flow cell 124 includes a flow cell body 404 to receive the drop drive assembly 402. The nozzle assembly 450 is slid into a mount 452 that is coupled to the carriage assembly. The sample injection tube 422 is preferably formed of glass to avoid surface etching in the presence of electrical currents in the sheath fluid for drop charging and vibration of the drop-drive for drop separation that can cause leakage. The drop drive assembly 402 includes a sample inlet 408 to receive the sample fluid.

Referring now to FIG. 4F, a cross-sectional view of the flow cell 124 is shown cut through the drain port/charging port with the conductive hose fitting 419 and the sheath inlet port with its hose fitting 418. The sample injection tube 422 is centered in a chamber within the flow cell body 404. The flow cell 124 includes a rear focus adjustment 463 for the one or more objective lenses.

FIG. 4G illustrates a side view of the flow cell 124. The center optical axes of the objective lenses 460A-460B are shown lined up to receive light only from the cuvette. The objective lens mount 461 assures that the objective lenses 460A-460B remain in alignment. The flow cell body 404 is opaque so that light from other sources, such as ambient, is not captured by the objective lenses for 460A-460B.

The nozzle assembly 450 slides in and out of the mount 452 in order to service or repair components of the nozzle assembly or swap for a different diameter of opening in the nozzle. The nozzle of the nozzle assembly receives a sample flow of fluid from a cuvette and forms drops with preferably a single cell/particle each for sorting out.

### Flow Cell Linkage and Nozzle Carriage

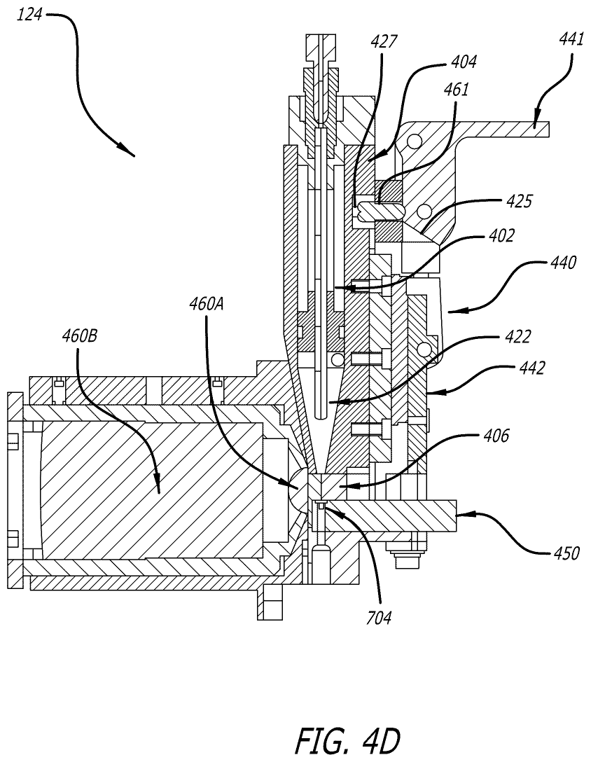

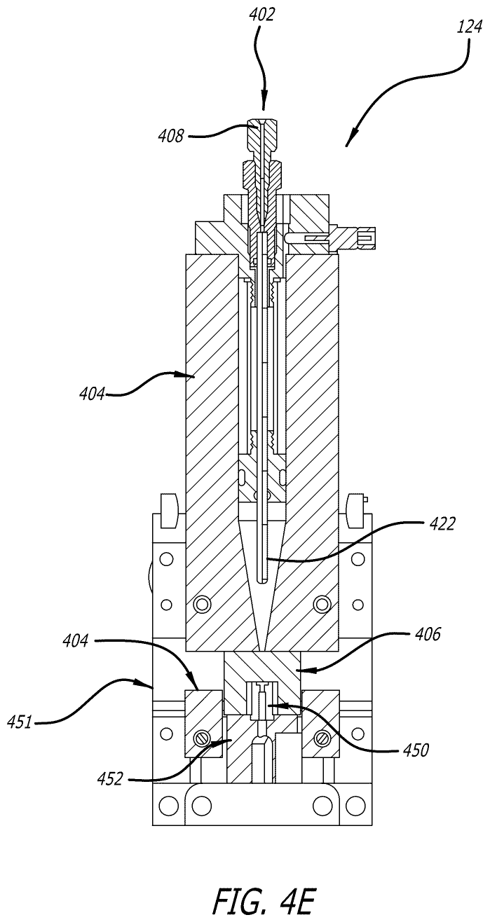

FIGS. 4H-4L illustrate various views and components of the flow cell linkage 440 and nozzle carriage assembly 442 for the flow cell assembly 124 of the cell sorter system 100. FIGS. 5A-5B and 6A-6B respectively illustrate side views and cross section views of the flow cell assembly 124 to show operation of the flow cell linkage 440 and nozzle carriage assembly 442.

Referring now to FIG. 4H an exploded view of the flow cell 124 is shown. The flow cell 124 includes flow cell linkage 440 and the nozzle carriage assembly 442. The nozzle assembly 450 slides into and out of the mount 452. an exploded view of the nozzle carriage assembly 442 is shown in FIG. 4I.

The flow cell linkage 440 includes a carriage lever 441, left and right spring-loaded lever arms 444L-444R, nozzle carriage assembly 442 pivotally coupled together at pivot points by pivotal shafts 445A-445C. Each of the pivotal shafts 445A-445C can include washers along the shaft between the lever arms and the pivotal openings 447A, 447C, and 447F. Each of the pivotal shafts 445A-445C is retained within the pivotal openings by a circlip (retention fastener) 449.

The carriage lever 441 is pivotally mounted to a pair of pivot point openings 447C in arms of a leverage hinge bracket 443 by shaft 445C at a pivot point opening 447B in a protrusion extending from the lever.

A top pivot point opening 447D in each of the left and right lever 444L-444R arms is pivotally coupled to the lever 441 at a pivot point opening 447A by the shaft 445A. A lower pivot point opening 447E in each of the left and right lever arms 444L-444R is pivotally coupled to the nozzle carriage assembly 442 at pivot point opening 447F by the pivotal shaft 445B. The nozzle carriage assembly 442 is slidingly coupled to a linear slide rail 446 that is mounted to the flow cell body 404 by one or more fasteners (e.g., threaded screws or bolts).

In operation, the carriage lever 441 pivots about pivot point opening 447B thereby lifting up or letting down at the top of the lever arms 444L-444R through the shaft 445A at pivot point openings 447A,447D. This translates through the lever arms into linear motion at the bottom pivot point openings 447E. By the shaft 445B through the bottom pivot openings 447E in the lever arms 444L-444R and the pivot opening 447F in the nozzle carriage assembly 442, the liner motion in the lever arms is translated into a linear motion in the carriage assembly 442. With a nozzle assembly 450 slid into the mount 452, the carriage assembly 442 can lift up and lower down the nozzle assembly to engage and disengage with the cuvette 406.

The lever arms 444L-444R are spring-loaded between an upper portion and a lower portion to be sure a proper force is exerted upward on the nozzle assembly 450. This assures that an O-ring is squeezed to properly seal up against a surface the cuvette 406.

The flow cell linkage 440 is adjustable upward and downward by the hinge bracket 443. The hinge bracket 443 has a pair of elongated openings 460 in opposite sides of the flanges that mount to the flow cell 404. A pair of screws or bolts (not shown) are inserted through the elongated openings 460 through the elongated openings 460 and into threaded openings in the flow cell 404. The elongated openings 460 allow the bracket 443 to shift up or down around the pair of screws or bolts when loosened. The movement of the bracket 443 adjusts the entire flow cell linkage 440, including the carriage assembly 442, up or down.

The flow cell linkage 440 further includes a spring loaded lever detent 461 with one end inserted into an opening in the flow cell 404 that can couple against a spring 427 (see FIG. 4D). As shown in FIG. 4D, an opposite end of the lever detent 461 rides up against a backside cam 425 in the lever hinge 441 to maintain the flow cell linkage 440 in either of an upward position or a downward position.

Referring now to FIG. 4I, an exploded view of the nozzle carriage assembly 442 is shown. The nozzle carriage assembly 442 includes a carriage plate 465, a linear bearing 464, the nozzle mount 452, a clamping plate 466, flat washers 467, lock washers 468, threaded bolts 469, and alignment tubes 470 assembled together. The threaded bolts 469 are inserted through the lock washers 468, the flat washers 467, through holes 471C in the clamping plate 466, holes 471D in the nozzle mount 452, and inner hollow cylinders of the alignment tubes 470. The threads of the bolts 469 are screwed or threaded into threaded holes 471E in the base of the carriage plate 465 to hold the mount 452 coupled to the plate. Fasteners, such as metal screws, are inserted through a plurality of through holes 471A in the front of the carriage plate 465 and screwed into threaded holes 471B in the linear bearing 464 to couple the plate and bearing together.

The linear bearing 464 includes a pair of guide rails 474 in a backside to slide along the linear slide rail 446 shown in FIG. 4H. The front side of the carriage plate 465 includes the pivotal opening 447F to receive the shaft 445B. A rectangular shaped portion of the carriage plate extends out from the front face of the plate to form the pivotal opening 447F.

To electrically ground the carriage assembly 442, a ground wire lug 479 coupled to a ground wire is mounted by a fastener to near a front center portion of the carriage plate 465.

Referring now to FIGS. 4J through 4M, various views of the lever arm 444L-444R are shown. Each of the lever arms 444L-444R can include at least one small side cutout to allow the lever arms to pass by the ends of the shaft 445C. Each of the lever arms can also include a back side cutout adjacent the side cutout.

FIG. 4J illustrates the back notch 474 in each of the lever arms 444L-444R. The back notch provides clearance for the bracket 443 mounting screw heads.

FIG. 4K illustrates the spring-loaded assembly of each lever arm. FIG. 4K further illustrates the through holes 447D-447E. A bolt 480 holds the spring 476 and the upper and lower portions of each lever arm spring loaded together. The bolt 480 includes a shaft 477 with a smaller threaded portion 479 screwed into a threaded opening 478 in the upper portion up until the larger shaft buts up against a lower surface of the upper portion.

As shown in FIG. 4L, the shaft of the bolt 480 is inserted into and through the spring into the opening 481 in an end of the lower portion. The bolt 480 can have a hex head, a socket head, a screw head or otherwise a type of head rotatable by a tool inserted into the opening 481 in the end to reach the head deep in the opening.

The spring 476 presses up against the head of the bolt 480 at one end and presses against the bottom of the opening 481 in the lower portion at the opposite end. Accordingly, the lower portion and the upper portion of the lever arm can be slightly pulled apart and placed in tension up until the spring is fully compressed. The spring provides tension against the cam to help hold a position of the carriage release lever 441 and the carriage assembly.

Referring now to FIGS. 5A-5B, the motion in the flow cell linkage 440 is shown under control of the carriage release lever 441. In the upward position of the release lever 441, the nozzle carriage assembly 442 is in its highest position so that the nozzle assembly 450 engages the cuvette 406. In this highest position, the lever arms 444L-444R are in a substantially vertical position. The cam in the release lever 441 is held in the upright position by friction from the detente. Pressing down on the release lever 441 causes the lever arms 444L-444R to pivot in parallel together away from the flow cell body 404 and allows the nozzle carriage assembly 442 to slide down in the guide rails. This lowering of the nozzle carriage assembly 442 disengages the nozzle assembly 450 from the cuvette 406.

As can be seen in FIG. 5B, the carriage release lever 441 pivots around the shaft 445C in the lever hinge/bracket 443. A lower end of the lever arms 444L-444R pivot around the shaft 445B in the carriage plate of the carriage assembly 442. An upper end of the lever arms pivot about shaft 445A in the release lever 441. The L shape of the release lever pushes the lever arms 444L-444R out and slightly downward with respect to the flow cell body 404.

FIGS. 6A-6B better show the disengagement of the nozzle assembly from the cuvette 406. In FIG. 6A, the release lever 441 is in its upward position. The lever arms 444L-444R (see FIG. 5A) are in their upward vertical position. The nozzle assembly 450 is in an upward position engaging the cuvette 406. The O-ring seal of the nozzle assembly 450 is pressed up against the cuvette 406 to seal around the nozzle.

In FIG. 6B, the release lever 441 is in its lower position, the lever arms are pivot away from the flow cell body 404 and the carriage assembly is in a lower position along with the nozzle assembly 450. Accordingly, the nozzle assembly 450 is disengaged from the cuvette 406. A gap 602 is shown between the nozzle assembly 450 and the cuvette 406. In this lowered position, the nozzle assembly 450 can be slid out and away from the mount 452 of the carriage assembly 442.

### Nozzle Assembly

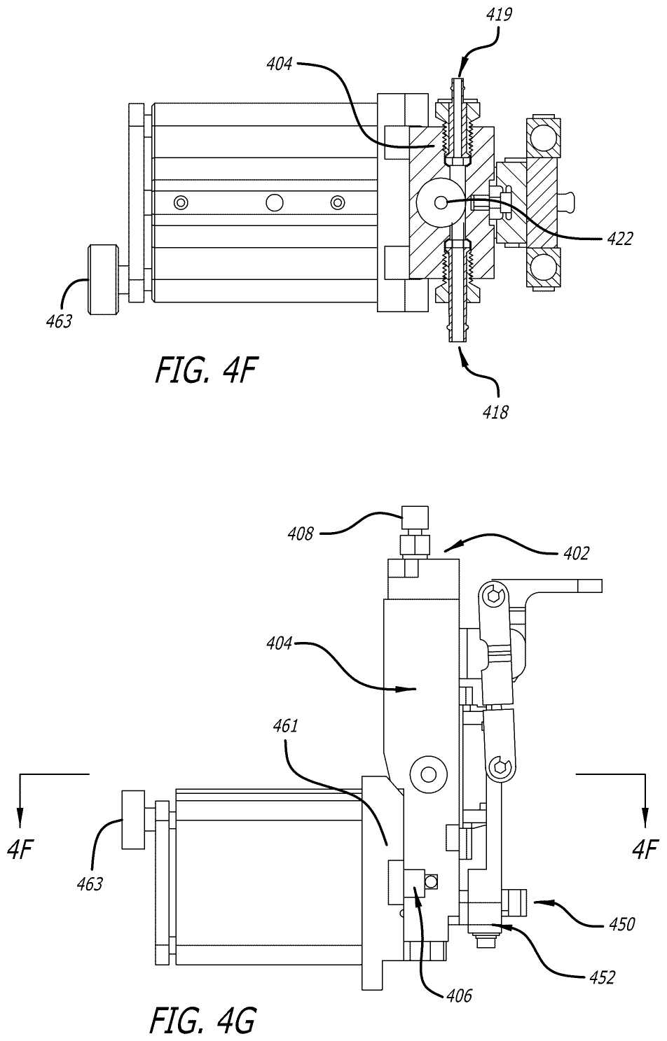

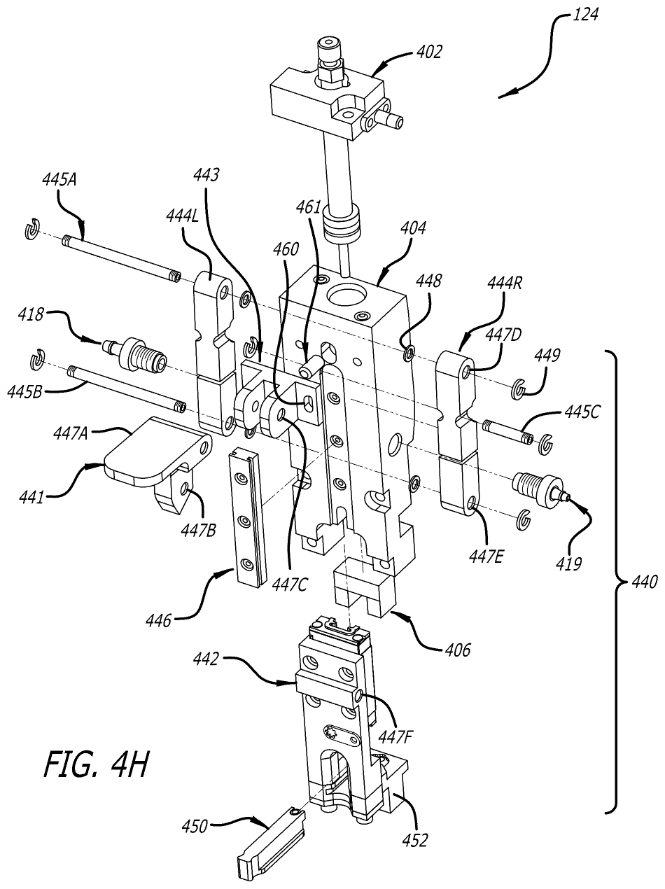

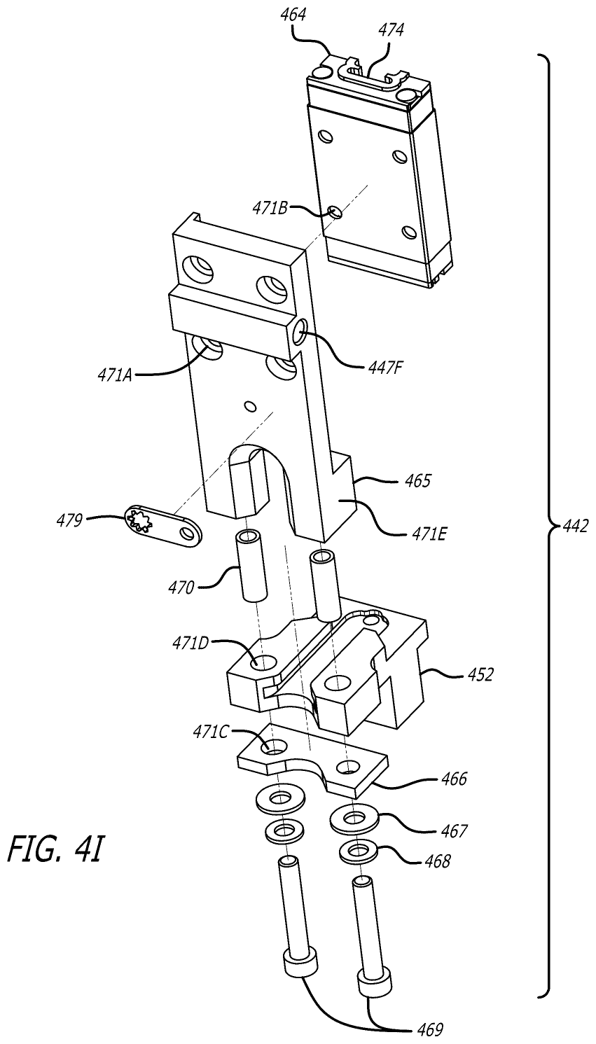

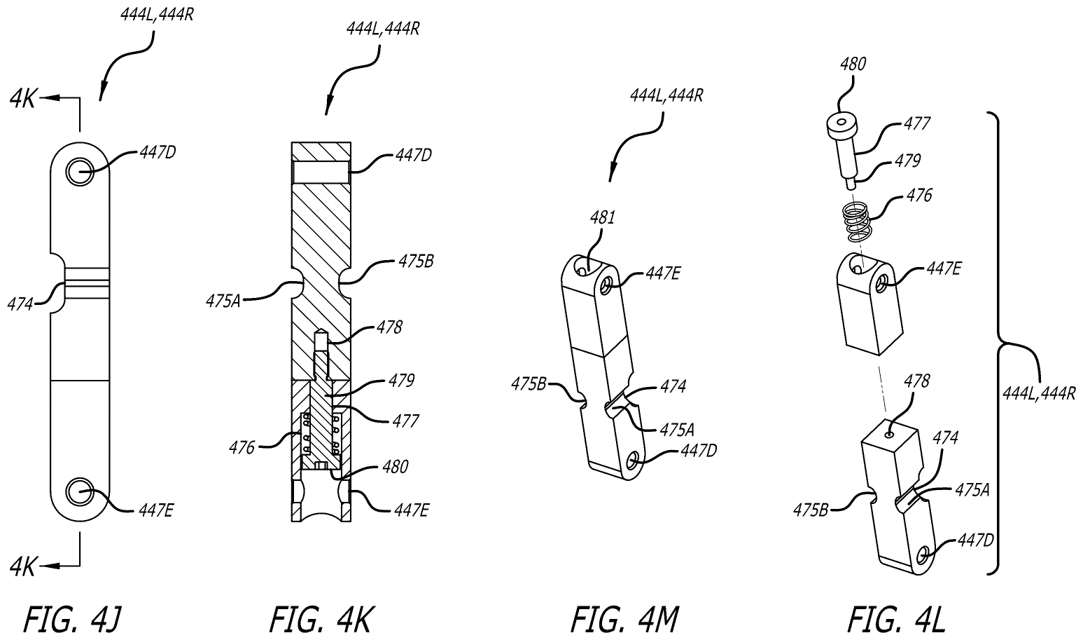

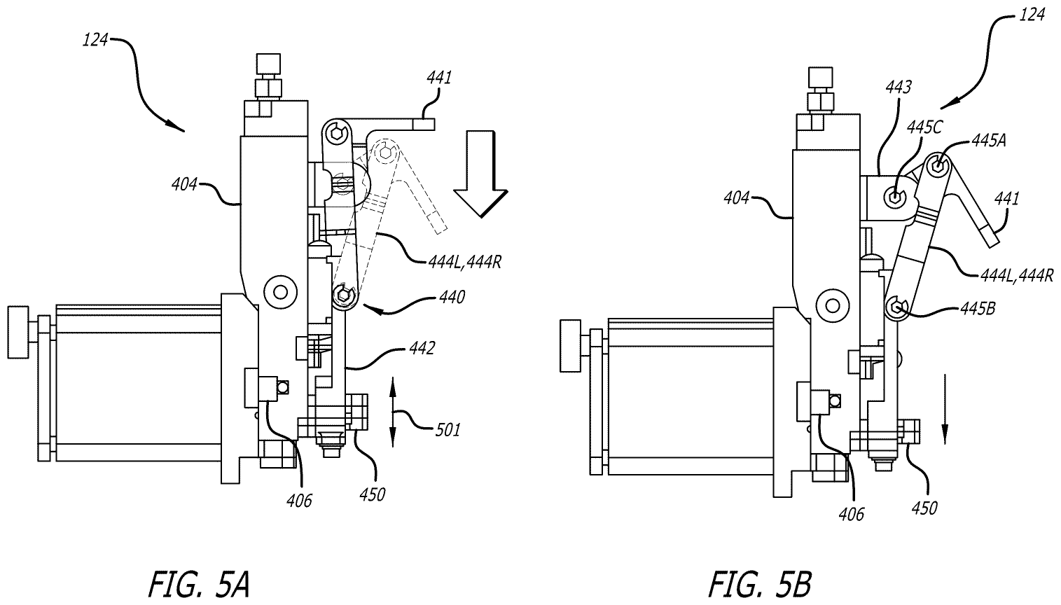

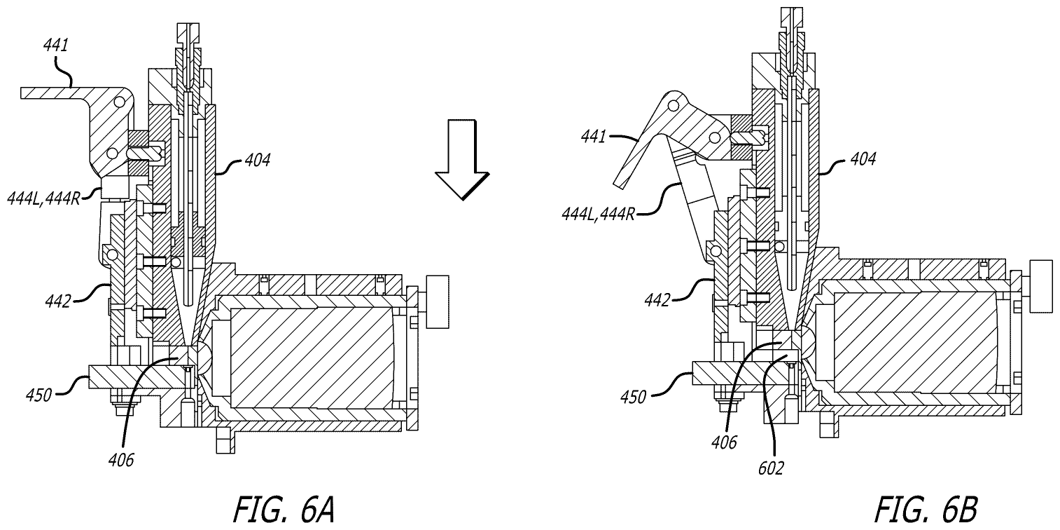

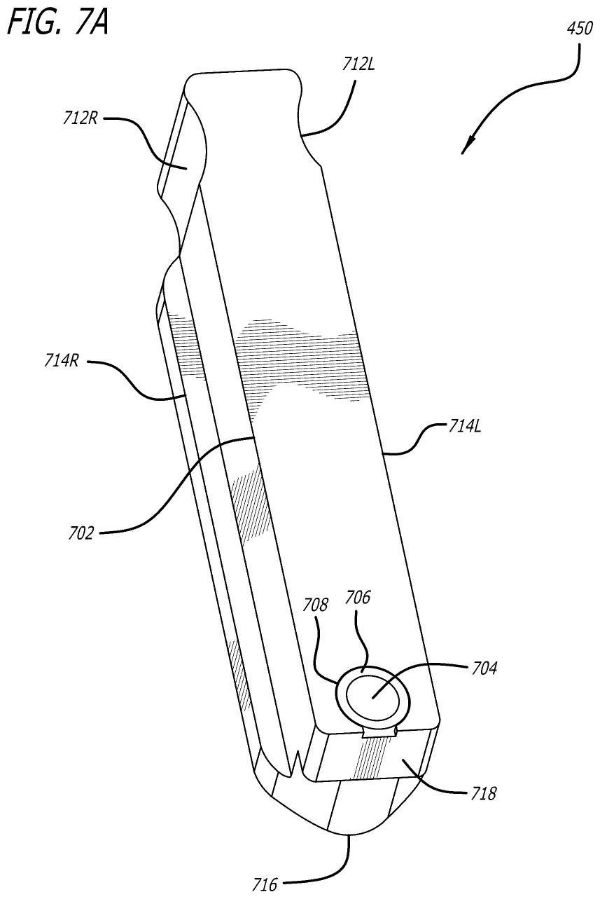

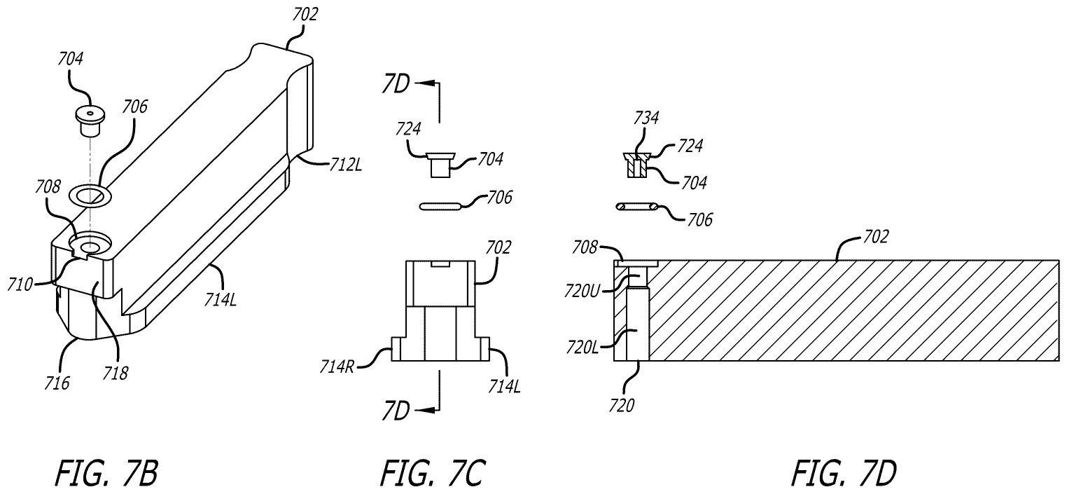

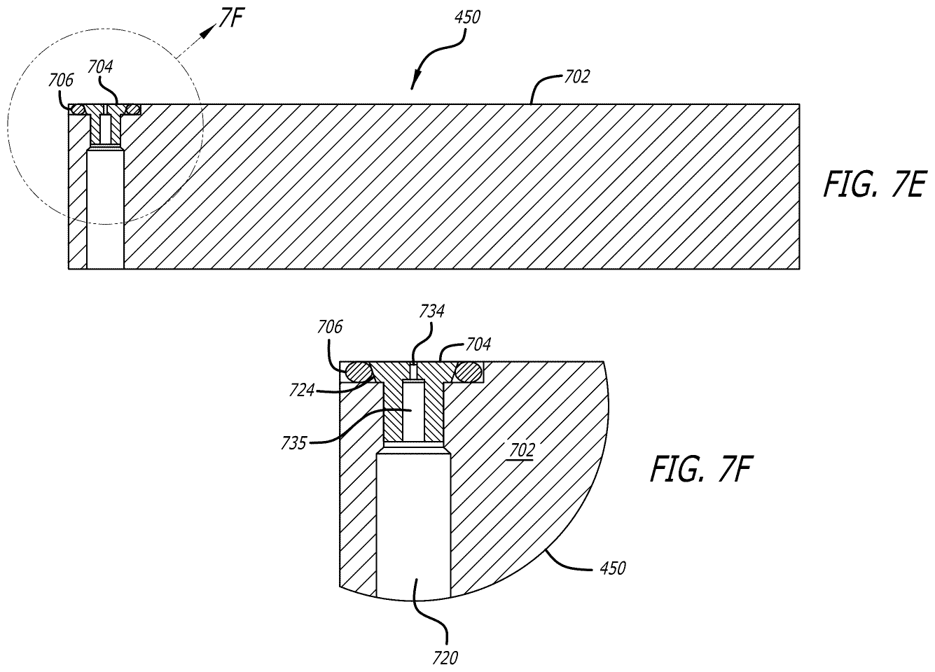

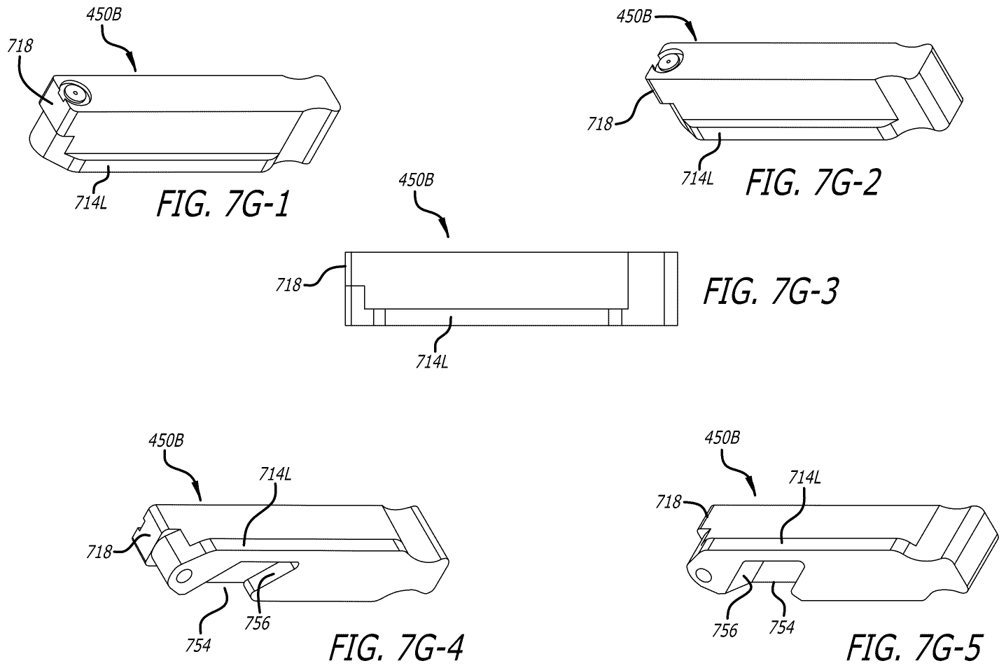

Referring now to FIGS. 7A-7F, various views of the nozzle assembly 450 are illustrated. FIGS. 7B-7D illustrate various exploded views of the nozzle assembly 450. FIGS. 7A and 7E-7F illustrate various assembled views of the nozzle assembly 450. FIGS. 7G, 7H and 7I-7L illustrate views of a latchable nozzle assembly 450B, somewhat similar to the nozzle assembly 450 but with additional features.

The nozzle assembly 450 includes a three-dimensional nozzle body (nozzle handle) 702, a ceramic nozzle 704, a replaceable O-ring 706, and a partial gland opening 708. The partial gland opening 708 is washer shaped opening that includes a slot 710 at a back end for easy O-ring removal by finger nail or a small tool. Despite having the slot 710, the O-ring 706 in the partial gland opening 708 can still provide a seal around the nozzle 704 capable of withstanding high pressures when pressed against a cuvette. The cross-section of the three-dimensional body 702 generally has a top portion, a midsection portion under the top portion, and a base portion under the top and midsection portions. The three-dimensional body 702 further includes a left rail 714L and a right rail 714R along left and right sides in the base portion.

The three-dimensional nozzle body 702 is elongated and provides a handle at a front end by a left indentation 712L and a right indentation 712R in top, midsection, and bottom portions. At a back end opposite the front end, the three-dimensional nozzle body 702 provides a nose or arch-shaped stop 716 in the base portion to make two points of contact. The nose or arch-shaped stop 716 extends up from the base through the midsection up to the top portion of the body. The end 718 of the top portion extends slightly out over the nose or arch-shaped stop 716 to be sure the O-ring has sufficient support in the partial gland to seal up against the cuvette. Because it provides a handle, the three-dimensional body 702 may also be referred to herein as the nozzle handle 702.

As shown in FIG. 7D, the three-dimensional body 702 includes a through hole 720 starting at the base of the partial gland 708 with an upper receptacle portion 720U to receive the nozzle 704 and a lower drop channel portion 720L to allow drops to flow through without interference from the sidewalls.

The three-dimensional body 702 is formed of a high performance engineered thermoplastic polymer, such as polyether-ether-keytone (PEEK) in the polyaryletherketone (PAEK) family, to provide mechanical strength and high temperature and chemical resistance. The three-dimensional body 702 is generally formed with low tolerances. The low tolerances allow the nozzle assembly to readily slide in and out of guides in a mount. The low tolerances also provide a somewhat sloppy friction fit to the mount and allow a slight pivotal motion to clear debris from two stop points at the arch shaped stop 716. Other thermoplastic polymers may be used to form the three-dimensional body 702 at low cost and low tolerances.

The size (e.g., diameters, depth) and shape of the gland and the nozzle, allow a low cost standard rubber O-ring to be used as the replaceable O-ring 706. The O-ring may be formed of ethylene propylene diene monomer (EPDM), a synthetic rubber, having good resistance to various environmental factors. In alternate embodiments, the O-ring can be formed of silicon rubber or natural rubber.

The nozzle 704 is preferably a ceramic nozzle formed of a ceramic material given its insulative electrical properties to avoid grounding of the charges being transferred to the drops of sample fluid before reaching the deflection unit. As shown in FIGS. 7C-7F, the top of the nozzle 704 has a beveled ring 724 to properly receive and hold the circular cross section of the O-ring in the depth of the partial gland. The top of the nozzle 704 has a drop inlet 734 that leads to a somewhat larger diameter drop channel 735 in the nozzle. When the nozzle 704 is friction fitted into the receptacle 720U of the body 702, the drop channel 735 of the nozzle 704 is in communication with a somewhat larger diameter drop channel 720L of the through hole 720 extending the width of the body 702.

FIGS. 7E and 7F illustrate how the nozzle 704 and O-ring 706 are assembled into through hole and partial gland opening in the body 702 of the nozzle assembly. The O-ring 706 is held in the partial gland opening 708 by the beveled ring 724 in the top portion of the nozzle 704.

The nozzle assembly 450 is selectively slidingly coupled into and decoupled from the nozzle mount 452. The tolerances between the nozzle body of the nozzle assembly 450 and the nozzle mount 452 is about 0.25 microns or more for a lose fit. It is not a tight fit. This allows the nozzle assembly 450 to pivot somewhat about an axis through the orifice of the nozzle. The lose fit facilitates clearing of debris between the nose and the receiver of the nozzle mount for a proper registration of the nozzle orifice with the fluid flow channel in the cuvette 406.

The cuvette 406 can be formed of one or more pieces of optical grade quartz to receive laser light and allow reflected light, scattered light, fluorescent light to be captured.

The sample droplets can become charged by the conductive host fitting mounted in a drain/charge port of the flow cell. Accordingly, the nozzle assembly must be formed of non-conductive or insulative materials to avoid charge loss through a ground path to the carriage assembly. The nozzle mount 452 and the nozzle carriage assembly 442 are electrically grounded to shield the charged droplets from the charges on deflection plates below the nozzle mount.

### Latchable Nozzle Assembly

Referring now to FIGS. 7G-1 through 7G-5 and FIGS. 7H-1 through 7H-5, various views of the left side and the right side of a latchable nozzle assembly 450B are shown. Features of the latchable nozzle assembly 450B are shown including an end 718. Each view shows a different perspective of the left side and right side of the nozzle assembly 450B. The left side of the nozzle assembly 450B includes, among other things, the left rail 714L, which is shown in FIGS. 7G-1-7G-5. FIGS. 7H-1 through 7H-5 illustrate other features that are formed on the nozzle assembly 450B. The right side of the nozzle assembly 450B includes, among other things, the right rail 714R, which is shown in FIGS. 7H-1-7H-5. The features include, among other things, a pocket 754 with an angled ramp 756 formed into the material of the nozzle body of the latchable nozzle assembly 450B. These features are configured to work with other components (discussed with reference to FIGS. 12A and 12B) to guide the latchable nozzle assembly 450B accurately and repeatedly into a latchable mount 452B (not shown in FIG. 7, see FIGS. 12A-12D). The latchable nozzle assembly 450B includes a nozzle insert (nozzle) 704 and an O-ring seal (O-ring gasket) 706 around the nozzle 704 in a gland (ring opening) as further discussed herein with respect to the nozzle assembly 450.

FIGS. 7I-7L show more detailed views of some features of the nozzle assembly 450B. FIG. 7I shows a top-down view of the nozzle assembly 450B, including the end 718, a left rail 714L, and a right rail 714R. FIG. 7J shows a view of the nozzle assembly 450B from the gripping end. In the latchable nozzle assembly 450B, the left rail 714L differs from the right rail 714R to accommodate the pocket 754 in the base or bottom side of the nozzle body. In FIG. 7I, portions of the pocket 754 are clearly visible in the top-down view (bottom view) of the latchable nozzle assembly 450B.

FIG. 7K shows a view from the bottom view of the nozzle assembly 450B, including the end 718, the left rail 714L, and the right rail 714R. The pocket 754 is readily visible in the bottom view of the nozzle assembly 450B. The pocket 754 is a void region in the material (e.g., PEEK or ceramic) of the nozzle body that is defined by a roof 758, an angled back wall 760, a left interior wall 762, and the angled ramp 756. The pocket 754 has a side opening in the right side (alternatively the left side) of the nozzle body that can be used to help form (e.g., machine, grind, cut, router, or cast) the pocket. The angled ramp 756 is formed in a front portion of the pocket toward the direction of the front end 718 of the nozzle assembly. The angled ramp 756 has a grade or slope downwards on an angle with a Z axis and is slanted or angled on an angle with an X axis. The left interior wall 762 is formed opposite the right opening of the pocket 754. The roof 758 is formed opposite the bottom opening of the pocket 754. The angled back wall 760 is formed opposite the ramp 756. The roof 758 couples to the ramp 756, the angled back wall 760, and the left interior wall 762. Accordingly, the pocket 754 is open in the bottom side and the right side of the nozzle body of the nozzle assembly 450B. FIG. 7L shows a view of the nozzle assembly 450B from the end 718. The nozzle assembly 450B includes, among things, the left rail 714L and the right rail 714R.

In another embodiment (not shown), the pocket 754 may be open at the bottom side and the left side of the nozzle assembly 450B. In another embodiment, the pocket 754 may be open at the bottom size of the nozzle assembly 450B, and not open in the left side and right side of the nozzle assembly 450B. It is important to note that directional terms (like “left”, “right”, “bottom”, “top”, “up”, “down”, etc.) are for explanatory purposes relative to the figures. Other directional terms may accurately describe a given embodiment, depending on directions defined for the given embodiment.

The angled ramp 756 is formed with a sideways angle 764 with respect to a horizontal (Y-axis) axis across the width nozzle body shown in FIG. 7K and a ramp angle 765 with respect to another axis (Z-axis) through the thickness of the nozzle body shown in FIG. 7H-3. With these features, the angled ramp 756 configures the latchable nozzle assembly 450B to work with other components (discussed with reference to FIGS. 12A and 12B) to guide the nozzle assembly 450B to accurately engage with the latchable mount 452B (not shown in FIGS. 7I-7L, see FIGS. 12A-12D).

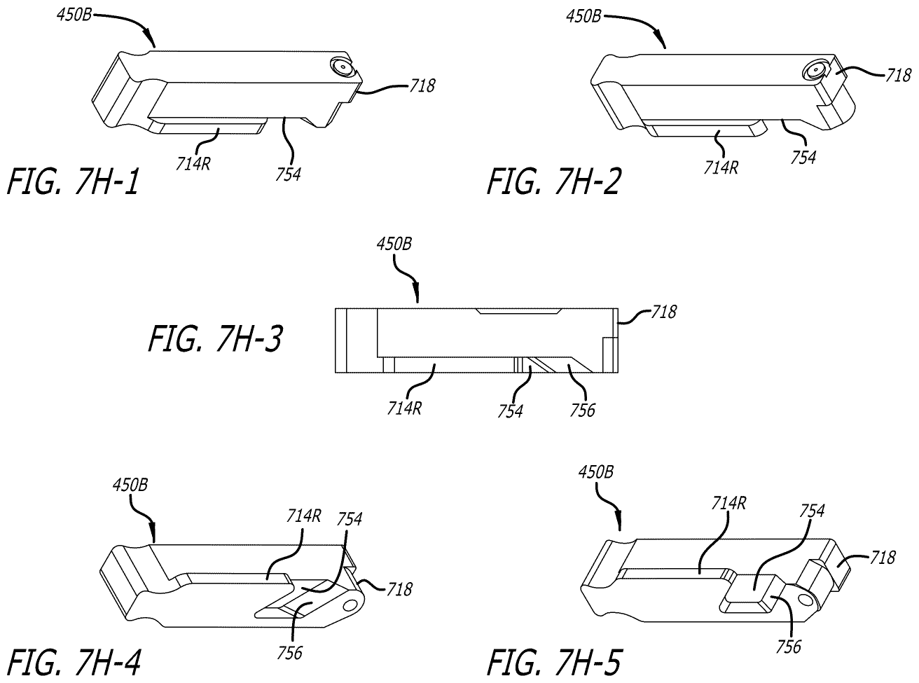

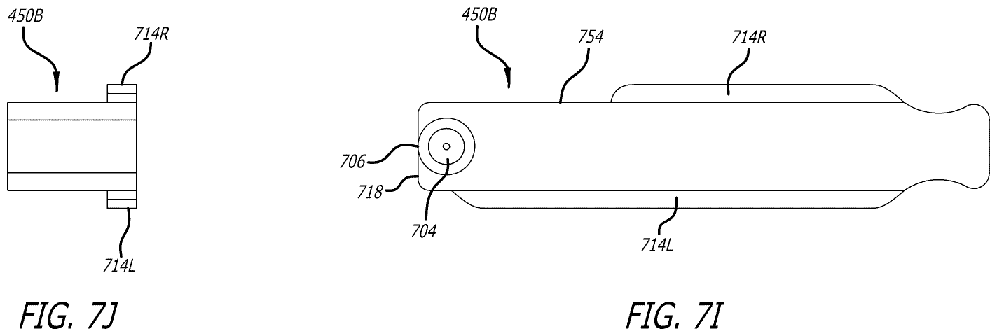

FIGS. 8A-8B, 9A-9B, 10A-10B, and 11A-11B illustrate views of sliding the nozzle assembly 450,450B into and out of the nozzle mount 452,452B of the carriage assembly 442 in the flow cell 124. This allows for maintenance of the nozzle assembly 450,450B, including replacement of its O-ring seal.

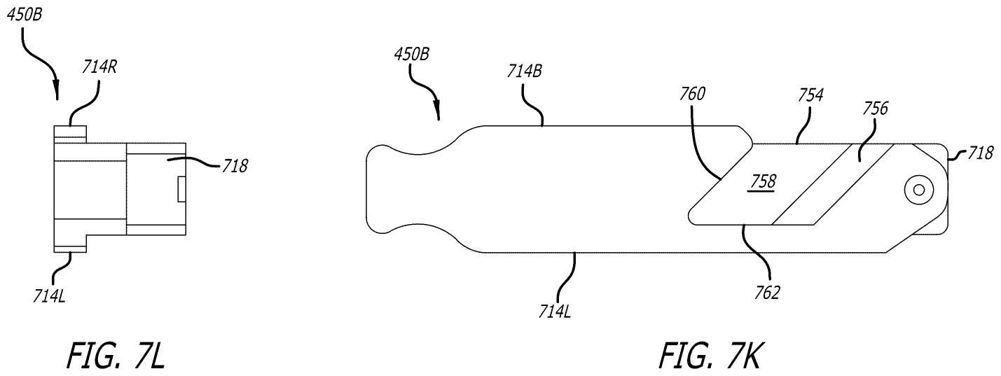

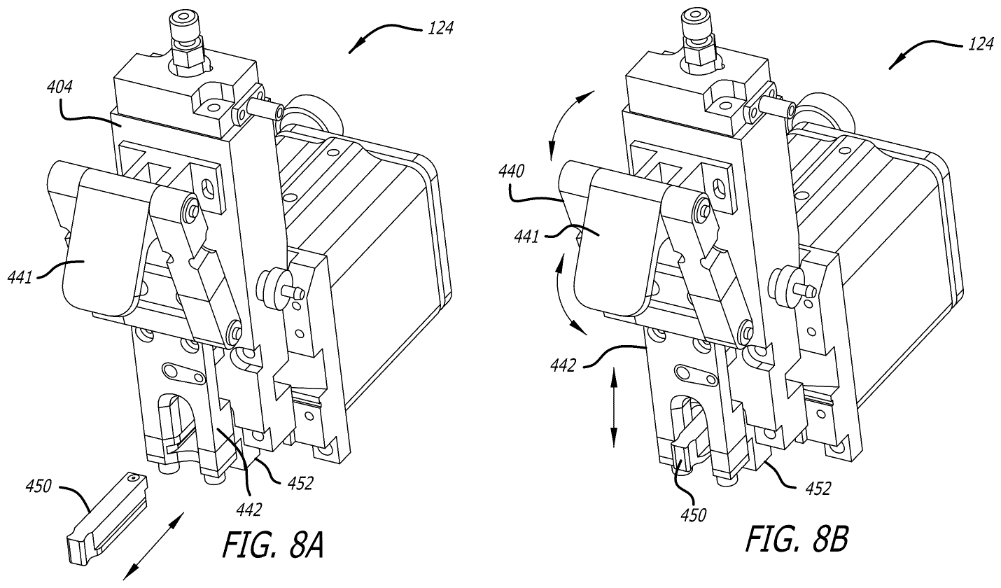

Assume the nozzle assembly 450B is pushed into the slot 910 in the mount 452. Initially, as better shown in FIGS. 9A-9B, bottom rails 714L-714R of the nozzle assembly 450,450B are lined up and respectively inserted into guide rail openings 914L-914R in the mount 452,452B. The nozzle assembly 450,450B is pushed into the mount within the slot 910 as far as possible so that the nose stop 716 of the body 702 engages the end wall of the mount in the slot 910.

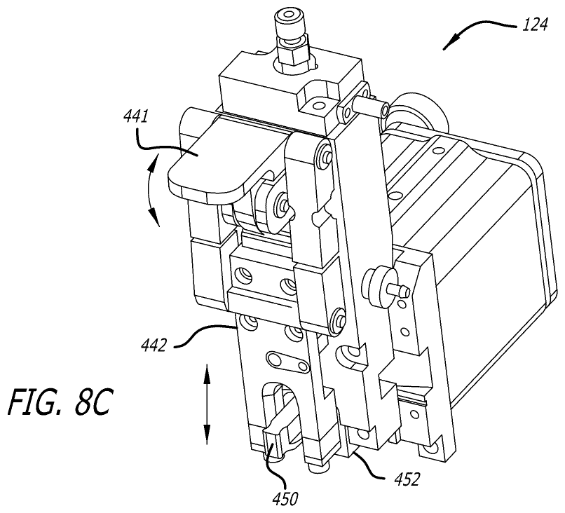

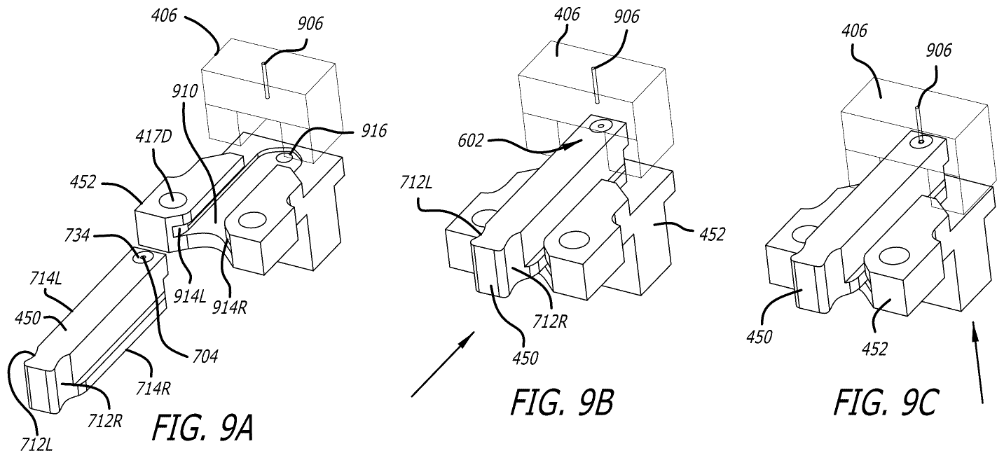

In operation of the cell sorter (sorting flow cytometer), a stream of sample drops with marked cells/particles flow from the SIT into the flow cell body and then into the flow channel 906 of the cuvette 406 for analysis by lasers and detectors. If the nozzle assembly 450,450B is properly aligned in the mount 452,452B such as shown by axis 1000 in FIG. 10B, the stream of drops from the flow channel in the cuvette 406 are received by the opening in nozzle of the nozzle assembly. The mount 452,452B has an opening 916 in the slot 910 that allows a stream of drops received from the opening in the nozzle of the nozzle assembly 450,450B to pass through. Accordingly, it is desirable to achieve proper alignment of the nozzle assembly 450,450B in the mount 452,452B.

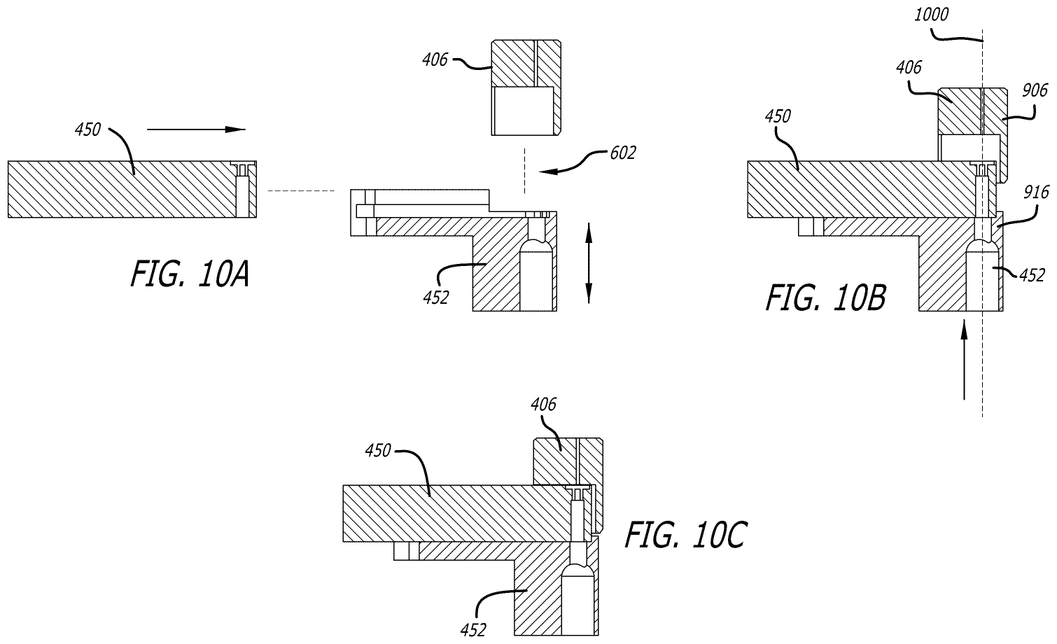

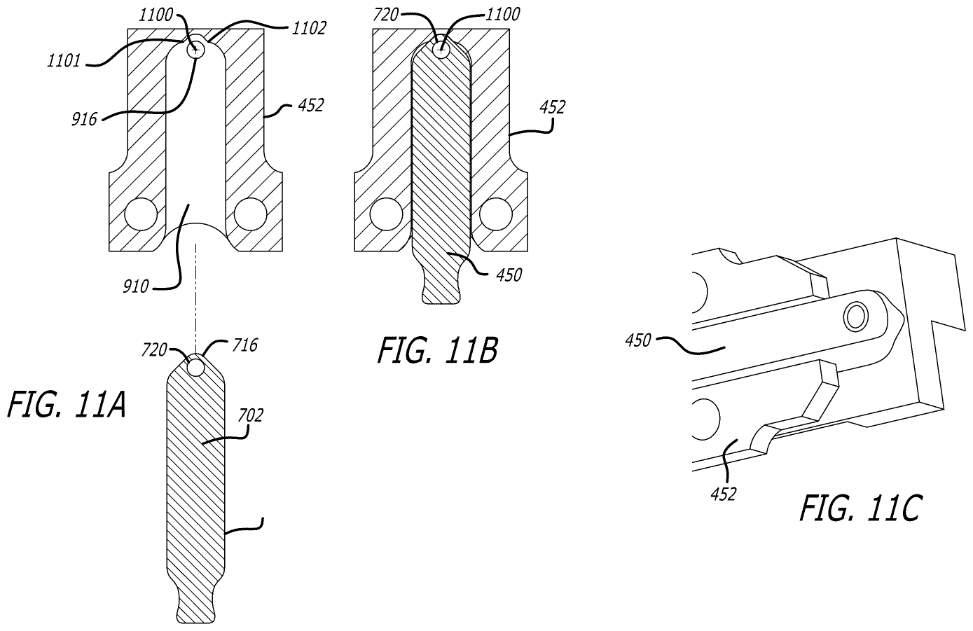

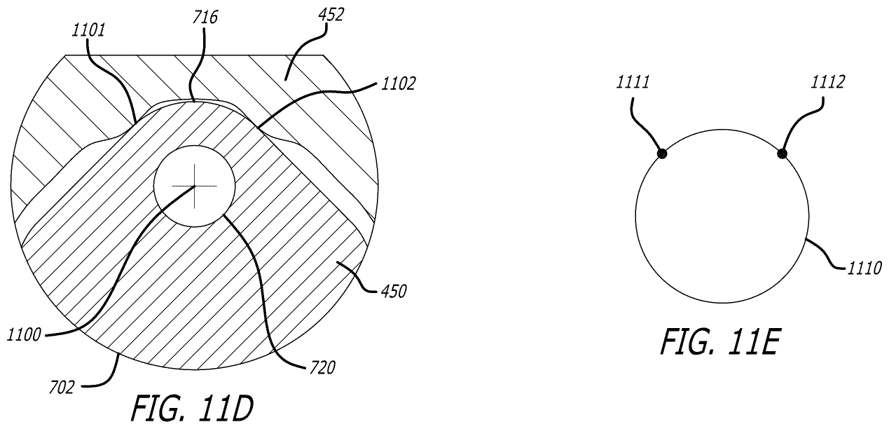

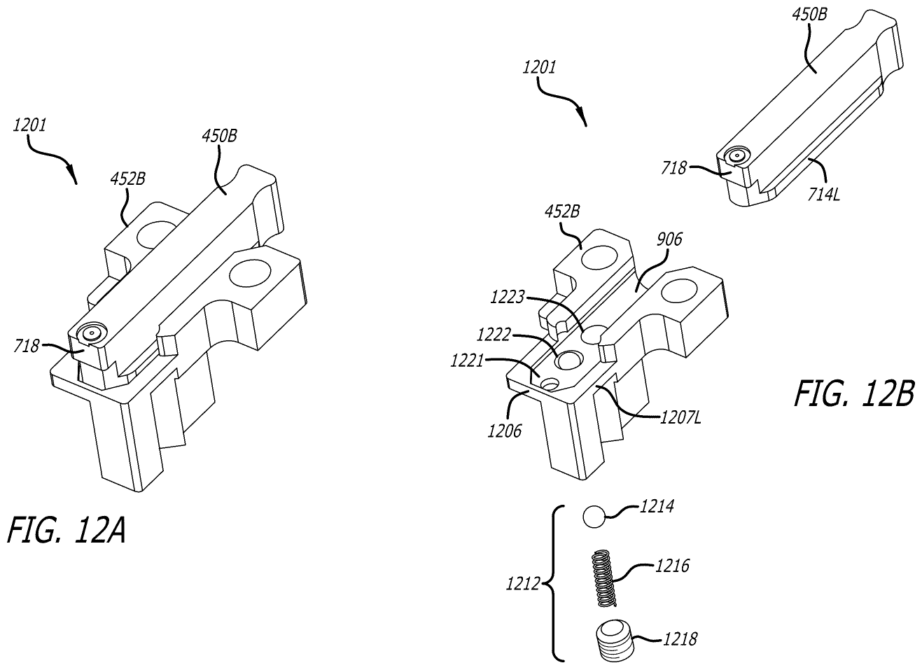

In FIG. 11A, the nozzle assembly 450,450B is ready to be inserted into the slot 910 of the mount 452,452B. The mount 452,452B includes a pair of nubs 1101-1102 formed in the end wall of the slot 910. The nozzle assembly 450,450B is pushed into the slot 910 as far as possible so that the nose stop 716 of the body 702 engages the nubs 1101-1102.

In FIGS. 11B-11C, the nozzle assembly 450,450B is fully inserted into the slot 910 of the mount 452,452B. The opening in nozzle of the nozzle assembly 450,450B is lined up with the flow channel in the cuvette 406 along the axis 1100. Preferably, the opening in the nozzle of the nozzle assembly is concentric with the opening 916 in the mount 452,452B along the axis 1100. However, debris can come between the nozzle assembly and the mount so that center of the opening in the nozzle is offset from center of the opening 916 in the mount. Because the center of the flow channel in the cuvette is aligned with the center of the opening in the mount, the center of the flow channel can also be offset from the center of the opening of the nozzle in the nozzle assembly by the debris. Addressing the debris and misalignment of centers of the holes is desirable.

FIG. 11D illustrates a magnified cross-sectional view of the nose stop 716 of the body 402 of the nozzle assembly 450,450B engaged with the mount 452,452B. The nozzle of the nozzle assembly 450,450B is to line up with the flow channel in the cuvette 406 along the axis 1100. The nose stop 716 in the body 702 of the nozzle assembly 450,450B butts up against nubs 1101-1102 in the mount 452,452B making two points of contact. Occasionally debris may come in between the two points of contact. The design of the nose stop 716 and the nubs in the mount 452,452B allows for the debris to be cleared. The left and right finger grabs 712L-712R invite a user to slightly pivot the nozzle assembly 450,450B about the axis 1100 as it is pushed into the slot 910 to help clear any debris.

FIG. 11E schematically illustrates the two point contact 1111-1112 between the nose stop 716 of the body 702 of the nozzle assembly 450,450B and nubs 1101-1102 at the end of the slot 910 in the mount 452,452B forming a circle 1110. The looseness of the body 702 of the nozzle assembly in the mount 452,452B allows the nozzle assembly to pivot slightly about the axis 1100, and the nose end 716 to grind debris away from the two points of contact with the nubs. This assures the opening in the nozzle is more aligned along the axis 1100 with the flow channel in the cuvette 406.

Alternatively, assume the nozzle assembly 450,450B is pulled out of the slot 910 from the mount 452,452B for maintenance. A user squeezes two fingers into the left and right finger grabs 712L-712R of the body 702 and pulls out on the nozzle assembly 450,450B sliding it out of the slot 910 and away from the mount 452,452B.

FIGS. 8B-8C, 9B-9C, and 10B-10C illustrate views how the nozzle assembly 450,450B in the mount 452,452B is raised and lowered by the flow cell linkage 440 and carriage assembly 442 to respectively press and un-press an O-ring seal of the nozzle assembly 450,450B up against the cuvette 406.

In FIGS. 8B, 9B, and 10B, release lever 441 and the nozzle assembly 450, engaged in the mount 452,452B of the carriage assembly 442, are in a lowered position. In the lowered position, a gap 602 exists between the cuvette 406 and the nozzle assembly 450,450B as shown in FIGS. 9B and 10B. To engage the nozzle assembly 450,450B with the cuvette 406, a user lifts up on the release lever 441 pivoting it about the shaft 445C. This causes the linkage assembly 440 to pivot forward into the flow cell body about the shaft 445B and lift up on the lever arms 444L-444R and the carriage assembly 442. With the nozzle assembly 450,450B mounted in the mount 452,452B of the carriage assembly 442, the nozzle assembly is lifted up together with the carriage assembly.

In FIGS. 8C, 9C, and 10C, the release lever 441 and the nozzle assembly 450,450B, engaged in the mount 452,452B, are in a raised or upper position. The gap 602 between the nozzle assembly and the cuvette 406 is substantially reduced and forces the O-ring seal of the nozzle assembly up against a base of the cuvette 406 around the flow channel 906.

The spring loaded detent slidingly engages the backside cam 425 of the release lever 441 to maintain a selected position of the linkage, carriage assembly, and nozzle assembly. From the lower position to the upper position of the release lever 441, the spring loaded detent 461 rides on a lower part of the backside cam 425 and comes to rest against an upper part of the backside cam 425 as shown in FIG. 4D. Between the lower part and the upper part of the backside cam 425 is a bump that has a larger radial distance from the shaft 445C than that of the lower part of the cam. The upper part of the cam can have a similar radial distance or smaller radial distance to the shaft than the bump. Accordingly, with the release lever in the upper position, the compression spring 427 behind the detent 461 is compressed more and applies more force against the cam 425. This spring force on the detent and the upper portion of the cam helps maintain the release lever in the upper position. A user pushes down on the release lever 441 to overcome the force and friction applied by the spring loaded detent in the upper portion and move the cam to the lower portion actuating the linkage 440 in order to lower the carriage 442 and the nozzle assembly 450,450B.

To disengage the nozzle assembly 450,450B from the cuvette 406, a user pushes down on the release lever 441 pivoting it about the shaft 445C. This causes the linkage assembly 440 to pivot forward away from the flow cell body about the shaft 445B and let down the lever arms 444L-444R and the carriage assembly 442. With the nozzle assembly 450,450B mounted in the mount 452,452B of the carriage assembly 442, the nozzle assembly is lowered down together with the carriage assembly. Accordingly, in the lowered position, the large gap 602 is formed between the cuvette 406 and the nozzle assembly 450,450B to allow the nozzle assembly 450,450B to be slid out from the mount 452,452B without damaging the cuvette 406. With the nozzle assembly 450,450B slid out and away from the mount, a new nozzle assembly may be installed in its place and/or maintenance can be performed on the used nozzle assembly and reinstalled when completed.

While the nozzle assembly 450,450B are referred to herein, an empty latchable nozzle assembly 450E and test nozzle assemblies 450T can be similarly inserted and removed from the nozzle mount 452,452B. However, a latchable nozzle assembly (e.g., 450B,450E,450T) with its angled ramp and pocket undergo a few more processes when engaged with and disengaged from a latchable mount 452B.

### Latchable Nozzle Subsystem

The nozzle assembly 450 is a nozzle assembly that can slide into and out of the nozzle mount 452. Furthermore, the nozzle assembly 450 is held in the nozzle mount 452 by the fit and friction of the engaging portions (e.g., side rails and rail slots, bottom surface of nozzle body and base of slot) therebetween. Unfortunately, a nozzle assembly is often removed from the mount such as to clear a clog in the nozzle orifice. When the nozzle assembly 450 is slid back into the mount, it may not stop or register at a substantially similar spot in the mount. Thus, the flow channels in the nozzle may be slightly offset from the flow channel in the cuvette so that the flow of drops may be slightly altered. To avoid having to recalibrate the cell sorter or flow cytometer for drop flow each time a nozzle assembly is replaced, it is desirable to have a nozzle assembly stop and register at substantially the same spot in the mount. This is so the alignment between flow channels in the nozzle and the cuvette remains substantially the same to that for which they were previously calibrated. Advantageously, embodiments of the latchable nozzle assembly 450B described herein implements such desirable functionality.

Referring now to FIGS. 12A-12B, a latchable nozzle subsystem 1201 is shown that allows a latchable nozzle assembly 450B to be stopped and registered at substantially the same spot when repeatedly slid into and out of the latchable nozzle mount 452B. The latchable nozzle subsystem 1201 includes the latchable nozzle assembly 450B and the latchable nozzle mount 452B. The latchable nozzle mount 452B couples to the carriage plate.

The latchable nozzle mount 452B is formed and configured to slidably receive the nozzle (body) handle of the latchable nozzle assembly 450B. In FIG. 12A, the latchable nozzle assembly 450B (with the end 718) is mounted on the mount 452B. In FIG. 12B, the latchable nozzle assembly 450B (with the end 418) is unmounted from the mount 452B.

FIG. 12B illustrates a ball (plunger) assembly 1212, which includes a ball 1214 (e.g., ball bearing), a spring 1216, and a set screw 1218. Material of components of the ball assembly 1212 may include metal, steel, and/or stainless steel, among other materials. In the slot 901, the latchable nozzle mount 452B is formed to have, among other things, a first hole 1221, a second hole 1222, and a third hole 1223. The first hole 1221 is a through hole to allow sample drops to drop out of the flow channel of the nozzle to be sorted out or collected below. The second hole 1222 receives the ball assembly 1212 and is partially threaded with a female thread to engage with the male thread of the set screw 1218. But for a top portion being smaller to retain the ball, the diameter of the second hole 1222 is about the diameter of the ball (e.g., about four millimeter). The third hole 1223 is unused but can drain stray fluids away from the slot. In one embodiment, the center of the threaded hole 1222 for the ball assembly is slightly offset (e.g., to the right of center) from a center line through the slot 910 in the latchable mount 452B. This is so that the center of the ball 1214 is slightly offset from center of the nozzle and mount. In another embodiment, the centers of the holes 1221,1222,1223 are substantially colinear along the center line.

The ball 1214 is configured to extend partially out of the second through hole 1222 and engage with the nozzle handle 702 of the nozzle assembly 450B. The ball assembly 1212 positions the ball 1214 to be slidably aligned in the nozzle assembly's pocket 754 (further described herein with reference to FIG. 7K).

FIGS. 12C and 12D illustrate more details of the nozzle subsystem 1201, which includes the nozzle assembly 450B and the mount 452B. FIG. 12C shows the nozzle assembly 450B mounted on the mount 452B from the perspective of the end 718. The mount 452B further includes a left slotted rail 1231L and a right slotted rail 1231R (FIG. 12C is a view facing the end 718). FIG. 12D shows a cross-sectional view of the right side of the nozzle subsystem 1201. The ball assembly 1212 (including the ball 1214, the spring 1216, and the screw 1218) is positioned within the mount 452B. The spring 1216 is coupled to a lower portion (e.g., base) of the mount 452B. The ball 1214 is coupled to an upper end of the spring 1216. The ball 1214 and the second through hole 1222 are substantially concentric (e.g., concentric within a tolerance). The spring 1216 provides an upward force to the ball 1214 such that the ball 1214 extends at least partially out of the second through hole 1222. The ball 1214 thereby engages the nozzle body of the nozzle assembly 450B by providing an upward force (e.g., adjustable but desired to be about four Newtons) on the bottom of the nozzle assembly (e.g., the angled ramp 756). The set screw 1218 enables a user to adjust the spring tension provided by the spring 1216 on the ball 1214 by turning the set screw a desired number of turns within the threaded hole 1222 of the mount 452B.

To mount the latchable nozzle assembly, a user initially engages the opposing (left and right) side rails 714R,714L of the nozzle assembly 450B into left and right rail slots (slotted rails) in the slot 901 of the mount 452B and pushes the nozzle assembly forward. As the user pushes the nozzle assembly 450B further forward into the slot 901 of the mount 452B, the bottom of the nozzle assembly 450B engages the ball 1214 in the mount 452B. The bottom of the nozzle assembly 450B can depress the ball 1214 into opening 1222 in the mount 452B to provide clearance for the nozzle assembly 450B to continue to slide forward into the slot and rail slots of the mount. A front portion of the nozzle assembly 450B traverses, slides, and/or rolls over the ball 1214 slightly depressing it into the opening 1222 and continues forward into the mount 452B. As the nozzle assembly is further inserted, the starting point of the pocket in the bottom and front portion of nozzle assembly reaches the ball 1214.

Referring to FIGS. 7K, 12C, and 12D, as the nozzle assembly 450B is further inserted into the nozzle mount 452B, the ball 1214 starts to roll into the pocket 754 and begin engaging with the angled ramp 756. The spring force of the spring 1216 pushes up on the ball 1214 so that the ball 1214 engages the angled ramp 756 within the pocket. The forces by the ball assembly can then take over from the user supplied force on the nozzle assembly.

The angled ramp 756 acts like an angled wedge cam and the ball assembly 1212 acts like a cam follower engaged with the angled wedge cam. Together, the angled ramp 756 and the ball assembly 1212 convert portions of the spring force in one direction into a force vector with forces in other directions on the nozzle assembly 450B. A portion of the upward force from the spring on the ball 1214 is converted into a forward force on the nozzle assembly by the upward ramp angle in the angled ramp 756. Another portion of the upward force is converted into a sideways force on the nozzle assembly by the sideways angle in the angled ramp. These forces, provided by the spring force on the ball and the angled ramp, cause the nose of the nozzle assembly 450B to be pushed forward into an end wall 1206 in the slot 910 of the mount 452B (see FIG. 12B). The forces also concurrently cause the side rail 714L of the nozzle assembly 450B to be pushed sideways (e.g., left) into a side wall 1207L in the slot 910 associated with the left slotted rail 1231L. (see FIG. 12B). This is so the nozzle assembly 450B can be repeatedly seated and mounted (registered) into the same position when removed and reinserted.

The spring force and engagement of the ball with the angled ramp also causes the right slotted rail 1231R to provide an opposing downward force on the right rail 714R of the nozzle assembly 450B (FIG. 12C is a view facing the end 718). Likewise, the left slotted rail 1231L provides an opposing downward force on the left rail 714L of the nozzle assembly 450B. Accordingly, the engagement of the ball 1214 causes some combination of forces between the ball 1214, the angled ramp 756, the slotted rails 1231R,1231L, and/or the rails 714R,714L.

The repeatability to register the nozzle assembly 450B on the mount 452B in substantially the same position upon reinsertion after cleaning is desirable to maintain alignment between flow channels in the nozzle and the cuvette. The combination of forces generates a force vector that guides the nozzle assembly 450B to register on the mount 452B such that the center nozzle orifice 1232 and the first through hole 1221 are concentric within a tolerance. Such tolerance may be, for example, over a range of about plus or minus five microns or less. Also, a center axis of the cuvette opening (flow channel) 906 and a center axis of the center nozzle orifice 1232 of the nozzle can be aligned together (substantially co-linear) within a tolerance. That tolerance may be, for example, in the range of about plus or minus two microns or less. According to industry standards, these tolerances are perfection or near perfection. The nose of the nozzle assembly can be formed within tolerances with respect to the orifice (flow channel) in the nozzle to assure close alignment with the flow channel in the cuvette when mounted in the latchable mount. As explained further herein, the carriage assembly can be adjusted to provide good co-planarity between a top surface of the nozzle and a bottom surface of the cuvette provide good alignment between flow channels so as to achieve good break off and good quality of drops.

The ball assembly 1212 provides for the latchable nozzle assembly 450B to be self-latching or self-locking (e.g., latches with and de-latches from) with the latchable mount 452B. Accordingly, in the embodiment of FIGS. 12A-12D, the latchable nozzle assembly 450B can also be referred to as a self-latching or self-locking (e.g., auto-locking) nozzle assembly.

When the nozzle assembly 450B is drawn up into the cuvette by the carriage assembly, the cuvette provides an opposing downward force on the nozzle assembly 450B (e.g., the O-ring). Such downward force causes the nozzle assembly 450B to slightly depress the ball 1214 down into the hole 1222 and compresses the O-ring to seal around the flow channels of the nozzle and the cuvette. Meanwhile, some pressure (force) can be released between the engagement of the slotted rails 1231R,1231L of the mount and the rails 714R,714L of the nozzle body. Accordingly, the combination of forces caused by the ball assembly 1212 generates a stable balancing act between the cuvette 406, the nozzle assembly 450B, and the mount 452B. A user can disengage the nozzle assembly 450B from the mount 452B by releasing the cuvette and pulling the nozzle assembly 450B out of the latchable nozzle mount 452B.

The removal process of the latchable nozzle 450B from the mount 425B is substantially the reverse of the insertion process of the latchable nozzle 450B. A user releases the engagement of the cuvette on the nozzle assembly 450B (e.g., O-ring). The cuvette's downward pressure on the nozzle assembly 450B (e.g., O-ring) is thereby released. Pressure (which the cuvette had previously released during engagement) is reinstated between the slotted rails 1231R,1231L of the mount and the rails 714R,714L of the nozzle body. A user then begins to pull the latchable nozzle 450B out. The ball 1214 is at least partially depressed as the latchable nozzle 450B slides, rolls, and/or traverses along the mount 452B including the ball 1214. Disengagement from the mount 452B completes the removal of the latchable nozzle 450B.

In an alternate embodiment, a drilled ball may be used in the first opening in the latchable mount 452B to register with the flow channel in the nozzle assembly 450B. In this case, the drilled ball functions like a ball joint in a car suspension. The drilled ball can include a spring and a hollow screw or just have sufficient clearance for the nozzle body in the slot to ride over the drilled ball and have its first opening register configured with a conical shape to register with the drilled ball. The through hole in the drilled ball would allow the drops to drop out of the nozzle and the mount to be further sorted and/or captured below.

### Tiltable Carriage Plate

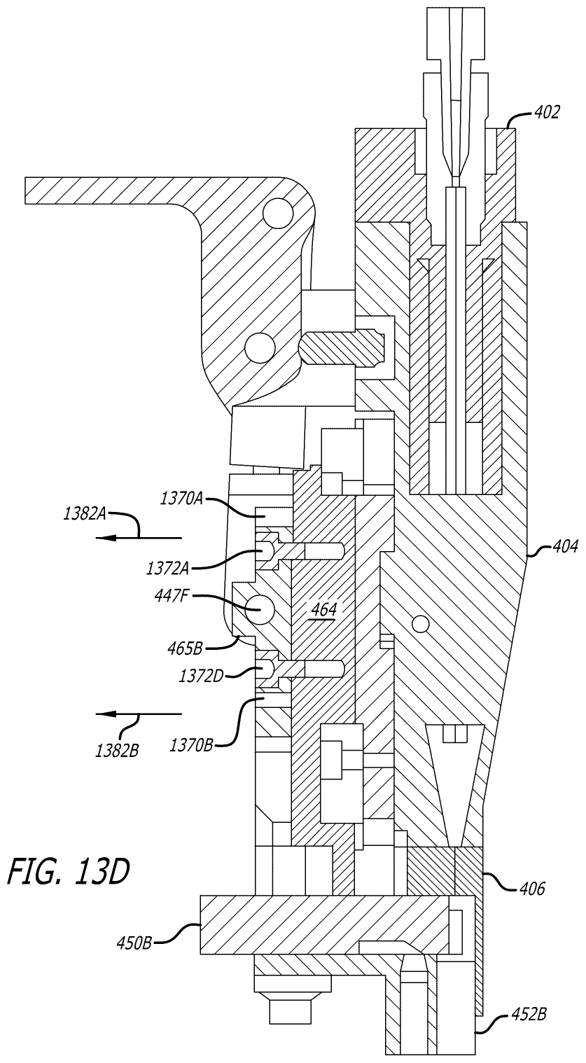

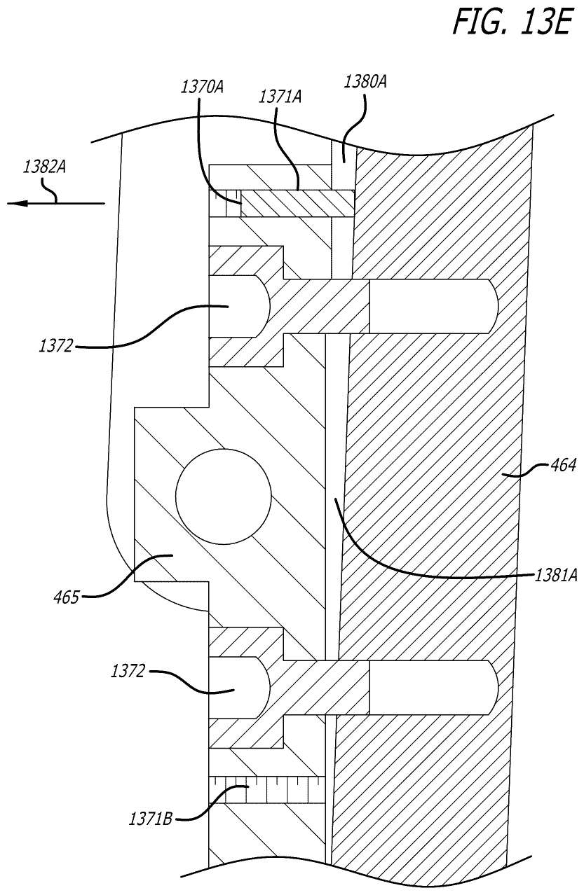

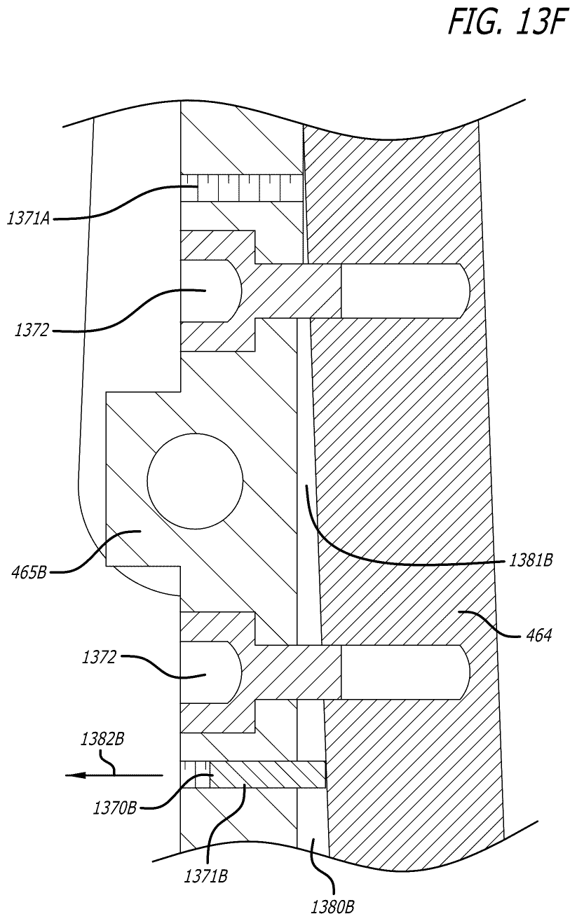

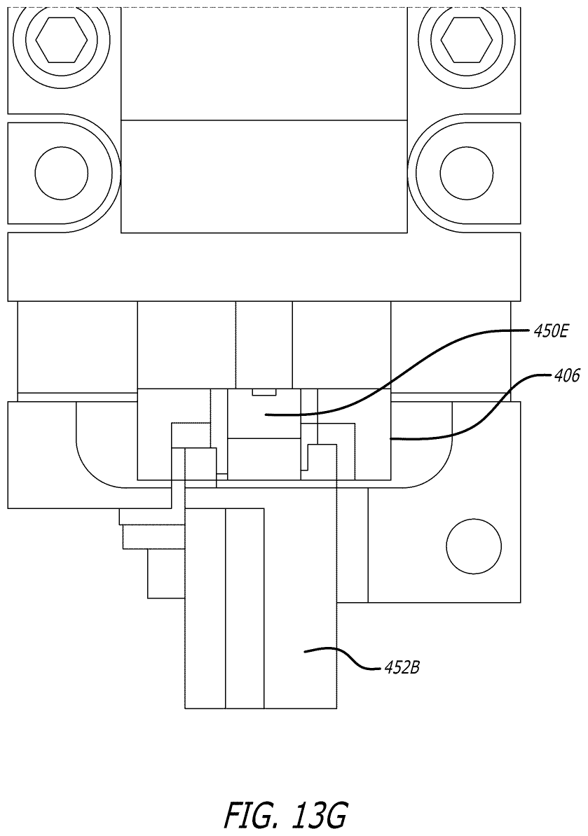

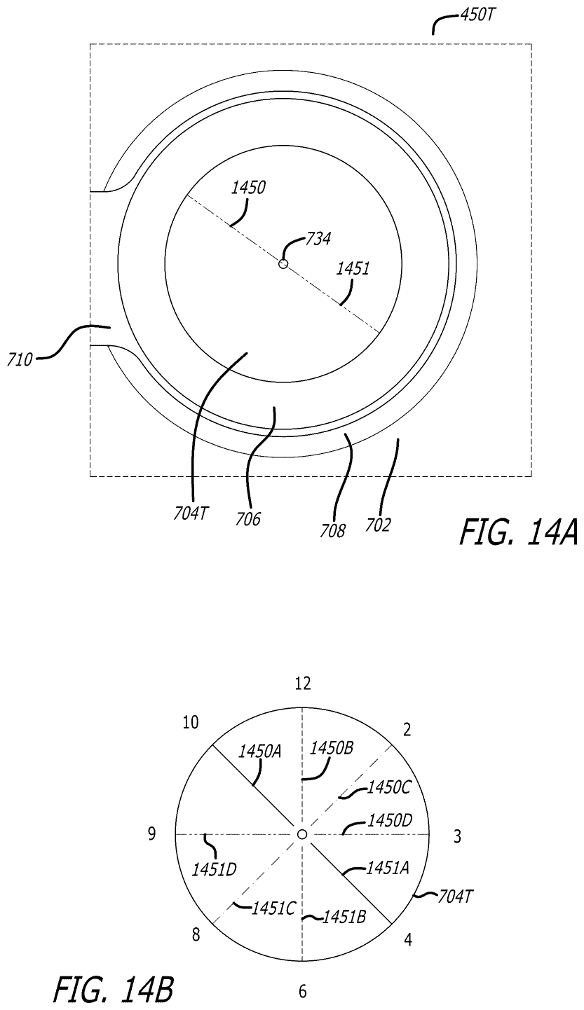

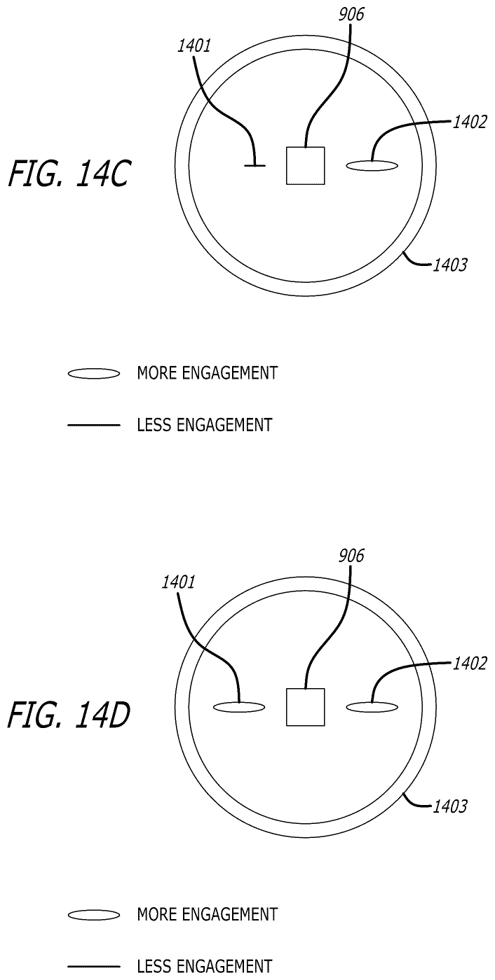

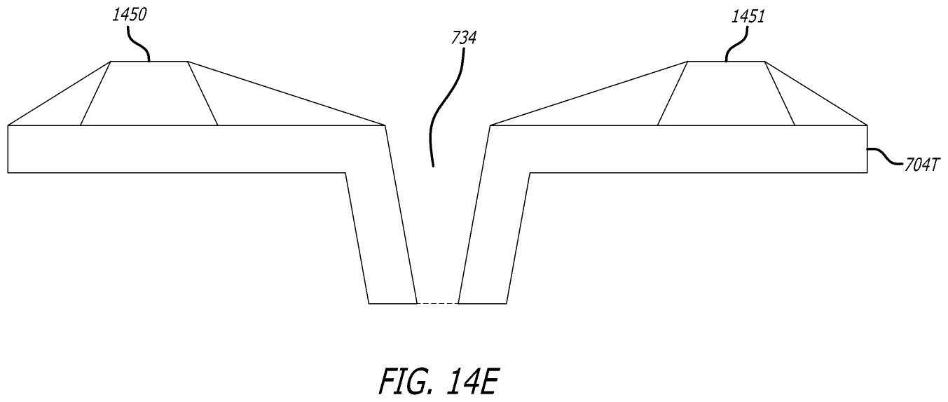

Referring now to FIGS. 13A-13G, views of a flow cell subassembly 124B and portions thereof are shown that include the nozzle assembly 450B and the latchable nozzle mount 452B. The flow cell subassembly 124B includes features to adjust the orientation of the nozzle mount 452B with respect to the cuvette 406 in order to provide an improved engagement between their flow channels. The orientation of the nozzle mount 452B can be adjusted in pitch (tilt) and yaw (rotation to an adjusted angular orientation) so that top surfaces of the nozzle and the nozzle body of the nozzle assembly 450B and a bottom (base) surface 1306 of the cuvette 406 can be made more co-planar.

FIG. 13A is an exploded view of a flow cell subassembly 124B. The flow cell subassembly 124B is similar to the flow cell subassembly 124 but with a tiltable carriage plate 465B, the latchable nozzle assembly 450B, and the latchable mount 452B. The latchable mount 452B is coupled to the tiltable carriage plate 465B in FIG. 13A similar to that shown by FIGS. 4H and 4I with the carriage plate 465 and mount 452.

Generally, it is desirable that the linear bearing 464 and the cuvette 406 maintain a constant orientation in two dimensions (e.g., X and Z axes) about the flow cell body 404. In one dimension (e.g., the Y axis), the linear bearing 464 can slide up and down the rail 446 along the front of flow cell body 404 while the cuvette is fixed in place. The carriage plate 465B and the nozzle mount 452B are coupled together in a fixed relationship. The carriage plate 465B generally couples to the linear bearing 464. However, the manner in which the carriage plate 465B couples to the linear bearing 464 can be actively adjusted in two dimensions (rotationally or yaw, and tilt or pitch) so that the engagement between the nozzle assembly 450B and the cuvette 406 can be adjusted and improved.

Referring now to FIGS. 13A-13B, the tiltable carriage plate 465B includes a plurality of threaded openings 1371A and 1371B to receive a plurality of threaded set screws 1370A and 1370B. The pair of upper threaded openings 1371A receive the pair of upper threaded set screws 1370A. The pair of lower threaded openings 1371B in the tiltable carriage plate 465B receive the pair of lower threaded set screws 1370B. When threaded into the carriage plate, the set screws can push on the face of the linear bearing 464 to adjust the angle of the carriage plate 465B and the nozzle mount 452B with respect to the linear bearing and the cuvette 406.

The upper threaded openings 1371A are located above and adjacent the upper through holes 471C in the carriage plate. The lower threaded openings 1371B are located below and adjacent the lower through holes 471C in the carriage plate. The through holes 471C in the carriage plate receive the bolts or headed screws 1372 with male threads that can be threaded into the threaded holes 471B with the female threads. The plurality of bolts or headed screws 1372 screwed into the threaded holes 471B hold the carriage plate 465B and linear bearing 464 coupled together. The through holes 471C can be counterbored to be slightly larger in diameter than the diameter of the bolts/screws 1372 to allow some rotation of the carriage plate with respect to the linear bearing.

There is a small amount of axial play (clearance) in between the shafts of plurality of bolts/screws 1372 and the through holes 471C as well between the threads of bolts/screws 1372 and the threads of the threaded holes 471B. This axial play allows for a very small amount of angular rotation of the carriage plate 465B and mount 452B with respect to the linear bearing 464 and cuvette 406. This angular rotation is yaw in the carriage plate with respect to the linear bearing and is shown by a clockwise arrow 1380R and a counterclockwise arrow 1380L in FIG. 13C. With clockwise angular rotation, a positive yaw angle 1383A can be set from a center pivot point of the carriage plate with respect to the linear bearing. With counterclockwise angular rotation, a negative yaw angle 1383B can be set from the center pivot point of the carriage plate with respect to the linear bearing. The adjustment in yaw angle can improve the engagement between a top face of the nozzle and a base of the cuvette in a first dimension about a Z axis. The range of the yaw angle that can be adjusted is about plus or minus two degrees about the Z axis.

In FIG. 13C, the bolts or screws 1382A-1382D holding the carriage plate to the linear bearing are somewhat loose when adjusting the angular rotation of the carriage plate 465B and mount 452B. The bolts or screws 1373-1373B holding the bracket 443 of the carriage assembly 442 to the flow cell body 404 can also be somewhat loose when adjusting the angular rotation of the carriage plate 465B and mount 452B to the linear bearing and cuvette.

FIG. 13D illustrates a cross sectional view through the bolts or screws 1372B and 1272D and the set screws 1370A and 1370B as shown in FIG. 13C. FIG. 13D illustrates how the set screws 1370A and 1370B push the carriage plate 465B away from the linear bearing 464 when screwed in. With the carriage plate 465B coupled the nozzle mount 452B and a nozzle assembly 450B mounted into the nozzle mount, the upper set screws or the lower set screws can be used to adjust their tilt with respect to the linear bearing 464 and the engagement of a top surface of nozzle in the nozzle assembly 450B with the base of the cuvette 406.

When the upper set screws 1370A are tightened, the top portion of the carriage plate is pushed away from the linear bearing as indicated by the arrow 1382A. The lower bolts 1372C-1372D act as a fulcrum or pivot point so that screwing in the upper set screws 1370A moves the mount 452B and the nozzle assembly 450B inward with respect to the cuvette 406.

When the lower set screws 1370B are tightened, the bottom portion of the carriage plate is pushed away from the linear bearing as indicated by the arrow 1382B. In this case, the upper bolts 1372A-1372B act as a fulcrum or pivot point so that screwing in the lower set screws 1370B moves the mount 452B and the nozzle assembly 450B outward with respect to the cuvette 406.

FIG. 13E better shows the tilt (pitch) in the carriage plate that can be made away from the linear bearing when the upper set screws 1370A are screwed in. As the set screw 1370A is tightened in the threaded hole 1371A, its shaft extends out from the back side of the carriage plate such that the end of the set screw makes contact with the front surface of the linear bearing and pushes the carriage plate outward as shown by the arrow 1382A. This forms a tilted gap 1380A at a pitch angle 1381A between the carriage plate 465B and the linear bearing from a pivot point near the lower bolt/screw 1372. Any unused set screws are removed. With the upper set screws 1370A being used to adjust the position of the nozzle assembly with the cuvette, the lower set screws 1370B are removed and likely not used such that the lower threaded holes 1371B are open.

FIG. 13F better shows the tilt (pitch) in the carriage plate that can be made away from the linear bearing when the lower set screws 1370B are screwed in. As the set screw 1370B is tightened in the threaded hole 1371B, its shaft extends out from the back side of the carriage plate such that the end of the set screw makes contact with the front surface of the linear bearing and pushes the carriage plate outward as shown by the arrow 1382B. This forms a tilted gap 1380B at a pitch angle 1381B between the carriage plate 465B and the linear bearing 464 from a pivot point near the upper bolt/screw 1372. With the lower set screws 1370B being used to adjust the position of the nozzle assembly with the cuvette, the upper set screws 1370A can be removed and unused such that the upper threaded holes 1371A are open. The hollow circular cylindrical flow channel of the nozzle is to be aligned within the hollow square cylindrical flow channel of the cuvette.

The adjustment in pitch angle can improve the engagement between a top of the nozzle and a base of the cuvette in a second dimension about an X axis. The range of pitch angle 1381A,1381B that can set is about plus or minus two degrees about the X axis.

In an alternate embodiment, shims may be used between the carriage plate and the linear bearing to establish the gap, at the top and/or bottom, and set the pitch angle instead of the upper and/or lower set screws 1370A-1370B.

Referring now to FIG. 13G, to assure that the flow cell subassembly 124B is assembled properly, an empty latchable nozzle assembly 450E can be mounted into the mount 452B. An empty latchable nozzle assembly 450E is the nozzle assembly 450,450B but without the nozzle insert 704,704T and the O-ring seal 706. With a loosened carriage linkage (screws 1373A-1373B loosened) and the empty latchable nozzle assembly 450E mounted in the mount, the top surface of the nozzle body 702 (see FIGS. 7A-7D) can rest flat against the base surface 1306 of the cuvette 406. To do so, the mount 452B is manually pushed towards the cuvette to make initial adjustments as needed to form an even gap. The upper set screws 1370A or the lower set screws 1370B can be used to adjust the tilt or pitch to achieve co-planer surfaces between the empty nozzle 450E and the base of the cuvette. The carriage plate can also be rotated to adjust the yaw to achieve co-planar surfaces between the empty nozzle assembly 450E and the base of the cuvette. The bolts/screws 1372 can be initially tightened in this configuration and then measurements can be made with test nozzle assemblies to be sure the flow channels in the nozzle and the cuvette are aligned together. Adjustments to the carriage plate of the carriage assembly of the flow cell assembly can have quick feedback with engagements tests (measurements) without having to be assembled into a flow cytometer and tested with fluids performing drop breakoff testing. The adjustments for pitch and yaw is an iterative process of fine tuning, back and forth, to achieve the desired co-planarity and engagement between the top of the nozzle and the base of the cuvette.

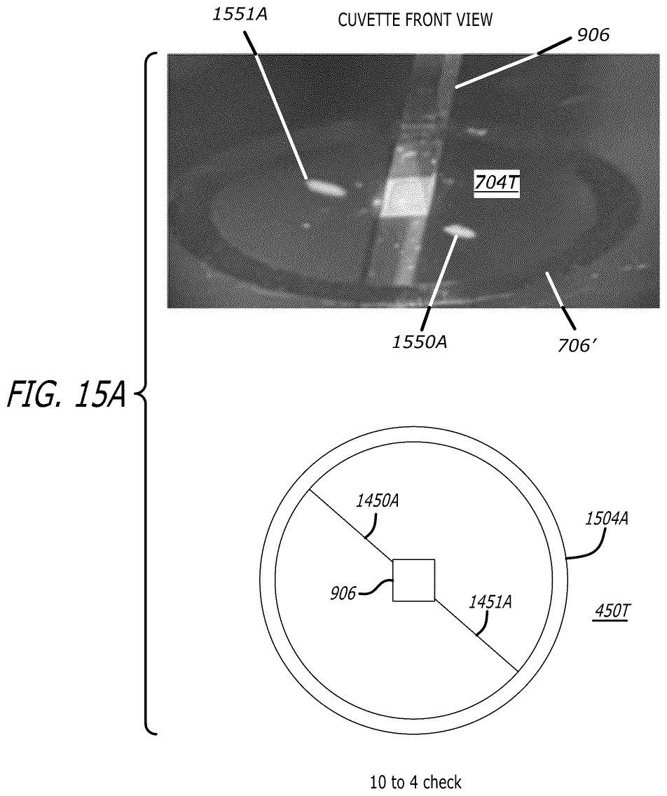

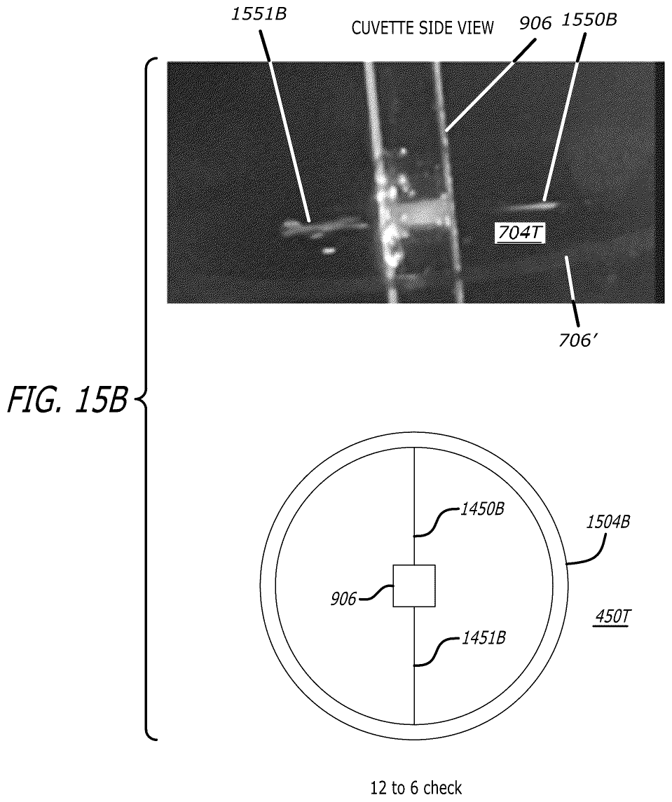

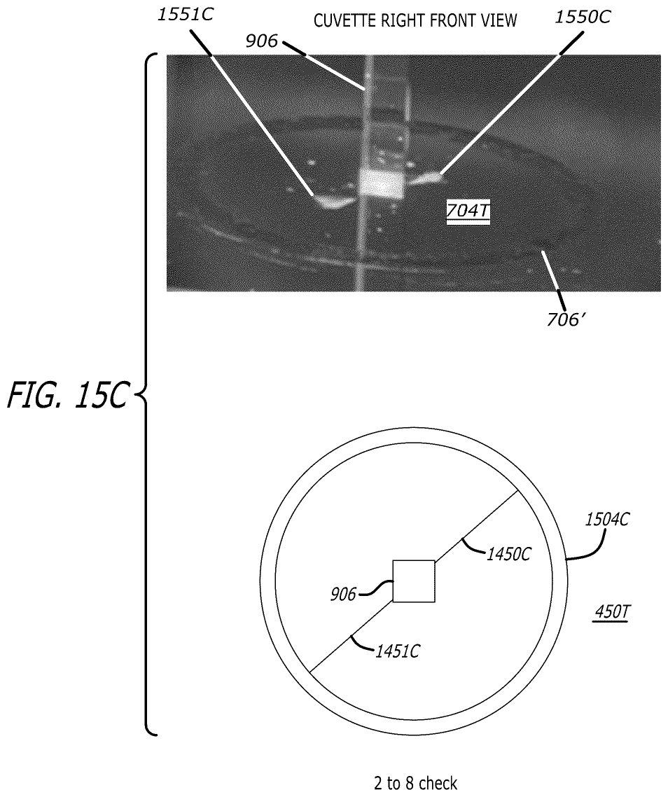

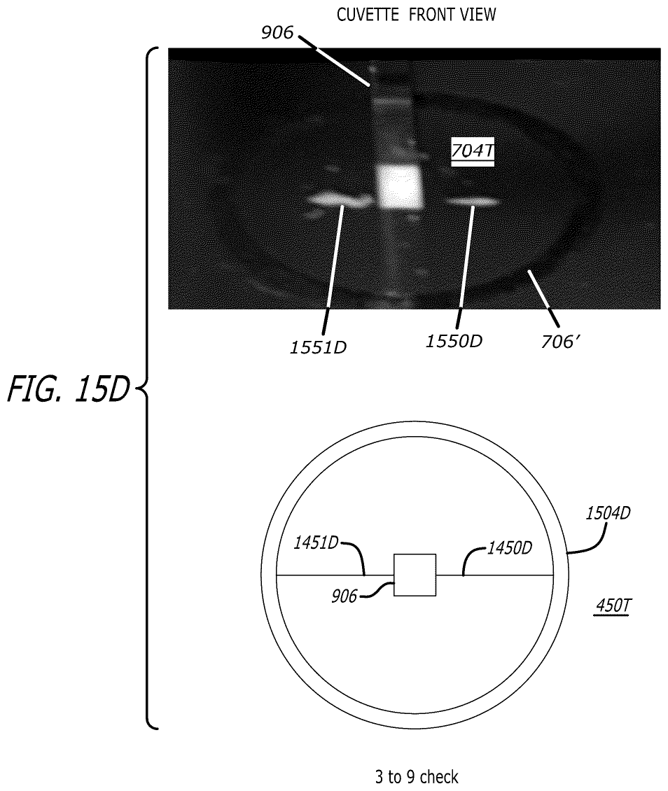

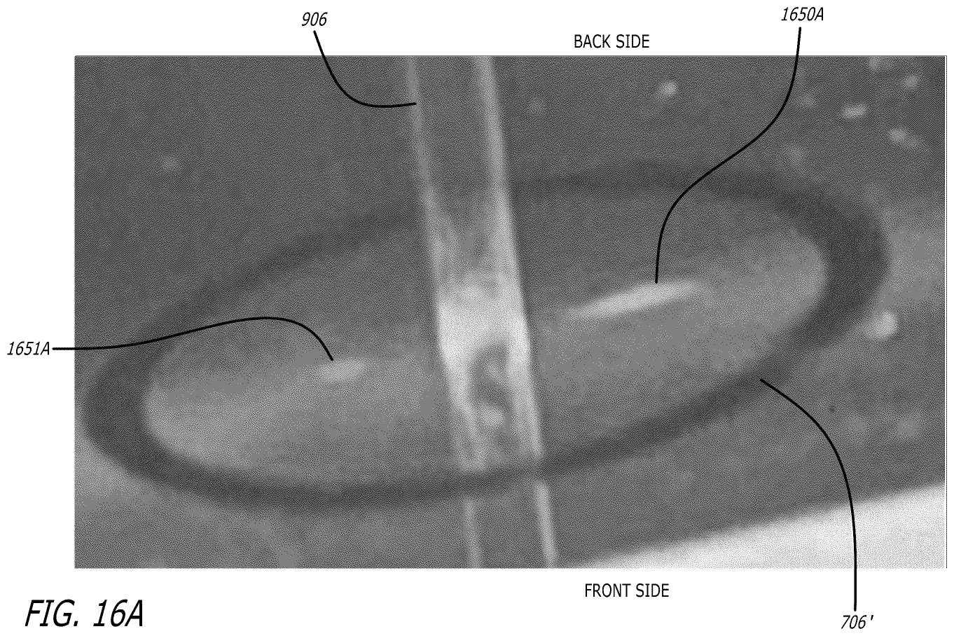

Referring now to FIGS. 14A and 14E, to perform measurements (engagement testing) to be sure the flow channels in the nozzle and the cuvette are aligned together, a latchable test nozzle assembly 450T can be used. If the engagement testing indicates misalignment, the yaw and/or pitch of the carriage plate with respect to the linear bearing can be readjusted to compensate. The latchable test nozzle assembly 450T is the nozzle assembly 450,450B with a test nozzle 704T with a pair of ridges (with crowns or peaks) 1450-1451 in alignment having a triangular cross-section extending slightly up from a top surface. The pair of ridges (with crowns or peaks) 1450-1451 are formed by the mold halves when a nozzle is manufactured and can be used for testing purposes. Otherwise, the pair of ridges can be removed in production nozzles leaving a substantially flat top surface. The pair of ridges 1450-1451 are in alignment (colinear or coplanar—in the same plane) on opposite sides of the drop inlet (orifice) 734 in the test nozzle 704T. The crowns of the ridges 1450-1451 form a pair of line segments in the same plane The latchable test nozzle assembly 450T includes the o-ring seal 706 in the gland opening 708 in the nozzle body 702. Multiple test nozzle assemblies 450T can be made with different orientations of the test nozzle 704T in the nozzle body 702 to provide different orientations of the pair of ridges 1450-1451.

Referring now to FIG. 14B, the test nozzle 704T can be assembled into the nozzle body in different orientations forming multiple test nozzle assemblies 450T to thoroughly test the engagement between the nozzle and the cuvette to assure the flow channels are aligned and not at angles with each other. A plurality of nozzle assemblies 450T can be formed with different angular orientations of the pairs of ridges (or planes) such as two or more of zero, forty-five, ninety, one hundred-thirty-five degrees; or two or more pairs of ridges at different angles with respect to planes through two hours of a clock (3 to 9 for left and right check, 12 to 6 for fore and aft check, 10 to 4 confirmation check, or 2 to 8 confirmation check). The test nozzle insert 704T has its plane or ridge lines clocked or angled at the selected position. The test nozzle insert 704T is then press fit into the nozzle body of the latchable test nozzle assembly at the desired angle and held in place by friction to form the desired latchable test nozzle assembly. The O-ring is then mounted into the gland around the test nozzle insert.

For example, a first nozzle test assembly can have a test nozzle with a first orientation of ridges 1450A-1451A aligned with the hours of 10 and 4 at one hundred-thirty-five and three-hundred-fifteen degrees. A second nozzle test assembly can have test nozzle with a second orientation of ridges 1450B-1451B aligned with the hours of 12 and 6 at zero and ninety degrees. A third latchable test nozzle assembly can have a test nozzle with a third orientation of ridges 1450C-1451C aligned with the hours of 2 and 8 at forty-five and one-hundred-thirty-five degrees. A fourth latchable test nozzle assembly can have a test nozzle with a fourth orientation of ridges 1450D-1451D aligned with the hours of 3 and 9 at forty-five and two-hundred-seventy degrees. Other angles of orientation can be used with the ridges in the nozzle when mounted in the nozzle body in order to make measurements of engagement.

With the latchable test nozzle assembly 450T mounted into the mount 452B and the carriage engaging the top surface of the test nozzle with the clear cuvette 406, a light from a light source can be shinned into one side of the cuvette. Depending upon engagement, the light can reflect off the ridges 1450-1451 forming oval light (white) spots or (white) lines that are visible from the opposite side of the cuvette. With no engagement, no oval light spot or line is visible. The light spots are visible on opposite sides of the flow channel 906 in the clear cuvette from the ridges that are on opposite sides of the orifice in the nozzle.

FIG. 14C illustrates a pattern of light (white) spots 1401-1402 that that may be observed and indicate an uneven engagement between the colinear ridges and the base of the cuvette. The o-ring around the nozzle in the nozzle assembly absorbs much of the light and forms a ring shadow 1403 about the light (white) spots that are observed.

The light spot 1401 is almost a line segment indicating poor engagement. The light spot 1402 is oval and indicates more engagement than the line segment of the light spot 1401. Accordingly, the light spots 1401-1402 on opposite sides of the cuvette flow channel 906 indicate an uneven engagement between the latchable test nozzle assembly and the cuvette.

The tilt (pitch) of the carriage plate with linear bearing can be adjusted by a plurality of set screws to compensate and achieve better engagement. Alternatively, or conjunctively, the rotation (yaw) of the carriage plate with the linear bearing can be slightly adjusted to compensate and achieve better engagement by the slop between male and female screw threads.

FIG. 14D illustrates a pattern of lights spots 1411-1412 that may be observed and indicate an even engagement between the colinear ridges and the base of the cuvette. The light spots 1411-1412 are both oval in appearance indicating a good engagement between the latchable test nozzle assembly 450T and the cuvette 406. With the light spots 1411-1412 on opposite sides of the cuvette flow channel 906 being similar in shape, it indicates an even engagement as well.

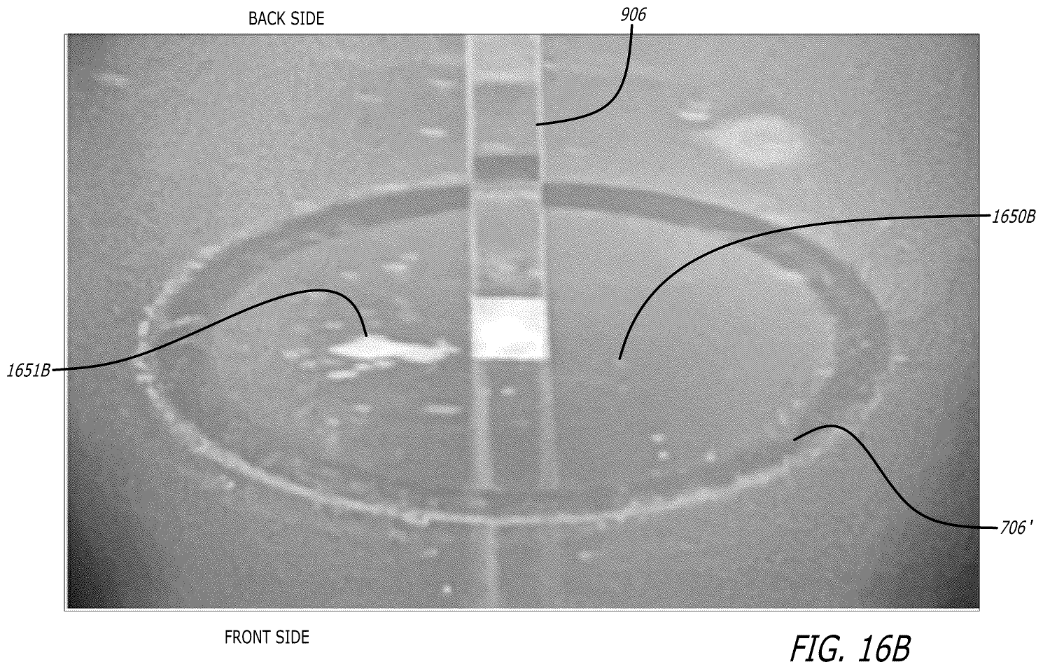

Referring now to FIGS. 15A-15D, light reflections observed through front or side views of the clear cuvette 406 show light spots around the cuvette flow channel 906 formed by different test nozzle assemblies 450T. Light from a light source is incident on one side of the cuvette and nozzle assembly. Light reflections are observed at an opposite side of the cuvette from the incident light reflecting off a portion of the pair of opposing colinear ridges of the first nozzle engaged with the bottom surface portion of the cuvette 406. FIGS. 15A-15D show good even engagement of the test nozzle assemblies 450T with the cuvette 406. The planes of the top surface of the nozzle and the bottom surface of the cuvette are co-planar.

The different test nozzle assemblies 450T in the figures can have different orifice (flow channel) diameters and ridges at different angles with respect to the nozzle body. The nozzle can be assembled into the nozzle body in different orientations forming multiple test nozzle assemblies 450T to thoroughly test the engagement between the nozzle and the cuvette to assure the flow channels are aligned and not at angles with each other.

In FIG. 15A, a front view of the cuvette, a nozzle 704 in a latchable test nozzle assembly 450T has a pair of ridges 1450A-1451A aligned around the cuvette flow channel 906 for a 10 o'clock to 4 o'clock check as indicated by the nozzle schematic 1504A. The flow channel of the test nozzle is within the hollow square cylindrical flow channel 906 of the cuvette. Light spots 1550A-1551A are observed on opposite sides of the flow channel 906 within the shadow 706′ formed by the O-ring 706.

In FIG. 15B, a side view of the cuvette, a nozzle 704 in a latchable test nozzle assembly 450T has a pair of ridges 1450B-1451B aligned around the cuvette flow channel 906 for a 12 o'clock to 6 o'clock check as indicated by the nozzle schematic 1504B. Light spots 1550B-1551B are observed on opposite sides of the flow channel 906 within the shadow 706′ formed by the o-ring. The observed Light spots 1550B-1551B appear to be good and even on each side of the cuvette flow channel 906.

In FIG. 15C, a right front view of the cuvette, a nozzle 704 in a latchable test nozzle assembly 450T has a pair of ridges 1450C-1451C aligned around the cuvette flow channel 906 for a 2 o'clock to 8 o'clock check as indicated by the nozzle schematic 1504C. Light spots 1550C-1551C are observed on opposite sides of the flow channel 906 within the shadow 706′ formed by the o-ring. The observed light spots 1550C-1551C appear to be good and even on each side of the cuvette flow channel 906.

In FIG. 15D, a front view of the cuvette, a nozzle 704 in a latchable test nozzle assembly 450T has a pair of ridges 1450D-1451D aligned around the cuvette flow channel 906 for a 3 o'clock to 9 o'clock check as indicated by the nozzle schematic 1504D. Light spots 1550D-1551D are observed on opposite sides of the flow channel 906 within the shadow 706′ formed by the o-ring. The observed light spots 1550D-1551D appear to be good and even on each side of the cuvette flow channel 906.

Referring now to FIGS. 16A-16C, light reflections observed through front or side views of the clear cuvette 406 show light spots around the cuvette flow channel 906 that indicate a poor and uneven engagement by test nozzle assemblies 450T with the cuvette 406. The planes of the top surface of the nozzle and the bottom surface of the cuvette are not co-planar.

In FIG. 16A, a front view of the cuvette, a test nozzle 704T in a latchable test nozzle assembly 450T can form one or two reflective light spots 1650A-1651A observed on opposite sides of the flow channel 906 within the shadow 706′ formed by the o-ring. The observed reflective light spots 1650A-1651A on the opposite sides of the cuvette flow channel 906 appear uneven (different shapes) indicating a poor engagement.

In FIG. 16B, a front view of the cuvette, a test nozzle 704T in a latchable test nozzle assembly 450T forms a single reflective light spot 1651A observed on one side of the flow channel 906 within the shadow 706′ formed by the o-ring. An expected reflective light spot 1650B on the opposite side of the channel 906 is not formed or observed. The single observed reflective light spot 1651B, an oval on one side of the cuvette flow channel 906, is an indicator that there is a poor engagement between the nozzle and the cuvette.

In FIG. 16C, a side view of the cuvette, a nozzle 704 in a latchable test nozzle assembly 450T forms light spots 1650C-1651C observed on opposite sides of the flow channel 906 within the shadow 706′ formed by the o-ring. The observed light spots 1650C-1651C on the opposite sides of the cuvette flow channel 906 appear uneven (different oval shapes—one narrower than the other) indicating a poor engagement.

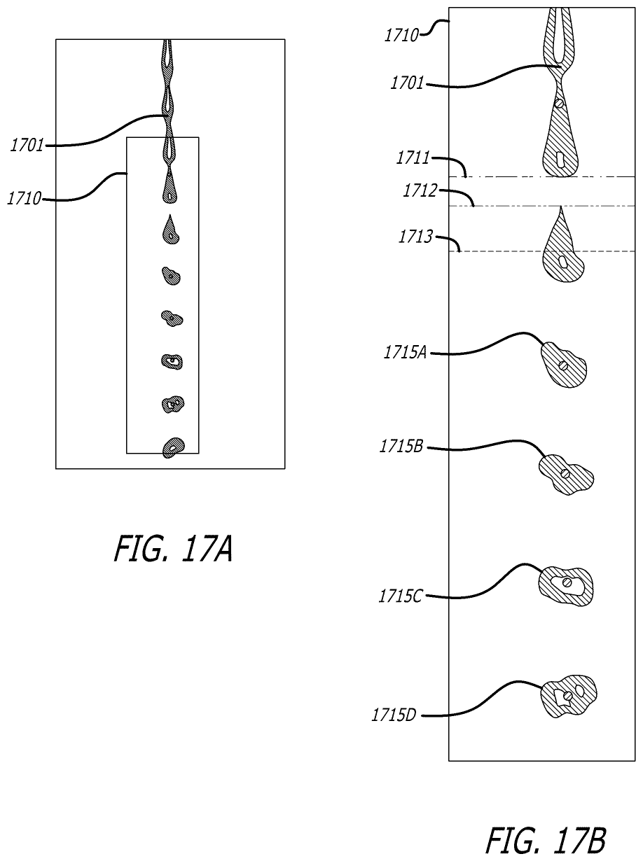

While these observations are made during assembly of the flow cytometer/cell sorter, other observations can be made after assembly during tests run on the flow cytometer/cell sorter after assembly. For example, FIGS. 17A-17B and 18A-18B are views of drops released from a fully assembled cell sorter/flow cytometer that includes the flow cell subassembly with a cuvette 406 and a nozzle assembly 405,405B.

### Engagement Testing for Coplanarity

During assembly of a flow cytometer, it is desirable to assemble the flow cell assembly 124B so that a center axis of the flow channel in the cuvette is substantially aligned with a center axis of the flow channels in the nozzle assembly and the latchable nozzle assembly. The angle or tilt between the carriage plate and the linear bearing can be adjusted so that a plane of the base of the cuvette is substantially in parallel with a plane of the top surface of the nozzle so they are substantially co-planar in order to improve their engagement. Methods for assembly of a flow cell subassembly of a flow cytometer can be used to provide substantial co-planarity between the base of the cuvette and the top surface of the nozzle to provide quality drop formation from the improved engagement.

The method begins by loosely installing the whole carriage assembly 422B to the flow cell body 404 and to the linear bearing 464. In FIG. 13D, the bolts/screws 1373A-1373B are loose so the bracket 443 of the carriage assembly 422B is loosely coupled to the flow cell body 404. The though holes in the bracket 443 are oval to allow some side to side (left to right) adjustment. The bolts/screws 1372A-1372D are loose so that the carriage plate 465B of a carriage assembly 442B is loosely coupled to the linear bearing 464. The plurality of screws (threaded fasteners) 1372A-1372D are inserted through a plurality of holes 471A in the carriage plate and loosely threaded into the plurality of threaded openings of the linear bearing 464. The upper set screws 1370A and the lower set screws 1370B may be partly into their respective threaded holes 1370A and 1370B but without the shaft ends contacting the linear bearing 464.

Next, an empty latchable nozzle assembly 450E is inserted into the latchable mount 452B of the carriage assembly 442 under a cuvette 406. The empty latchable nozzle assembly 450E has no nozzle or o-ring seal around a nozzle. The top surface of the nozzle body of the empty latchable nozzle assembly can be used to engage the base of the cuvette, instead of the nozzle, in order to initially set up the alignment.

Next, as shown in FIG. 13G, the latchable mount 452B is pushed to engage the top surface portion of the empty latchable nozzle assembly 450E with the bottom surface portion of the cuvette 406. The carriage plate 465B is rotated clockwise and counterclockwise to perform a yaw (rotational) adjustment to set a small even gap between the top surface portion of the empty latchable nozzle assembly 450E and the bottom surface portion of the cuvette. The even gap provides for left-right horizontal co-planarity between the top surface portion of the empty latchable nozzle assembly 450E and the bottom surface portion of the cuvette 406. The front back horizontal co-planarity between surfaces can be checked and adjusted by adjusting the tilt or pitch of the carriage plate with the linear bearing.

The plurality of screws 1373A-1373B are tightened to hold the bracket 443 tight against the flow cell body 404. The bolts/screws 1372A-1372B with threads extending through the carriage plate into the plurality of threaded openings of the linear bearing 464, can be fully tightened and made ready for testing of the front to back engagement between the cuvette and test nozzles.

One or more engagement tests to test the initial engagement that is set using the empty latchable nozzle assembly can be performed. Instead of the empty latchable nozzle assembly, a plurality of engagement test nozzle assemblies 450T can be used. Accordingly, the empty latchable nozzle assembly 450E is removed from the latchable nozzle mount 452B so that one or more engagement test nozzle assemblies 450T with one or more clocked ridges in their nozzles can be inserted into the latchable nozzle mount 452B.

A first latchable test nozzle assembly 450T with a first nozzle is inserted into the nozzle mount 452B. The first latchable test nozzle assembly 450T has a pair of opposing colinear ridges 1450-1451 in its nozzle, such as ridges 1450A-1450B shown schematically in nozzle schematic 1504A in FIG. 15A. The opposing colinear ridges 1450-1451 form a pair of line segments in a first plane at a selected first angle through the orifice (flow channel) in the first nozzle.

The carriage assembly 442 is operated with the lever handle to bring the nozzle of the first latchable test nozzle assembly 450T into engagement with the bottom surface portion of the cuvette 406. Engagement observations can then be made between the latchable test nozzle assembly and the cuvette.

Using a light source, a light is shined into one side of the clear cuvette 406 with engagement observations being made from the opposite side of the clear cuvette. If the light is shined through the rear of the cuvette, engagement observations are made from the front of the cuvette. If a light is shined through the left side of the cuvette, observations of the engagement is made on the right side of the cuvette. Due to the small size, the subassembly may be set on one or more of its sides under a microscope to make the observations, such that light shines from below into one side with observations made above with respect to the microscope.

Due to the light from the light source, light reflections from an opposite side of the cuvette can be observed. The light of the light source can be reflected off of portions of the pair of opposing colinear ridges in the first nozzle that is engaged with the bottom surface portion of the cuvette 406. The light reflection can be observed as oval spots indicating good engagement or lines indicating poor engagement. Moreover, one side may show a light line or nothing on one side of the nozzle and the opposite side of the nozzle may show an oval light spot such that uneven engagement is indicated. The directionality of the one or two light reflections can be observed with respect to an axis along a length of the nozzle body of the latchable test nozzle assembly

If the light reflection that is observed is on only one side of the flow channel it likely indicates that a top surface of the first nozzle is not coplanar with the bottom surface of the cuvette. If light reflection is observed on both sides of the flow channel but it is uneven (e.g., a light line on one side and an oval on the other), a top surface of the first nozzle is likely not coplanar with the bottom surface of the cuvette. If on the other hand the light reflection is observed on both sides of the flow channel of the cuvette and they are even looking light spots (e.g., ovals), it is likely that a top surface of the first nozzle is coplanar with the bottom surface of the cuvette.

One or more of these engagement tests can be performed with one or more engagement test nozzle assemblies 450T. At least one of the 10 to 4, 12 to 6, or 2-8 test engagement shown by FIGS. 15A-15C should at least be performed first to determine how well the front to back (or 12-6 direction) co-planarity is set after the initial left to right setting with the empty latchable nozzle assembly 450E. Accordingly, the engagement test process can further continue with a second engagement test to determine coplanarity in a different direction and gain an understanding of what adjustments, if any, that may be made.

The first latchable test nozzle assembly 450T in the nozzle mount 452B can be removed to ready insertion of a second latchable test nozzle assembly 450T that is different than the first latchable test nozzle assembly. The second latchable test nozzle assembly 450T having a test nozzle with a pair of opposing colinear ridges is engaged into the mount 452B. The pair of opposing colinear ridges in the second nozzle form line segments in a second plane at a selected second angle through the orifice differing from the selected first angle of the first plane. If the line segments of the first nozzle are in the 12 to 6 plane, then the second nozzle in the second latchable test nozzle assembly 450T should have its pair of ridges forming line segments in a different plane such as the 3 to 9 plane, 10 to 4 plane, or 2 to 8 plane.

With the second latchable test nozzle assembly 450T mounted in the nozzle mount 452B, the steps of operating, shining, and observing can be repeated with the second latchable test nozzle assembly to determine if the top surface of the second nozzle is coplanar with the bottom surface of the cuvette. Additional test nozzle assemblies 450T with nozzles having ridges at different clock planes can be mounted in the nozzle mount so that additional engagement test can be made through the repeated steps of operating, shining, and observing with a different latchable test nozzle assembly.

If any one of the one or more engagement tests indicate an uneven engagement between the pair of opposing ridges thereby showing a lack of coplanarity, the flow cell subassembly 124B can undergo tilt adjustments and/or added rotational adjustments to correct. If on the other hand, the observed light reflection from all or one or more of a series of engagement tests indicates coplanarity in a plurality of different directions without a tilt adjustment, then the set screws 1370A-1370B can all be removed and the flow cell assembly accepted and installed into a flow cytometer system or a cell sorter system. Recall that nozzle mount 452B is coupled to the carriage plate 465B in a fixed orientation such that an adjustment to the carriage plate is an adjustment to the nozzle mount and any nozzle assembly that is inserted into the nozzle mount.

If one or more of the engagement tests indicates a lack of coplanarity, further adjustments can be made to the coupling of the carriage plate 465B to the linear bearing 464. After the initial rotational adjustment of the carriage plate using the empty latchable nozzle assembly, the upper and lower set screws 1370A,1370B remain loose in the upper and lower threaded openings 1371A,1371B in the carriage plate 465B. One pair of the set screws (upper set screws 1370A or lower set screws 1370B) in the carriage plate can be threaded in to engage against the linear bearing to provide pitch (tilt) adjustment in the tiltable carriage plate and nozzle mount of the carriage assembly. Any nozzle assembly, such as a latchable test nozzle assembly 450T, inserted into the nozzle mount receives the same amount of pitch (tilt) adjustment from the set screws. Each of the set screws in a selected pair of set screws is desired to be rotated to provide an equal engagement against the linear bearing so that an even (equal) gap 1380A,1380B is provided in both left and right sides between the carriage plate and the linear bearing.

The pair of set screws (upper or lower) selected for engagement is based on the engagement observations made in the 12 to 6 direction (zero and ninety degrees or front to back direction) during the engagement testing such as with the nozzle schematic 1504B shown in FIG. 15B. The idea is to perform the pitch adjustment for the tiltable carriage to add more engagement to either the front side or the back side about the flow channel that was observed to have less engagement. This is performed to even out the engagement between the front and back sides about the flow channel.

For example, assuming the observations made with the engagement tests indicated that the back side of the cuvette 406 needs more engagement with the nozzle, then the upper set screws 1370A can be selected to add pitch to correct the engagement. Assuming the ends and shafts of the upper set screws 1370A are engaged equally with the linear bearing, then the tilted gap 1380A shown in FIG. 13E can be formed and observed in each of the left and right sides of the flow cell assembly. The size of the titled gap can be measured in each side to assure an equal tilt of the carriage plate from the linear bearing. If needed, the upper bolts/screws 1372A-1372B can be slightly loosened to allow for the set screws to form the needed gap 1380A to provide sufficient pitch adjustment.

In FIG. 16C for example, an engagement test shows the reflected light spot 1651C in the front of the flow channel 906 is observed to be narrower than reflected light spot 1650C in back of the flow channel. This observation from the engagement test indicates that the front side of the cuvette 406 needs more engagement with the nozzle. Accordingly, the lower set screws 1370B shown in FIGS. 13C, 13D, and 13F can be selected to add pitch to correct the engagement. Assuming the ends and shafts of the lower set screws 1370B are engaged equally with the linear bearing, the tilted gap 1380B shown in FIG. 13F can be formed and observed in each of the left and right sides of the flow cell assembly. The size of the titled gap can be measured in each side to assure an equal tilt of the carriage plate from the linear bearing. If needed, the lower bolts/screws 1372C-1372D can be slightly loosened to allow for the set screws to form the needed gap 1380B to provide sufficient pitch adjustment.

If on the other hand, poor engagement is observed primarily in the 3 to 9 direction (forty-five and two hundred seventy degrees or left to right direction) during the engagement testing with the 3 to 9 check by nozzle schematic 1504D, then a yaw adjustment is needed instead. The idea is to perform the yaw adjustment with a clockwise or counterclockwise rotation on the carriage plate with respect to the linear bearing to add more engagement to either the left side or the right side of the flow channel of the cuvette for that side which was observed to have less. For example, FIGS. 16A-16B show uneven engagement between left and right sides about the flow channel in the cuvette.

In FIG. 16A, the left reflective light spot 1651A indicates that the left side has less engagement. Accordingly, a clockwise rotation of the carriage plate (arrow 1380R in FIG. 13C) can provide more engagement to the left side in order to even out the level of engagement between the left and right sides about the flow channel in the cuvette.

In FIG. 16B, the right side has less engagement than the left side as indicated by the lack of any reflective light spot 1650B in the right side. Accordingly, a counterclockwise rotation of the carriage plate (arrow 1380L in FIG. 13C) can provide more engagement to the right side in order to even out a level of engagement between the right and left sides about the flow channel 906 in the cuvette.

If instead an uneven engagement about the flow channel is observed with a latchable test nozzle assembly having the nozzle schematic 1504A with the 10 to 4 check or the nozzle schematic 1504C with the 2 to 8 check, then both pitch and yaw adjustments need to be made to even out the engagement about the flow channel by respectively adjusting the tilt in the carriage plate to form an upper gap 1380A or a lower gap 1380B with the set screws, and rotating the carriage plate clockwise 1380R or counterclockwise 1380L with respect to the linear bearing.

Observations from all or one or more of the engagement tests can indicate an even engagement between the nozzle and the cuvette in all directions. That is, one or more of the engagement tests with the first, second, third, and fourth test nozzles may determine that the bottom surface of the cuvette is coplanar with the top surface of the nozzle. If so, the bolts/screws 1372A-1372D are tightened to lock the position and orientation of the carriage plate to the linear bearing. Any and all unused set screws 1370A,1370B are unscrewed and removed from the carriage plate. The accepted flow cell subassembly can then be installed into a flow cytometer or cell sorter system.

### Drop Drive Assembly

The drop drive assembly 402 of the flow cell 124 are in communication with the sample input station 130 of the fluidics system to receive sample fluid. Tubing couples the flow cell and sample input station in communication together. Generally, the drop drive assembly 402 receives the sample fluid under pressure through the sample input port 408 at one end. At an opposite end, the drop drive assembly 402 forms a stream of sample fluid out of sample injection tube (SIT) 422. The lower portion of the drop drive assembly below the hub is inserted into the chamber of the flow cell body 404, such as can be seen in FIGS. 4D-4G.

The drop drive assembly 402, amongst other features, includes the sample input port 408, the sample injection tube (SIT) 422, and a hollow piezoelectric cylindrical transducer. The upper end of the SIT 422 is in communication with the sample input port 408 and the tubing to receive the flow of sample fluid. The sample injection tube (SIT) 422 injects the sample fluid into a funnel portion of a chamber in the flow cell body. The hollow piezoelectric cylindrical transducer is under software control selected by a user (amplitude and frequency) to facilitate formation of drops.

The hollow piezoelectric cylindrical transducer mounts around a portion of the SIT 422 when assembled together. Sample fluid with cells/particles flows within the hollow center cylinder of the SIT 422. When energized by an alternating current (AC) signal (amplitude and frequency selectable) from the electronics system, the hollow piezoelectric cylindrical transducer vibrates based on frequency and amplitude of the AC signal. The vibrations are coupled into the insulated cylindrical sealing base such that the sample fluid receives acoustical energy that can help convert the sample fluid into a stream of small drops spread out in a single file line out of the nozzle. Ideally, each drop has a single cell/particle but cells/particles of interest can vary in size. The diameter of the opening in the nozzle, the sheath pressure, and fluid viscosity can vary the size of drops and their frequency of generation. For a given sheath fluid pressure, the AC signal frequency and amplitude can be set for resonance where droplet formation is stable and yields a desired drop size. The nozzle assembly can be readily swapped in and out to get a different diameter of nozzle opening.

### Drop Quality

The nozzle, in the nozzle assembly of the flow cell, breaks up the sample fluid into droplets. In a cell sorter, the drops with cells of interest in a center stream are sorted out by deflecting drops away from the center stream. The drops are charged in the flow cell so they can be deflected away (sorted) from the center stream by charged deflecting plates in a deflection chamber 122. The deflected drops with cells of interest can be collected into separate vessels (test tubes, wells of plates) for further testing in a lab.

It is desirable that the stream of drops out of the nozzle containing a biological cell be of appropriate in shape. It is desirable that the period between drops be appropriate so each drop can be deflected and collected into separate vessels. Also, the break off time point of drops from a stream is desirable to control in the formation of drops and be consistent between nozzle removal, cleaning, and reinsertion. Accordingly, the shape of the drops and the period between drops can be important in a cell sorter system. The droplet yield out from the nozzle and the droplet shape quality in the stream of drops out of the nozzle are related to how well the nozzle engages (pairs) with the cuvette. It is desirable that the top surface of the nozzle and the bottom surface of the cuvette are co-planar and the axes of flow channels are aligned to provide good droplet yield and a good quality of drop shape.

FIGS. 17A-17B illustrate magnified and unmagnified views of poor quality drops released from a nozzle in a nozzle assembly engaged with a cuvette of a flow cytometer/cell sorter under test. FIGS. 18A-18B illustrate magnified and unmagnified views of good quality drops released from a nozzle in a nozzle assembly engaged with a cuvette of a flow cytometer/cell sorter under test.

FIGS. 17A-17B illustrate views of a stream 1701 of poor quality drops out of the orifice (flow channels) of a nozzle. A section 1710 of the stream 1701 is magnified in FIG. 17B in order to take measurements of the quality of the drops. Lines 1711, 1712, and 1713 can be used to measure the drop delay, drop interval, drop center, and others to obtain an overall idea of the stream status. The drops 1715A-1715D are asymmetric, without a rounded drop shape. A poor engagement between the nozzle and the cuvette can cause such a poor drop quality. Nozzles that have good break off will show a symmetric well-rounded drop shape.

FIGS. 18A-18B illustrate views of a stream 1801 of good quality drops out of the orifice (flow channels) of a nozzle. A section 1810 of the stream 1801 is magnified in FIG. 18B in order to take measurements of the quality of the drops. Lines 1811, 1812, and 1813 can be used to measure the drop delay, drop interval, drop center, and others to obtain an overall idea of the stream status. The drops 1815A-1815D are symmetric. The drops have oval shapes that are well rounded. This indicates nozzles having a good break off and a good engagement between the nozzle and the cuvette to provide a good drop quality.

There are some stream controls that can be adjusted to improve poor drop quality so that it is acceptable, even with a poor engagement between the nozzle and cuvette. However, settings (e.g., higher amplitude and/or higher frequency of vibrations provided by a piezoelectric cylindrical transducer in the SIT) that may need to be set can overstress components in the flow cytometer/cell sorter and lead to premature failure that requires replacement or repair. It is desirable to provide a good mechanical engagement between the nozzle and the cuvette to provide a good drop quality at nominal settings to avoid overstress of the components and lower maintenance costs of the flow cytometer/cell sorter.

### Advantages

There are a number of advantages to having a latching (locking) nozzle assembly in a sorting flow cytometer (e.g., cell sorter 100). The nozzle assembly can be removed, cleaned, and replaced into a substantially similar position to provide a substantially similar drop quality from run to run after calibration to the nozzle.

There are a number of advantages to having the flow channels in the cuvette and nozzle be adjustable into alignment. A good alignment between the flow channels can lead to better drop quality. With better drop quality, drop settings can be more nominal within ranges. In the long run, the better drop quality can result in lower maintenance costs of a flow cytometer system or a cell sorter system.

This disclosure contemplates other embodiments or purposes. It will be appreciated that the embodiments of the invention can be practiced by other means than that of the described embodiments, which are presented in this description for purposes of illustration and not of limitation. The specification and drawings are not intended to limit the exclusionary scope of this patent document. It is noted that various equivalents for the particular embodiments discussed in this description may be practiced by the claimed invention as well. That is, while specific embodiments of the invention have been described, it is evident that many alternatives, modifications, permutations and variations will become apparent in light of the foregoing description. For example, the threaded openings can have different dimensions in which case, the dimensions of the various threaded fasteners would differ than those described herein. Accordingly, it is intended that the claimed invention embrace all such alternatives, modifications and variations as fall within the scope of the appended claims. The fact that a product, process, or method exhibits differences from one or more of the described exemplary embodiments does not mean that the product or process is outside the scope (literal scope and/or other legally-recognized scope) of the following claims.

1. A method for a subassembly of a flow cytometer or a cell sorter, the method comprising:
loosely installing a carriage assembly 442B to a flow cell 404, including loosely installing a carriage plate 465B to a linear bearing 464 by inserting a plurality of bolts/screws through a plurality of holes 471A in the carriage plate and threading one or more threads of the plurality of bolts/screws into a plurality of threaded openings of the linear bearing 464;
inserting an empty nozzle assembly 450E into a mount 452B of the carriage assembly 442B under a cuvette 406, the empty nozzle assembly 450E having a nozzle body without a nozzle and an o-ring;
pushing on the mount 452B to engage a top surface portion of the nozzle body of the empty nozzle assembly 450E with a bottom surface portion of the cuvette 406; and
with the top surface portion of the empty nozzle assembly 450E and the bottom surface portion of the cuvette 406 forming an even gap, tightening the one or more threads of the plurality of bolts/screws into the plurality of threaded openings of the linear bearing 464.

2. The method of claim 1, further comprising:
removing the empty nozzle 450E assembly from the mount 452B;
inserting a first test nozzle assembly 450T into the mount, the first test nozzle assembly 450T having first nozzle with a pair of opposing colinear ridges having tops forming line segments in a first plane at a first angle through an orifice, wherein the first test nozzle assembly 450T has no o-ring around the first nozzle;
operating the carriage assembly 442B to bring the first nozzle of the first test nozzle assembly 450T into engagement with the bottom surface portion of the cuvette 406;
shining a light from a light source into one side of the cuvette 406; and
from an opposite side of the cuvette, observing one or two light reflections in a form of an oval light spot or a light segment on opposite sides of a flow channel in the cuvette.

3. The method of claim 2, wherein
the one or two light reflections are formed by the light from the light source reflecting off a portion of one or both of the pair of opposing colinear ridges in the first test nozzle assembly 450T engaged with the bottom surface portion of the cuvette 406.

4. The method of claim 2, further comprising:
from the opposite side of the cuvette, observing a directionality of the one or two light reflections with respect to an axis along a length of the nozzle body of the first test nozzle assembly 450T.

5. The method of claim 2, wherein
the one or two light reflections are observed on only one side of the flow channel such that a top surface of the first nozzle of the first test nozzle assembly 450T is not coplanar with the bottom surface of the cuvette.

6. The method of claim 2, wherein
the one or two light reflections are observed on both sides of the flow channel but uneven such that a top surface of the first nozzle of the first test nozzle assembly 450T is not coplanar with the bottom surface of the cuvette.

7. The method of claim 2, wherein
the one or two light reflections are observed on both sides of the flow channel and even such that a top surface of the first nozzle of the first test nozzle assembly 450T is coplanar with the bottom surface of the cuvette.

8. The method of claim 2, further comprising:
removing the first test nozzle assembly 450T from the mount;
inserting a second test nozzle assembly 450T into the mount, the second test nozzle 450T assembly having a pair of opposing colinear ridges in a second nozzle forming line segments in a second plane at a selected second angle through the orifice differing from the selected first angle of the first plane; and
repeating the operating, the shining, and the observing with the second test nozzle assembly to determine if the second nozzle is coplanar with the bottom surface of the cuvette.

9. The method of claim 8, further comprising:
removing the second test nozzle assembly from the mount;
inserting a third test nozzle assembly 450T into the mount, the third test nozzle assembly 450T having a pair of opposing colinear ridges in a third nozzle forming line segments in a third plane at a selected third angle through the orifice differing from the selected first and second angles of the respective first and second planes; and
repeating the operating, the shining, and the observing with the third test nozzle assembly to determine if the third nozzle is coplanar with the bottom surface of the cuvette.

10. The method of claim 9, further comprising:
removing the third test nozzle from the mount;
inserting a fourth test nozzle assembly 450T into the mount, the fourth test nozzle assembly 450T having a pair of opposing colinear ridges in a fourth nozzle forming line segments in a fourth plane at a selected fourth angle through the orifice differing from the selected first, second, and third angles of the respective first, second, and third planes; and
repeating the operating, the shining, and the observing with the fourth test nozzle assembly to determine if the fourth nozzle is coplanar with the bottom surface of the cuvette.

11. The method of claim 10, wherein it is observed that the engagement tests with the first nozzle, the second nozzle, the third nozzle, and the fourth nozzle are even on both sides of the flow channel in the cuvette, and the method further comprises:
installing the flow cell subassembly into a flow cytometer or a cell sorter.

12. The method of claim 2, wherein
the observing is performed with a microscope.

13. The method of claim 2, wherein
the one or two light reflections from the ridges is observed to be even on both sides of the flow channel in the cuvette indicating that a top surface of the first nozzle is coplanar with the bottom surface of the cuvette.

14. A method for a flow cell subassembly, the method comprising:
installing a carriage assembly to a flow cell, the carriage assembly including a carriage plate and a linear bearing, wherein a nozzle mount for receiving a nozzle assembly is coupled to the carriage plate and a cuvette is coupled to the flow cell;
performing a first engagement test between a first nozzle of a first test nozzle assembly and a cuvette to make a first observation of engagement along a first angle; and
based on the first observation of engagement, adjusting angular orientation (yaw) of a carriage plate with respect to a linear bearing by clockwise or counterclockwise rotation to adjust the engagement between nozzles and the cuvette in a first dimension.

15. The method of claim 14, further comprising:
tightening a plurality of bolts/screws through the carriage plate threaded into the linear bearing to hold the adjusted angular orientation in the carriage plate with the linear bearing.

16. The method of claim 14, further comprising:
performing a second engagement test between a second nozzle of a second test nozzle assembly and the cuvette to make a second observation of engagement along a second angle differing from the first angle; and
based on the second observation of engagement, adjusting tilt (pitch) of the carriage plate with respect to the linear bearing by turning a pair of set screws threaded into the carriage plate so ends of the pair of set screws push on a surface of the linear bearing to form a gap between the carriage plate and linear bearing to adjust the engagement between nozzles and the cuvette in a second dimension.

17. The method of claim 16, further comprising:
tightening a plurality of bolts/screws through the carriage plate threaded into the linear bearing to hold the adjusted tilt and the adjusted angular orientation in the carriage plate with the linear bearing.

18. The method of claim 16, further comprising:
performing a third engagement test between a third nozzle of a third test nozzle assembly and the cuvette to make a third observation of engagement along a third angle differing from the first and second angles; and
based on the third observation of engagement, readjusting the angular orientation (yaw) of the carriage plate with respect to the linear bearing by clockwise or counterclockwise rotation to readjust the engagement between nozzles and the cuvette in the first dimension.

19. A method for a flow cell subassembly, the method comprising:
installing a carriage assembly to a flow cell, the carriage assembly including a carriage plate and a linear bearing, wherein a nozzle mount for receiving a nozzle assembly is coupled to the carriage plate and a cuvette is coupled to the flow cell;
performing a first engagement test between a first nozzle of a first test nozzle assembly and a cuvette to make a first observation of engagement along a first angle;
performing a second engagement test between a second nozzle of a second test nozzle assembly and the cuvette to make a second observation of engagement along a second angle differing from the first angle;
performing a third engagement test between a third nozzle of a third test nozzle assembly and the cuvette to make a third observation of engagement along a third angle differing from the first and second angles; and
performing a fourth engagement test between a fourth nozzle of a fourth test nozzle assembly and the cuvette to make a fourth observation of engagement along a fourth angle differing from the first, second, and third angles.

20. The method of claim 19, further comprising:
based on the first, second, third, or fourth observations of engagement, adjusting angular orientation (yaw), adjusting tilt, or adjusting both angular orientation and tilt of the carriage plate with respect to the linear bearing to adjust the engagement between nozzles and the cuvette in a first dimension, a second dimension, or both the first dimension and the second dimension.

21-49. (canceled)
